(19) United States
(12) Patent Application Publication
(10) Pub. No.: US 2009/0001721 A1
(43) Pub. Date: Jan. 1, 2009

(54) Protective sleeve for threaded connections for expandable liner hanger

(75) Inventors: Scott Costa, Kingwood, TX (US); Joel Hockaday, Tomball, TX (US); Kevin K. Waddell, Houston, TX (US); Lev Ring, Houston, TX (US); Michael Bullock, Houston, TX (US); Robert Lance Cook, Katy, TX (US); Larry Kendziora, Needville, TX (US); David Paul Brisco, Duncan, OK (US); Tance Jackson, Plano, TX (US)

Correspondence Address: Conley Rose, P.C, P.O. Box 3267, Houston, TX, 77253-3267, US

(73) Assignee: ENVENTURE GLOBAL TECHNOLOGY, LLC, Houston, TX (US)

(21) Appl. No.: 12/163,682

(22) Filed: Jun. 27, 2008

Related U.S. Application Data
(63) Continuation of application No. 11/943,307, filed on Nov. 20, 2007, now abandoned.
Application No. 11/943,307 is a division of application No. 10/511,410, filed on Aug. 24, 2005.
Application No. 11/943,307 is a continuation-in-part of application No. 10/510,966, filed on Aug. 29, 2005.
Application No. 10/510,966 is a continuation-in-part of application No. 10/500,745, filed on Jul. 6, 2004.
(60) Provisional application No. 60/372,632, filed on Apr. 15, 2002.

(51) Int. Cl. F16L 25/06

(52) U.S. Cl. 285/333

(57) ABSTRACT

A tubular sleeve is coupled to and overlaps the threaded connection between a pair of adjacent tubular members.

### CROSS REFERENCE TO RELATED APPLICATIONS

The present application is a continuation of prior U.S. utility patent application Ser. No. 11/943,307, filed Nov. 20, 2007, and entitled “Protective Sleeve for Threaded Connections for Expandable Liner Hanger,” which is a divisional of U.S. utility patent application Ser. No. 10/511,410, which is a U.S. national stage of PCT patent application serial no. PCT/US2003/010144, filed on Mar. 31, 2003, which claimed the benefit of the filing date of U.S. provisional patent application Ser. No. 60/372,632, filed on Apr. 15, 2002, the disclosures of which are incorporated herein by reference.

U.S. utility patent application Ser. No. 11/943,307 is also a continuation-in-part of U.S. utility patent application Ser. No. 10/510,966, filed on Mar. 4, 2003, which is a continuation-in-part of U.S. utility patent application Ser. No. 10/500,745, filed on Jul. 6, 2004, the disclosures of which are incorporated herein by reference.

The present application is also related to the following: (1) U.S. patent application Ser. No. 09/454,139, filed on Dec. 13, 1999, (2) U.S. patent application Ser. No. 09/510,913, filed on Feb. 23, 2000, (3) U.S. patent application Ser. No. 09/502,350, filed on Feb. 10, 2000, (4) U.S. patent application Ser. No. 09/440,338, filed on Nov. 15, 1999, (5) U.S. patent application Ser. No. 09/523,460, filed on Mar. 10, 2000, (6) U.S. patent application Ser. No. 09/512,895, filed on Feb. 24, 2000, (7) U.S. patent application Ser. No. 09/511,941, filed on Feb. 24, 2000, (8) U.S. patent application Ser. No. 09/588,946, filed on Jun. 17, 2000, (9) U.S. patent application Ser. No. 09/559,122, filed on Apr. 26, 2000, (10) PCT patent application serial no. PCT/US00/18635, filed on Jul. 9, 2000, (11) U.S. provisional patent application Ser. No. 60/162,671, filed on Nov. 1, 1999, (12) U.S. provisional patent application Ser. No. 60/154,047, filed on Sep. 16, 1999, (13) U.S. provisional patent application Ser. No. 60/159,082, filed on Oct. 12, 1999, (14) U.S. provisional patent application Ser. No. 60/159,039, filed on Oct. 12, 1999, (15) U.S. provisional patent application Ser. No. 60/159,033, filed on Oct. 12, 1999, (16) U.S. provisional patent application Ser. No. 60/212,359, filed on Jun. 19, 2000, (17) U.S. provisional patent application Ser. No. 60/165,228, filed on Nov. 12, 1999, (18) U.S. provisional patent application Ser. No. 60/221,443, filed on Jul. 28, 2000, (19) U.S. provisional patent application Ser. No. 60/221,645, filed on Jul. 28, 2000, (20) U.S. provisional patent application Ser. No. 60/233,638, filed on Sep. 18, 2000, (21) U.S. provisional patent application Ser. No. 60/237,334, filed on Oct. 2, 2000, (22) U.S. provisional patent application Ser. No. 60/270,007, filed on Feb. 20, 2001, (23) U.S. provisional patent application Ser. No. 60/262,434, filed on Jan. 17, 2001, (24) U.S. provisional patent application Ser. No. 60/259,486, filed on Jan. 3, 2001, (25) U.S. provisional patent application Ser. No. 60/303,740, filed on Jul. 6, 2001, (26) U.S. provisional patent application Ser. No. 60/313,453, filed on Aug. 20, 2001, (27) U.S. provisional patent application Ser. No. 60/317,985, filed on Sep. 6, 2001, (28) U.S. provisional patent application Ser. No. 60/318,386, filed on Sep. 10, 2001, (29) U.S. utility patent application Ser. No. 09/969,922, filed on Oct. 3, 2001, (30) U.S. utility patent application Ser. No. 10/016,467, filed on Dec. 10, 2001; (31) U.S. provisional patent application Ser. No. 60/343,674, filed on Dec. 27, 2001; (32) U.S. provisional patent application Ser. No. 60/346,309, filed on Jan. 7, 2002; and (33) U.S. provisional patent application Ser. No. 60/372,478, filed on Apr. 12, 2002, the disclosures of which are incorporated herein by reference.

### BACKGROUND OF THE INVENTION

This invention relates generally to oil and gas exploration, and in particular to forming and repairing wellbore casings to facilitate oil and gas exploration.

During oil exploration, a wellbore typically traverses a number of zones within a subterranean formation. Wellbore casings are then formed in the wellbore by radially expanding and plastically deforming tubular members that are coupled to one another by threaded connections. Existing methods for radially expanding and plastically deforming tubular members coupled to one another by threaded connections are not always reliable or produce satisfactory results. In particular, the threaded connections can be damaged during the radial expansion process.

The present invention is directed to overcoming one or more of the limitations of the existing processes for radially expanding and plastically deforming tubular members coupled to one another by threaded connections.

### SUMMARY OF THE INVENTION

According to one aspect of the present invention, a method is provided that includes coupling an end of a first tubular member to an end of a tubular sleeve, coupling an end of a second tubular member to another end of the tubular sleeve, coupling the ends of the first and second tubular members, and radially expanding and plastically deforming the first tubular member and the second tubular member.

According to another aspect of the present invention, an apparatus is provided that includes a tubular sleeve, a first tubular member coupled to an end of the tubular sleeve, and a second tubular member coupled to another end of the tubular sleeve and the first tubular member.

According to another aspect of the present invention, a method of extracting geothermal energy from a subterranean source of geothermal energy is provided that includes drilling a borehole that traverses the subterranean source of geothermal energy, positioning a first casing string within the borehole, radially expanding and plastically deforming the first casing string within the borehole, positioning a second casing string within the borehole that traverses the subterranean source of geothermal energy, overlapping a portion of the second casing string with a portion of the first casing string, radially expanding and plastically deforming the second casing string within the borehole, and extracting geothermal energy from the subterranean source of geothermal energy using the first and second casing strings.

According to another aspect of the present invention, an apparatus for extracting geothermal energy from a subterranean source of geothermal energy is provided that includes a borehole that traverses the subterranean source of geothermal energy, a first casing string positioned within the borehole, and a second casing positioned within the borehole that overlaps with the first casing string that traverses the subterranean source of geothermal energy. The first casing string and the second casing string are radially expanded and plastically deformed within the borehole.

According to another aspect of the present invention, a method is provided that includes coupling an end of a first tubular member to an end of a tubular sleeve, coupling an end of a second tubular member to another end of the tubular sleeve, coupling the ends of the first and second tubular members, injecting a pressurized fluid through the first and second tubular members, determining if any of the pressurized fluid leaks through the coupled ends of the first and second tubular members, and if a predetermined amount of the pressurized fluid leaks through the coupled ends of the first and second tubular members, then coupling a tubular sleeve to the ends of the first and second tubular members and radially expanding and plastically deforming only the portions of the first and second tubular members proximate the tubular sleeve.

### BRIEF DESCRIPTION OF THE DRAWINGS

FIG. 1a is a fragmentary cross-sectional illustration of a first tubular member having an internally threaded connection at an end portion.

FIG. 1b is a fragmentary cross-sectional illustration of the placement of a tubular sleeve onto the end portion of the first tubular member of FIG. 1a.

FIG. 1c is a fragmentary cross-sectional illustration of the coupling of an externally threaded connection at an end portion of a second tubular member to the internally threaded connection at the end portion of the first tubular member of FIG. 1b.

FIG. 1d is a fragmentary cross-sectional illustration of the radial expansion and plastic deformation of a portion of the first tubular member of FIG. 1c.

FIG. 1e is a fragmentary cross sectional of the continued radial expansion and plastic deformation of the threaded connection between the first and second tubular members and the tubular sleeve of FIG. 1d.

FIG. 2a is a fragmentary cross-sectional illustration of the radial expansion and plastic deformation of a portion of a first tubular member having an internally threaded connection at an end portion, an alternative embodiment of a tubular sleeve supported by the end portion of the first tubular member, and a second tubular member having an externally threaded portion coupled to the internally threaded portion of the first tubular member.

FIG. 2b is a fragmentary cross sectional of the continued radial expansion and plastic deformation of the threaded connection between the first and second tubular members and the tubular sleeve of FIG. 2a.

FIG. 3a is a fragmentary cross-sectional illustration of the radial expansion and plastic deformation of a portion of a first tubular member having an internally threaded connection at an end portion, an alternative embodiment of a tubular sleeve supported by the end portion of the first tubular member, and a second tubular member having an externally threaded portion coupled to the internally threaded portion of the first tubular member.

FIG. 3b is a fragmentary cross sectional of the continued radial expansion and plastic deformation of the threaded connection between the first and second tubular members and the tubular sleeve of FIG. 3a.

FIG. 4a is a fragmentary cross-sectional illustration of the radial expansion and plastic deformation of a portion of a first tubular member having an internally threaded connection at an end portion, an alternative embodiment of a tubular sleeve having an external sealing element supported by the end portion of the first tubular member, and a second tubular member having an externally threaded portion coupled to the internally threaded portion of the first tubular member.

FIG. 4b is a fragmentary cross sectional of the continued radial expansion and plastic deformation of the threaded connection between the first and second tubular members and the tubular sleeve of FIG. 4a.

FIG. 5a is a fragmentary cross-sectional illustration of the radial expansion and plastic deformation of a portion of a first tubular member having an internally threaded connection at an end portion, an alternative embodiment of a tubular sleeve supported by the end portion of the first tubular member, and a second tubular member having an externally threaded portion coupled to the internally threaded portion of the first tubular member.

FIG. 5b is a fragmentary cross sectional of the continued radial expansion and plastic deformation of the threaded connection between the first and second tubular members and the tubular sleeve of FIG. 5a.

FIG. 6a is a fragmentary cross sectional illustration of an alternative embodiment of a tubular sleeve.

FIG. 6b is a fragmentary cross sectional illustration of an alternative embodiment of a tubular sleeve.

FIG. 6c is a fragmentary cross sectional illustration of an alternative embodiment of a tubular sleeve.

FIG. 6d is a fragmentary cross sectional illustration of an alternative embodiment of a tubular sleeve.

FIG. 7a is a fragmentary cross-sectional illustration of a first tubular member having an internally threaded connection at an end portion.

FIG. 7b is a fragmentary cross-sectional illustration of the placement of an alternative embodiment of a tubular sleeve onto the end portion of the first tubular member of FIG. 7a.

FIG. 7c is a fragmentary cross-sectional illustration of the coupling of an externally threaded connection at an end portion of a second tubular member to the internally threaded connection at the end portion of the first tubular member of FIG. 7b.

FIG. 7d is a fragmentary cross-sectional illustration of the radial expansion and plastic deformation of a portion of the first tubular member of FIG. 1c.

FIG. 7e is a fragmentary cross sectional of the continued radial expansion and plastic deformation of the threaded connection between the first and second tubular members and the tubular sleeve of FIG. 7d.

FIG. 8a is a fragmentary cross-sectional illustration of a first tubular member having an internally threaded connection at an end portion.

FIG. 8b is a fragmentary cross-sectional illustration of the placement of an alternative embodiment of a tubular sleeve onto the end portion of the first tubular member of FIG. 8a.

FIG. 8c is a fragmentary cross-sectional illustration of the coupling of the tubular sleeve of FIG. 8b to the end portion of the first tubular member.

FIG. 8d is a fragmentary cross-sectional illustration of the coupling of an externally threaded connection at an end portion of a second tubular member to the internally threaded connection at the end portion of the first tubular member of FIG. 8b.

FIG. 8e is a fragmentary cross-sectional illustration of the coupling of the tubular sleeve of FIG. 8d to the end portion of the second tubular member.

FIG. 8f is a fragmentary cross-sectional illustration of the radial expansion and plastic deformation of a portion of the first tubular member of FIG. 8e.

FIG. 8g is a fragmentary cross sectional of the continued radial expansion and plastic deformation of the threaded connection between the first and second tubular members and the tubular sleeve of FIG. 8f.

FIG. 9a is a fragmentary cross-sectional illustration of a first tubular member having an internally threaded connection at an end portion.

FIG. 9b is a fragmentary cross-sectional illustration of the placement of an alternative embodiment of a tubular sleeve onto the end portion of the first tubular member of FIG. 9a.

FIG. 9c is a fragmentary cross-sectional illustration of the coupling of an externally threaded connection at an end portion of a second tubular member to the internally threaded connection at the end portion of the first tubular member of FIG. 9b.

FIG. 9d is a fragmentary cross-sectional illustration of the radial expansion and plastic deformation of a portion of the first tubular member of FIG. 9c.

FIG. 9e is a fragmentary cross sectional of the continued radial expansion and plastic deformation of the threaded connection between the first and second tubular members and the tubular sleeve of FIG. 9d.

FIG. 10a is a fragmentary cross-sectional illustration of a first tubular member having an internally threaded connection at an end portion.

FIG. 10b is a fragmentary cross-sectional illustration of the placement of an alternative embodiment of a tubular sleeve onto the end portion of the first tubular member of FIG. 10a.

FIG. 10c is a fragmentary cross-sectional illustration of the coupling of an externally threaded connection at an end portion of a second tubular member to the internally threaded connection at the end portion of the first tubular member of FIG. 10b.

FIG. 10d is a fragmentary cross-sectional illustration of the radial expansion and plastic deformation of a portion of the first tubular member of FIG. 10c.

FIG. 10e is a fragmentary cross sectional of the continued radial expansion and plastic deformation of the threaded connection between the first and second tubular members and the tubular sleeve of FIG. 10d.

FIG. 11a is a fragmentary cross-sectional illustration of a first tubular member having an internally threaded connection at an end portion.

FIG. 11b is a fragmentary cross-sectional illustration of the placement of an alternative embodiment of a tubular sleeve onto the end portion of the first tubular member of FIG. 11a.

FIG. 11c is a fragmentary cross-sectional illustration of the coupling of an externally threaded connection at an end portion of a second tubular member to the internally threaded connection at the end portion of the first tubular member of FIG. 11b.

FIG. 11d is a fragmentary cross-sectional illustration of the radial expansion and plastic deformation of a portion of the first tubular member of FIG. 11c.

FIG. 11e is a fragmentary cross sectional of the continued radial expansion and plastic deformation of the threaded connection between the first and second tubular members and the tubular sleeve of FIG. 11d.

FIG. 12a is a fragmentary cross-sectional illustration of a first tubular member having an internally threaded connection at an end portion.

FIG. 12b is a fragmentary cross-sectional illustration of the placement of an alternative embodiment of a tubular sleeve onto the end portion of the first tubular member of FIG. 12a.

FIG. 12c is a fragmentary cross-sectional illustration of the coupling of an externally threaded connection at an end portion of a second tubular member to the internally threaded connection at the end portion of the first tubular member of FIG. 12b.

FIG. 12d is a fragmentary cross-sectional illustration of the radial expansion and plastic deformation of a portion of the first tubular member of FIG. 12c.

FIG. 12e is a fragmentary cross sectional of the continued radial expansion and plastic deformation of the threaded connection between the first and second tubular members and the tubular sleeve of FIG. 12d.

FIG. 13a is a fragmentary cross-sectional illustration of the coupling of an end portion of an alternative embodiment of a tubular sleeve onto the end portion of a first tubular member.

FIG. 13b is a fragmentary cross-sectional illustration of the coupling of an end portion of a second tubular member to the other end portion of the tubular sleeve of FIG. 13a.

FIG. 13c is a fragmentary cross-sectional illustration of the radial expansion and plastic deformation of a portion of the first tubular member of FIG. 13b.

FIG. 13d is a fragmentary cross sectional of the continued radial expansion and plastic deformation of the threaded connection between the first and second tubular members and the tubular sleeve of FIG. 13c.

FIG. 14a is a fragmentary cross-sectional illustration of an end portion of a first tubular member.

FIG. 14b is a fragmentary cross-sectional illustration of the coupling of an end portion of an alternative embodiment of a tubular sleeve onto the end portion of the first tubular member of FIG. 14a.

FIG. 14c is a fragmentary cross-sectional illustration of the coupling of an end portion of a second tubular member to the other end portion of the tubular sleeve of FIG. 14b.

FIG. 14d is a fragmentary cross-sectional illustration of the radial expansion and plastic deformation of a portion of the first tubular member of FIG. 14c.

FIG. 14e is a fragmentary cross sectional of the continued radial expansion and plastic deformation of the threaded connection between the first and second tubular members and the tubular sleeve of FIG. 14d.

FIG. 15a is a fragmentary cross-sectional illustration of the coupling of an internally threaded end portion of a first tubular member to an externally threaded end portion of a second tubular member including a protective sleeve coupled to the end portions of the first and second tubular member.

FIG. 15b is a cross-sectional illustration of the first and second tubular members and the protective sleeve following the radial expansion of the first and second tubulars and the protective sleeve.

FIG. 15c is a fragmentary cross-sectional illustration of an alternative embodiment that includes a metallic foil for amorphously bonding the first and second tubular members of FIGS. 15a and 15b during the radial expansion and plastic deformation of the tubular members.

FIG. 16 is a cross-sectional illustration of a borehole including a plurality of overlapping radially expanded wellbore casings that traverses a subterranean source of geothermal energy.

FIG. 17a is a fragmentary cross-sectional illustration of the coupling of an internally threaded end portion of a first tubular member to an externally threaded end portion of a second tubular member including a protective sleeve coupled to the end portions of the first and second tubular member.

FIG. 17b is a fragmentary cross-sectional illustration of the radial expansion and plastic deformation of the threaded portions of the first and second tubular members using an adjustable expansion cone.

FIG. 17c is an enlarged fragmentary cross-sectional illustration of the threaded portions of the first and second tubular members and the protective sleeve prior to the radial expansion and plastic deformation of the threaded portions.

FIG. 17d is an enlarged fragmentary cross-sectional illustration of the threaded portions of the first and second tubular members and the protective sleeve after the radial expansion and plastic deformation of the threaded portions.

FIG. 18a is a fragmentary cross-sectional illustration of the coupling of an internally threaded end portion of a first tubular member to an externally threaded end portion of a second tubular member including a protective sleeve coupled to the end portions of the first and second tubular member.

FIG. 18b is a fragmentary cross-sectional illustration of the radial expansion and plastic deformation of the threaded portions of the first and second tubular members using a rotary expansion tool.

FIG. 19 is an exemplary embodiment of a method of providing a fluid tight seal in the junction between a pair of adjacent tubular members.

### DETAILED DESCRIPTION OF THE ILLUSTRATIVE EMBODIMENTS

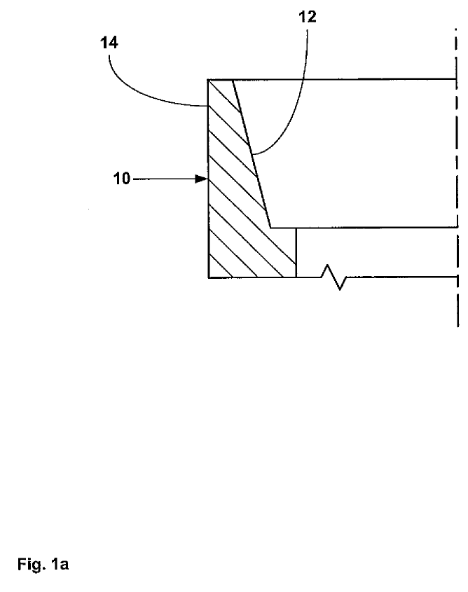

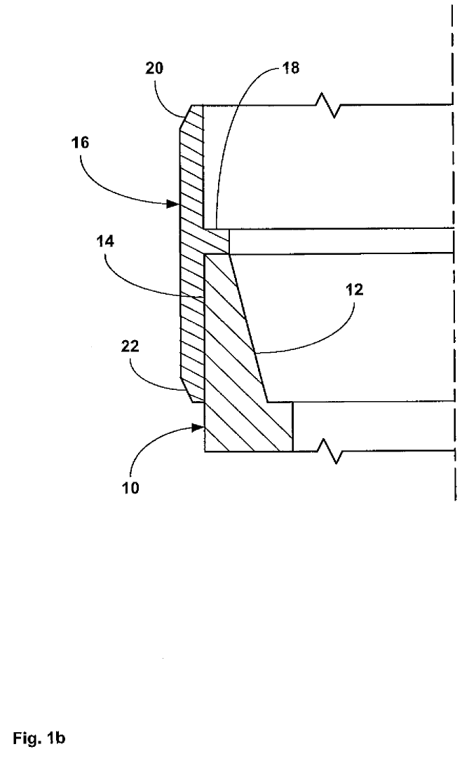

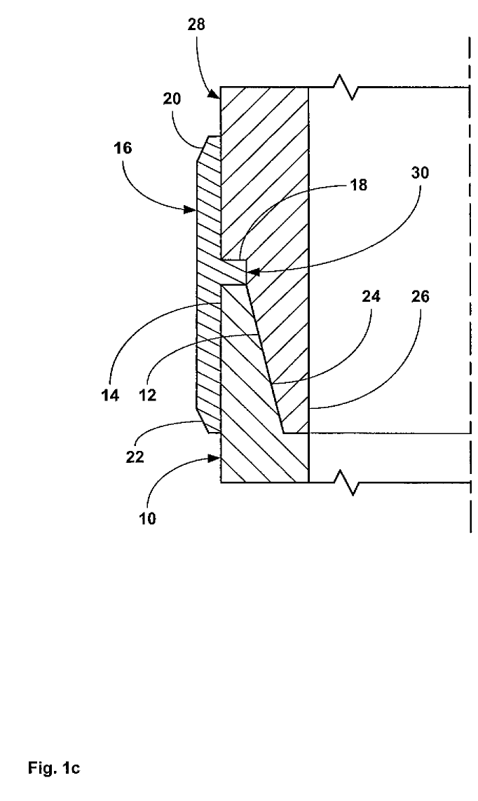

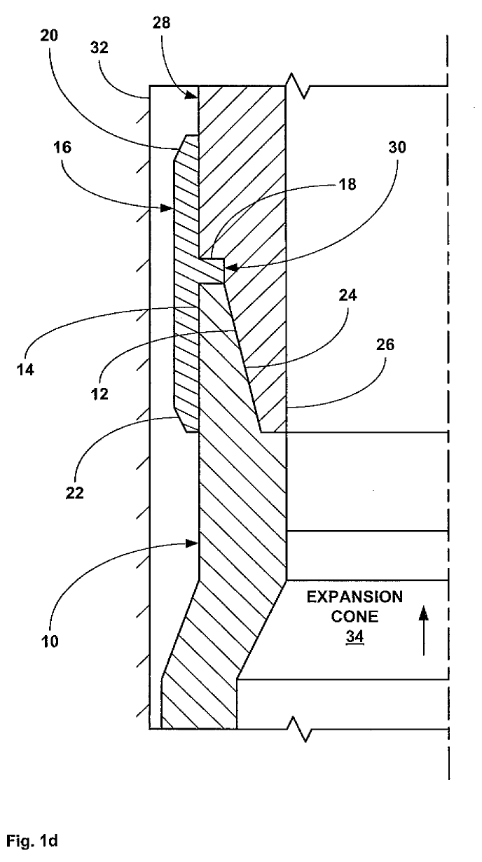

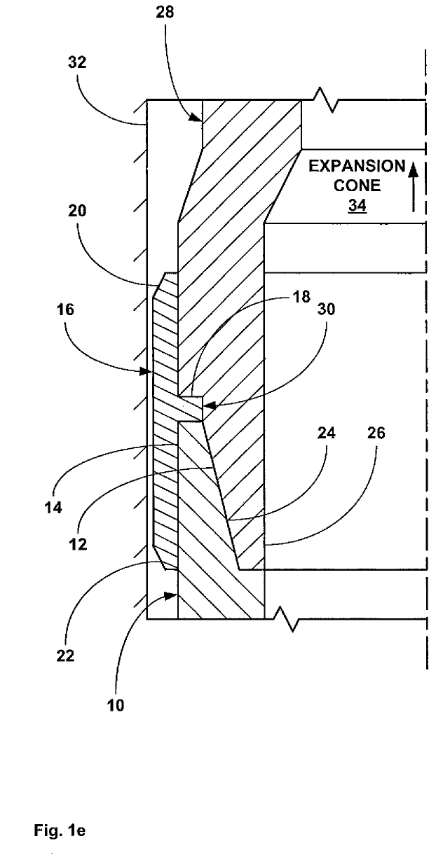

Referring to FIG. 1a, a first tubular member 10 includes an internally threaded connection 12 at an end portion 14. As illustrated in FIG. 1b, a first end of a tubular sleeve 16 that includes an internal flange 18 and tapered portions, 20 and 22, at opposite ends is then mounted upon and receives the end portion 14 of the first tubular member 10. In an exemplary embodiment, the end portion 14 of the first tubular member 10 abuts one side of the internal flange 18 of the tubular sleeve 16, and the internal diameter of the internal flange of the tubular sleeve is substantially equal to or greater than the maximum internal diameter of the internally threaded connection 12 of the end portion of the first tubular member. As illustrated in FIG. 1e, an externally threaded connection 24 of an end portion 26 of a second tubular member 28 having an annular recess 30 is then positioned within the tubular sleeve 16 and threadably coupled to the internally threaded connection 12 of the end portion 14 of the first tubular member 10. In an exemplary embodiment, the internal flange 18 of the tubular sleeve 16 mates with and is received within the annular recess 30 of the end portion 26 of the second tubular member 28. Thus, the tubular sleeve 16 is coupled to and surrounds the external surfaces of the first and second tubular members, 10 and 28.

In an exemplary embodiment, the internally threaded connection 12 of the end portion 14 of the first tubular member 10 is a box connection, and the externally threaded connection 24 of the end portion 26 of the second tubular member 28 is a pin connection. In an exemplary embodiment, the internal diameter of the tubular sleeve 16 is at least approximately M20″ greater than the outside diameters of the first and second tubular members, 10 and 28. In this manner, during the threaded coupling of the first and second tubular members, 10 and 28, fluidic materials within the first and second tubular members may be vented from the tubular members.

In an exemplary embodiment, as illustrated in FIGS. 1d and 1e, the first and second tubular members, 10 and 28, and the tubular sleeve 16 may then be positioned within another structure 32 such as, for example, a wellbore, and radially expanded and plastically deformed, for example, by moving an expansion cone 34 through the interiors of the first and second tubular members. The tapered portions, 20 and 22, of the tubular sleeve 16 facilitate the insertion and movement of the first and second tubular members within and through the structure 32, and the movement of the expansion cone 34 through the interiors of the first and second tubular members, 10 and 28, may be from top to bottom or from bottom to top.

In an exemplary embodiment, during the radial expansion and plastic deformation of the first and second tubular members, 10 and 28, the tubular sleeve 16 is also radially expanded and plastically deformed. In an exemplary embodiment, as a result, the tubular sleeve 16 may be maintained in circumferential tension and the end portions, 14 and 26, of the first and second tubular members, 10 and 28, may be maintained in circumferential compression.

In several exemplary embodiments, the first and second tubular members, 10 and 28, are radially expanded and plastically deformed using the expansion cone 34 in a conventional manner and/or using one or more of the methods and apparatus disclosed in one or more of the following: (1) U.S. patent application Ser. No. 09/454,139, filed on Dec. 3, 1999, (2) U.S. patent application Ser. No. 09/510,913, filed on Feb. 23, 2000, (3) U.S. patent application Ser. No. 09/502,350, filed on Feb. 10, 2000, (4) U.S. patent application Ser. No. 09/440,338, filed on Nov. 15, 1999, (5) U.S. patent application Ser. No. 09/523,460, filed on Mar. 10, 2000, (6) U.S. patent application Ser. No. 09/512,895, filed on Feb. 24, 2000, (7) U.S. patent application Ser. No. 09/511,941, filed on Feb. 24, 2000, (8) U.S. patent application Ser. No. 09/588,946, filed on Jun. 7, 2000, (9) U.S. patent application Ser. No. 09/559,122, filed on Apr. 26, 2000, (10) PCT patent application serial no. PCT/US00/18635, filed on Jul. 9, 2000, (11) U.S. provisional patent application Ser. No. 60/162,671, filed on Nov. 1, 1999, (12) U.S. provisional patent application Ser. No. 60/154,047, filed on Sep. 16, 1999, (13) U.S. provisional patent application Ser. No. 60/159,082, filed on Oct. 12, 1999, (14) U.S. provisional patent application Ser. No. 60/159,039, filed on Oct. 12, 1999, (15) U.S. provisional patent application Ser. No. 60/159,033, filed on Oct. 12, 1999, (16) U.S. provisional patent application Ser. No. 60/212,359, filed on Jun. 19, 2000, (17) U.S. provisional patent application Ser. No. 60/165,228, filed on Nov. 12, 1999, (18) U.S. provisional patent application Ser. No. 60/221,443, filed on Jul. 28, 2000, (19) U.S. provisional patent application Ser. No. 60/221,645, filed on Jul. 28, 2000, (20) U.S. provisional patent application Ser. No. 60/233,638, filed on Sep. 18, 12000, (21) U.S. provisional patent application Ser. No. 60/237,334, filed on Oct. 2, 2000, (22) U.S. provisional patent application Ser. No. 60/270,007, filed on Feb. 20, 2001; (23) U.S. provisional patent application Ser. No. 60/262,434, filed on Jan. 17, 2001; (24) U.S. provisional patent application Ser. No. 60/259,486, filed on Jan. 3, 2001, (25) U.S. provisional patent application Ser. No. 60/303,740, filed on Jul. 6, 2001, (26) U.S. provisional patent application Ser. No. 60/313,453, filed on Aug. 20, 2001, (27) U.S. provisional patent application Ser. No. 60/317,985, filed on Sep. 6, 2001, (28) U.S. provisional patent application Ser. No. 60/318,386, filed on Sep. 10, 2001, (29) U.S. utility patent application Ser. No. 09/969,922, filed on Oct. 3, 2001, (30) U.S. utility patent application Ser. No. 10/016,467, filed on Dec. 10, 2001; (31) U.S. provisional patent application Ser. No. 60/343,674, filed on Dec. 27, 2001; (32) U.S. provisional patent application Ser. No. 60/346,309, filed on Jan. 7, 2002; and (33) U.S. provisional patent application Ser. No. 60/372,478, filed on Apr. 12, 2002, the disclosures of which are incorporated herein by reference.

In several alternative embodiments, the first and second tubular members, 10 and 28, are radially expanded and plastically deformed using other conventional methods for radially expanding and plastically deforming tubular members such as, for example, internal pressurization and/or roller expansion devices such as, for example, that disclosed in U.S. patent application publication no. US 2001/0045284 A1, the disclosure of which is incorporated herein by reference.

The use of the tubular sleeve 16 during (a) the coupling of the first tubular member 10 to the second tubular member 28, (b) the placement of the first and second tubular members in the structure 32, and (c) the radial expansion and plastic deformation of the first and second tubular members provides a number of significant benefits. For example, the tubular sleeve 16 protects the exterior surfaces of the end portions, 14 and 26, of the first and second tubular members, 10 and 28, during handling and insertion of the tubular members within the structure 32. In this manner, damage to the exterior surfaces of the end portions, 14 and 26, of the first and second tubular member, 10 and 28, are prevented that could result in stress concentrations that could result in a catastrophic failure during subsequent radial expansion operations. Furthermore, the tubular sleeve 16 provides an alignment guide that facilitates the insertion and threaded coupling of the second tubular member 28 to the first tubular member 10. In this manner, misalignment that could result in damage to the threaded connections, 12 and 24, of the first and second tubular members, 10 and 28, may be avoided. In addition, during the relative rotation of the second tubular member with respect to the first tubular member, required during the threaded coupling of the first and second tubular members, the tubular sleeve 16 provides an indication of to what degree the first and second tubular members are threadably coupled. For example, if the tubular sleeve 16 can be easily rotated, that would indicate that the first and second tubular members, 10 and 28, are not fully threadably coupled and in intimate contact with the internal flange 18 of the tubular sleeve. Furthermore, the tubular sleeve 16 may prevent crack propagation during the radial expansion and plastic deformation of the first and second tubular members, 10 and 28. In this manner, failure modes such as, for example, longitudinal cracks in the end portions, 14 and 26, of the first and second tubular members may be limited in severity or eliminated all together. In addition, after completing the radial expansion and plastic deformation of the first and second tubular members, 10 and 28, the tubular sleeve 16 may provide a fluid tight metal-to-metal seal between interior surface of the tubular sleeve and the exterior surfaces of the end portions, 14 and 26, of the first and second tubular members. In this manner, fluidic materials are prevented from passing through the threaded connections, 12 and 24, of the first and second tubular members, 10 and 28, into the annulus between the first and second tubular members and the structure 32. Furthermore, because, following the radial expansion and plastic deformation of the first and second tubular members, 10 and 28, the tubular sleeve 16 may be maintained in circumferential tension and the end portions, 14 and 26, of the first and second tubular members, 10 and 28, may be maintained in circumferential compression, axial loads and/or torque loads may be transmitted through the tubular sleeve. In addition, the tubular sleeve 16 may also increase the collapse strength of the end portions, 14 and 26, of the first and second tubular members, 10 and 28.

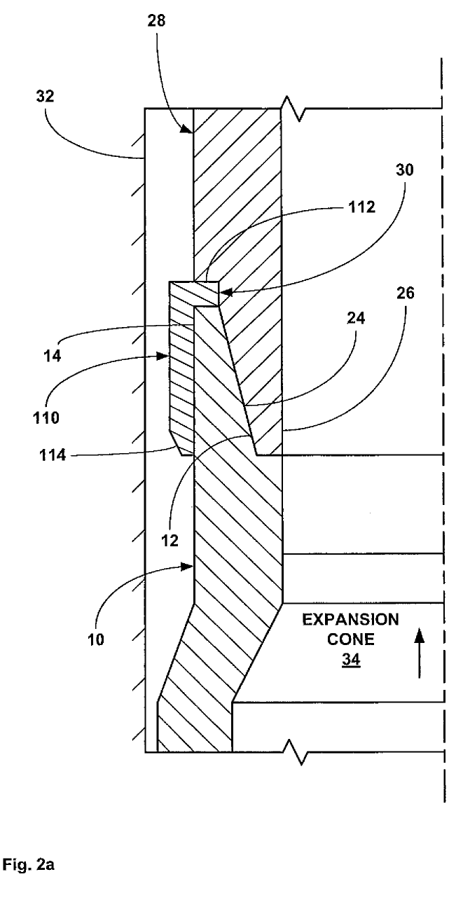

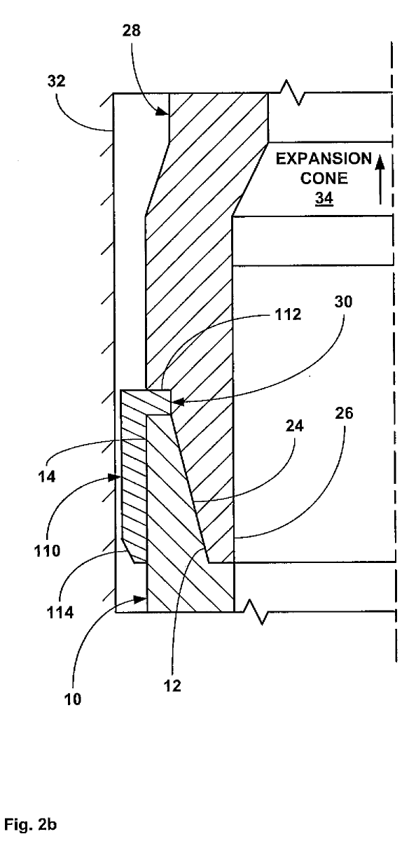

Referring to FIGS. 2a and 2b, in an alternative embodiment, a tubular sleeve 110 having an internal flange 112 and a tapered portion 114 is coupled to the first and second tubular members, 10 and 28. In particular, the tubular sleeve 110 receives and mates with the end portion 14 of the first tubular member 10, and the internal flange 112 of the tubular sleeve is received within the annular recess 30 of the second tubular member 28 proximate the end of the first tubular member. in this manner, the tubular sleeve 110 is coupled to the end portions, 14 and 26, of the first and second tubular members, 10 and 28, and the tubular sleeve covers the end portion 14 of the first tubular member 10.

In an exemplary embodiment, the first and second tubular members, 10 and 28, and the tubular sleeve 110 may then be positioned within the structure 32 and radially expanded and plastically deformed, for example, by moving an expansion cone 34 through the interiors of the first and second tubular members. In an exemplary embodiment, following the radial expansion and plastic deformation of the first and second tubular members, 10 and 28, the tubular sleeve 110 may be maintained in circumferential tension and the end portions, 14 and 26, of the first and second tubular members, 10 and 28, may be maintained in circumferential compression.

The use of the tubular sleeve 110 during (a) the coupling of the first tubular member 10 to the second tubular member 28, (b) the placement of the first and second tubular members in the structure 32, and (c) the radial expansion and plastic deformation of the first and second tubular members provides a number of significant benefits. For example, the tubular sleeve 110 protects the exterior surface of the end portion 14 of the first tubular member 10 during handling and insertion of the tubular members within the structure 32. In this manner, damage to the exterior surfaces of the end portion 14 of the first tubular member 10 is prevented that could result in stress concentrations that could result in a catastrophic failure during subsequent radial expansion operations. In addition, during the relative rotation of the second tubular member with respect to the first tubular member, required during the threaded coupling of the first and second tubular members, the tubular sleeve 110 provides an indication of to what degree the first and second tubular members are threadably coupled. For example, if the tubular sleeve 110 can be easily rotated, that would indicate that the first and second tubular members, 10 and 28, are not fully threadably coupled and in intimate contact with the internal flange 112 of the tubular sleeve. Furthermore, the tubular sleeve 110 may prevent crack propagation during the radial expansion and plastic deformation of the first and second tubular members, 10 and 28. In this manner, failure modes such as, for example, longitudinal cracks in the end portions, 14 and 26, of the first and second tubular members may be limited in severity or eliminated all together. In addition, after completing the radial expansion and plastic deformation of the first and second tubular members, 10 and 28, the tubular sleeve 110 may provide a fluid tight metal-to-metal seal between interior surface of the tubular sleeve and the exterior surface of the end portion 14 of the first tubular member. In this manner, fluidic materials are prevented from passing through the threaded connections, 12 and 24, of the first and second tubular members, 10 and 28, into the annulus between the first and second tubular members and the structure 32. Furthermore because, following the radial expansion and plastic deformation of the first and second tubular members, 10 and 28, the tubular sleeve 110 may be maintained in circumferential tension and the end portions, 14 and 26, of the first and second tubular members, 10 and 28, may be maintained in circumferential compression, axial loads and/or torque loads may be transmitted through the tubular sleeve.

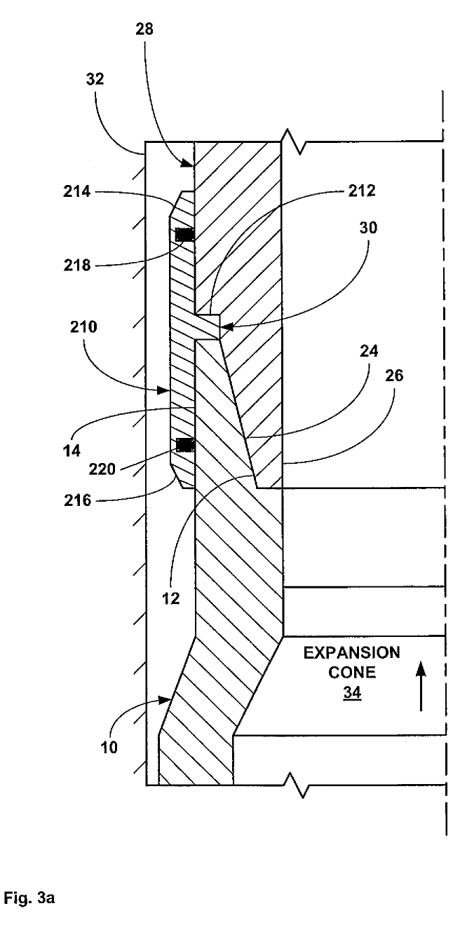

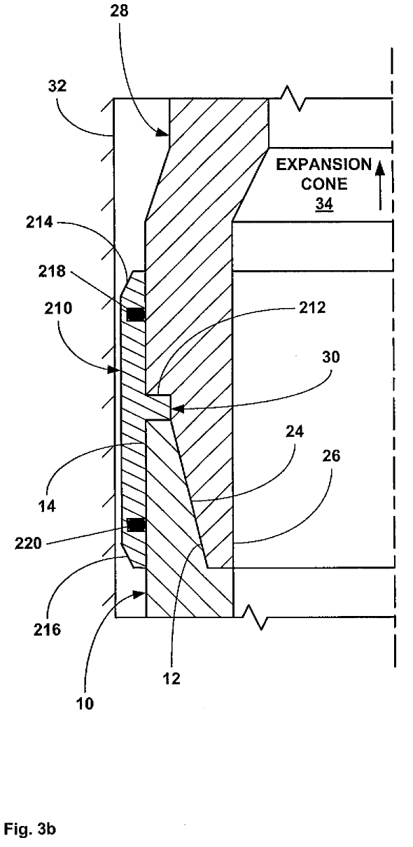

Referring to FIGS. 3a and 3b, in an alternative embodiment, a tubular sleeve 210 having an internal flange 212, tapered portions, 214 and 216, at opposite ends, and annular sealing members, 218 and 220, positioned on opposite sides of the internal flange, is coupled to the first and second tubular members, 10 and 28. In particular, the tubular sleeve 210 receives and mates with the end portions, 14 and 26, of the first and second tubular members, 10 and 28, and the internal flange 212 of the tubular sleeve is received within the annular recess 30 of the second tubular member 28 proximate the end of the first tubular member. Furthermore, the sealing members, 218 and 220, of the tubular sleeve 210 engage and fluidicly seal the interface between the tubular sleeve and the end portions, 14 and 26, of the first and second tubular members, 10 and 28. In this manner, the tubular sleeve 210 is coupled to the end portions, 14 and 26, of the first and second tubular members, 10 and 28, and the tubular sleeve covers the end portions, 14 and 26, of the first and second tubular members, 10 and 28.

In an exemplary embodiment, the first and second tubular members, 10 and 28, and the tubular sleeve 210 may then be positioned within the structure 32 and radially expanded and plastically deformed, for example, by moving an expansion cone 34 through the interiors of the first and second tubular members. In an exemplary embodiment, following the radial expansion and plastic deformation of the first and second tubular members, 10 and 28, the tubular sleeve 210 may be maintained in circumferential tension and the end portions, 14 and 26, of the first and second tubular members, 10 and 28, may be maintained in circumferential compression.

The use of the tubular sleeve 210 during (a) the coupling of the first tubular member 10 to the second tubular member 28, (b) the placement of the first and second tubular members in the structure 32, and (c) the radial expansion and plastic deformation of the first and second tubular members provides a number of significant benefits. For example, the tubular sleeve 210 protects the exterior surfaces of the end portions, 14 and 26, of the first and second tubular members, 10 and 28, during handling and insertion of the tubular members within the structure 32. In this manner, damage to the exterior surfaces of the end portions, 14 and 26, of the first and second tubular members, 10 and 28, is prevented that could result in stress concentrations that could result in a catastrophic failure during subsequent radial expansion operations. In addition, during the relative rotation of the second tubular member with respect to the first tubular member, required during the threaded coupling of the first and second tubular members, the tubular sleeve 210 provides an indication of to what degree the first and second tubular members are threadably coupled. For example, if the tubular sleeve 210 can be easily rotated, that would indicate that the first and second tubular members, 10 and 28, are not fully threadably coupled and in intimate contact with the internal flange 212 of the tubular sleeve. Furthermore, the tubular sleeve 210 may prevent crack propagation during the radial expansion and plastic deformation of the first and second tubular members, 10 and 28. In this manner, failure modes such as, for example, longitudinal cracks in the end portions, 14 and 26, of the first and second tubular members, 10 and 28, may be limited in severity or eliminated all together. In addition, after completing the radial expansion and plastic deformation of the first and second tubular members, 10 and 28, the tubular sleeve 210 may provide a fluid tight metal-to-metal seal between interior surface of the tubular sleeve and the exterior surfaces of the end portions, 14 and 26, of the first and second tubular members. In this manner, fluidic materials are prevented from passing through the threaded connections, 12 and 24, of the first and second tubular members, 10 and 28, into the annulus between the first and second tubular members and the structure 32. Furthermore, because, following the radial expansion and plastic deformation of the first and second tubular members, 10 and 28, the tubular sleeve 21 0 may be maintained in circumferential tension and the end portions, 14 and 26, of the first and second tubular members, 10 and 28, may be maintained in circumferential compression, axial loads and/or torque loads may be transmitted through the tubular sleeve. In addition, the tubular sleeve 210 may also increase the collapse strength of the end portions, 14 and 26, of the first and second tubular members, 10 and 28.

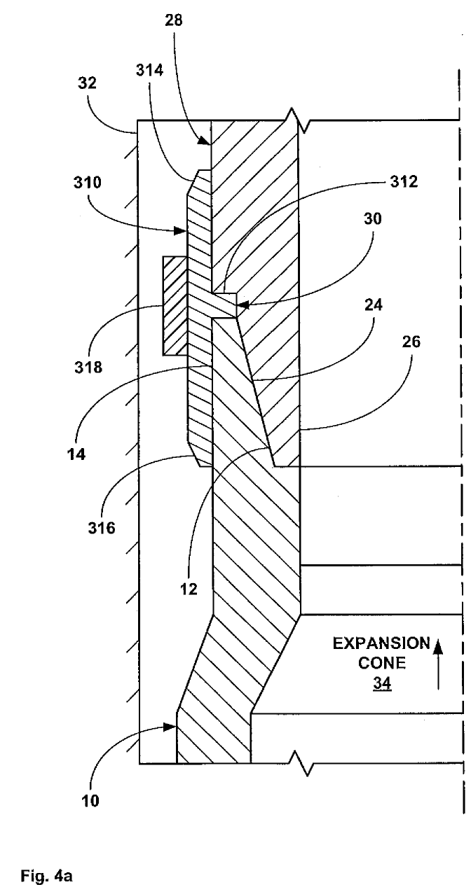

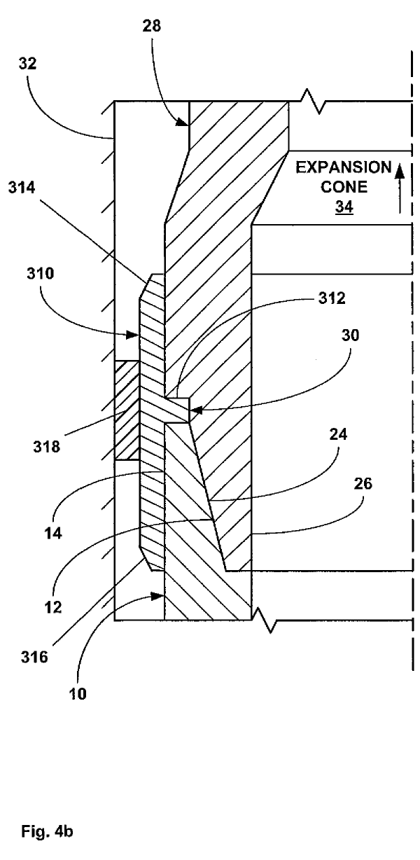

Referring to FIGS. 4a and 4b, in an alternative embodiment, a tubular sleeve 310 having an internal flange 312, tapered portions, 314 and 316, at opposite ends, and an annular sealing member 318 positioned on the exterior surface of the tubular sleeve, is coupled to the first and second tubular members, 10 and 28. In particular, the tubular sleeve 310 receives and mates with the end portions, 14 and 26, of the first and second tubular members, 10 and 28, and the internal flange 312 of the tubular sleeve is received within the annular recess 30 of the second tubular member 28 proximate the end of the first tubular member. In this manner, the tubular sleeve 310 is coupled to the end portions, 14 and 26, of the first and second tubular members, 10 and 28, and the tubular sleeve covers the end portions, 14 and 26, of the first and second tubular members, 10 and 28.

In an exemplary embodiment, the first and second tubular members, 10 and 28, and the tubular sleeve 310 may then be positioned within the structure 32 and radially expanded and plastically deformed, for example, by moving an expansion cone 34 through the interiors of the first and second tubular members. In an exemplary embodiment, following the radial expansion and plastic deformation of the first and second tubular members, 10 and 28, the tubular sleeve 310 may be maintained in circumferential tension and the end portions, 14 and 26, of the first and second tubular members, 10 and 28, may be maintained in circumferential compression. Furthermore, in an exemplary embodiment, following the radial expansion and plastic deformation of the first and second tubular members, 10 and 28, the annular seating member 318 circumferentially engages the interior surface of the structure 32 thereby preventing the passage of fluidic materials through the annulus between the tubular sleeve 310 and the structure. In this manner, the tubular sleeve 310 may provide an expandable packer element.

The use of the tubular sleeve 310 during (a) the coupling of the first tubular member 10 to the second tubular member 28, (b) the placement of the first and second tubular members in the structure 32, and (c) the radial expansion and plastic deformation of the first and second tubular members provides a number of significant benefits. For example, the tubular sleeve 310 protects the exterior surfaces of the end portions, 14 and 26, of the first and second tubular members, 10 and 28, during handling and insertion of the tubular members within the structure 32. In this manner, damage to the exterior surfaces of the end portions, 14 and 26, of the first and second tubular members, 10 and 28, is prevented that could result in stress concentrations that could result in a catastrophic failure during subsequent radial expansion operations. In addition, during the relative rotation of the second tubular member with respect to the first tubular member, required during the threaded coupling of the first and second tubular members, the tubular sleeve 310 provides an indication of to what degree the first and second tubular members are threadably coupled. For example, if the tubular sleeve 310 can be easily rotated, that would indicate that the first and second tubular members, 10 and 28, are not fully threadably coupled and in intimate contact with the internal flange 312 of the tubular sleeve. Furthermore, the tubular sleeve 310 may prevent crack propagation during the radial expansion and plastic deformation of the first and second tubular members, 10 and 28. In this manner, failure modes such as, for example, longitudinal cracks in the end portions, 14 and 26, of the first and second tubular members, 10 and 28, may be limited in severity or eliminated all together. In addition, after completing the radial expansion and plastic deformation of the first and second tubular members, 10 and 28, the tubular sleeve 310 may provide a fluid tight metal-to-metal seal between interior surface of the tubular sleeve and the exterior surfaces of the end portions, 14 and 26, of the first and second tubular members. In this manner, fluidic materials are prevented from passing through the threaded connections, 12 and 24, of the first and second tubular members, 10 and 28, into the annulus between the first and second tubular members and the structure 32. Furthermore, because, following the radial expansion and plastic deformation of the first and second tubular members, 10 and 28, the tubular sleeve 310 may be maintained in circumferential tension and the end portions, 14 and 26, of the first and second tubular members, 10 and 28, may be maintained in circumferential compression, axial loads and/or torque loads may be transmitted through the tubular sleeve. In addition, because, following the radial expansion and plastic deformation of the first and second tubular members, 10 and 28, the annular sealing member 318 may circumferentially engage the interior surface of the structure 32, the tubular sleeve 310 may provide an expandable packer element. In addition, the tubular sleeve 318 may also increase the collapse strength of the end portions, 14 and 26, of the first and second tubular members, 10 and 28.

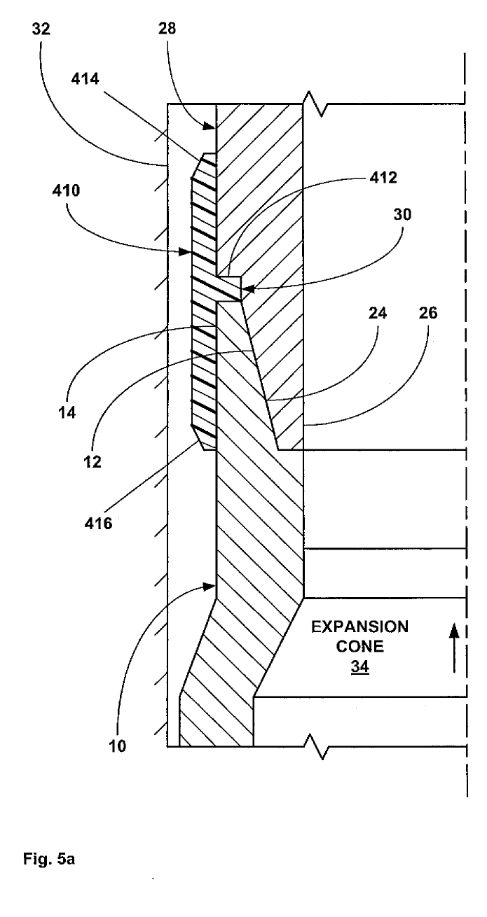

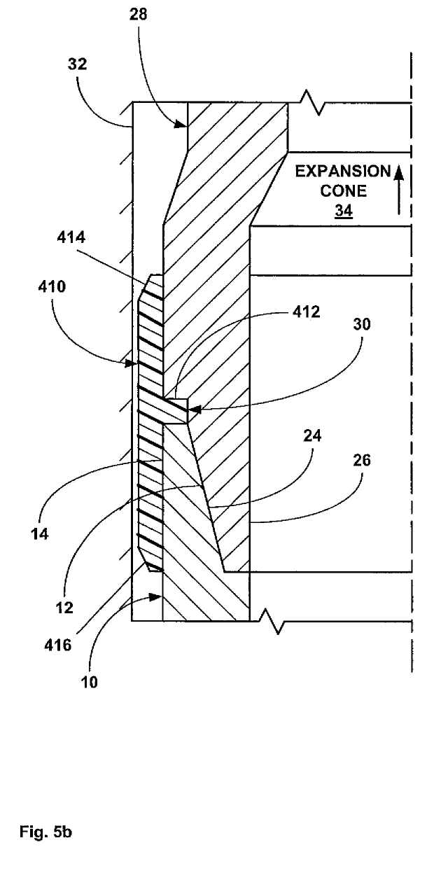

Referring to FIGS. 5a and 5b, in an alternative embodiment, a non-metallic tubular sleeve 410 having an internal flange 412, and tapered portions, 414 and 416, at opposite ends, is coupled to the first and second tubular members, 10 and 28. In particular, the tubular sleeve 410 receives and mates with the end portions, 14 and 26, of the first and second tubular members, 10 and 28, and the internal flange 412 of the tubular sleeve is received within the annular recess 30 of the second tubular member 28 proximate the end of the first tubular member. In this manner, the tubular sleeve 410 is coupled to the end portions, 14 and 26, of the first and second tubular members, 10 and 28, and the tubular sleeve covers the end portions, 14 and 26, of the first and second tubular members, 10 and 28.

In several exemplary embodiments, the tubular sleeve 410 may be plastic, ceramic, elastomeric, composite and/or a frangible material.

In an exemplary embodiment, the first and second tubular members, 10 and 28, and the tubular sleeve 410 may then be positioned within the structure 32 and radially expanded and plastically deformed, for example, by moving an expansion cone 34 through the interiors of the first and second tubular members. In an exemplary embodiment, following the radial expansion and plastic deformation of the first and second tubular members, 10 and 28, the tubular sleeve 410 may be maintained in circumferential tension and the end portions, 14 and 26, of the first and second tubular members, 10 and 28, may be maintained in circumferential compression. Furthermore, in an exemplary embodiment, during the radial expansion and plastic deformation of the first and second tubular members, 10 and 28, the tubular sleeve 310 may be broken off of the first and second tubular members.

The use of the tubular sleeve 410 during (a) the coupling of the first tubular member 10 to the second tubular member 28, (b) the placement of the first and second tubular members in the structure 32, and (c) the radial expansion and plastic deformation of the first and second tubular members provides a number of significant benefits. For example, the tubular sleeve 410 protects the exterior surfaces of the end portions, 14 and 26, of the first and second tubular members, 10 and 28, during handling and insertion of the tubular members within the structure 32. In this manner, damage to the exterior surfaces of the end portions, 14 and 26, of the first and second tubular members, 10 and 28, is prevented that could result in stress concentrations that could result in a catastrophic failure during subsequent radial expansion operations. In addition, during the relative rotation of the second tubular member with respect to the first tubular member, required during the threaded coupling of the first and second tubular members, the tubular sleeve 410 provides an indication of to what degree the first and second tubular members are threadably coupled. For example, if the tubular sleeve 410 can be easily rotated, that would indicate that the first and second tubular members, 10 and 28, are not fully threadably coupled and in intimate contact with the internal flange 412 of the tubular sleeve. Furthermore, the tubular sleeve 410 may prevent crack propagation during the radial expansion and plastic deformation of the first and second tubular members, 10 and 28. In this manner, failure modes such as, for example, longitudinal cracks in the end portions, 14 and 26, of the first and second tubular members, 10 and 28, may be limited in severity or eliminated all together. In addition, after completing the radial expansion and plastic deformation of the first and second tubular members, 10 and 28, the tubular sleeve 410 may provide a fluid tight metal-to-metal seal between interior surface of the tubular sleeve and the exterior surfaces of the end portions, 14 and 26, of the first and second tubular members. In this manner, fluidic materials are prevented from passing through the threaded connections, 12 and 24, of the first and second tubular members, 10 and 28, into the annulus between the first and second tubular members and the structure 32. Furthermore, because, following the radial expansion and plastic deformation of the first and second tubular members, 10 and 28, the tubular sleeve 410 may be maintained in circumferential tension and the end portions, 14 and 26, of the first and second tubular members, 10 and 28, may be maintained in circumferential compression, axial loads and/or torque loads may be transmitted through the tubular sleeve. In addition, because, during the radial expansion and plastic deformation of the first and second tubular members, 10 and 28, the tubular sleeve 410 may be broken off of the first and second tubular members, the final outside diameter of the first and second tubular members may more closely match the inside diameter of the structure 32. In addition, the tubular sleeve 410 may also increase the collapse strength of the end portions, 14 and 26, of the first and second tubular members, 10 and 28.

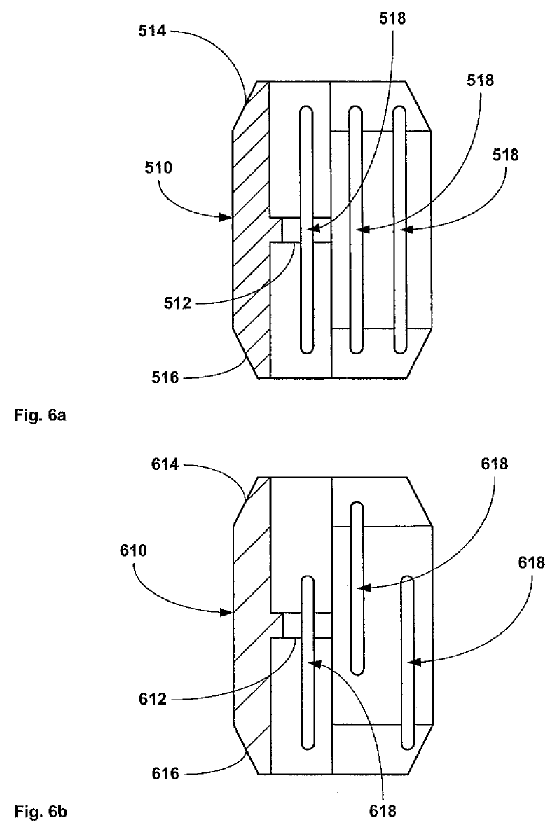

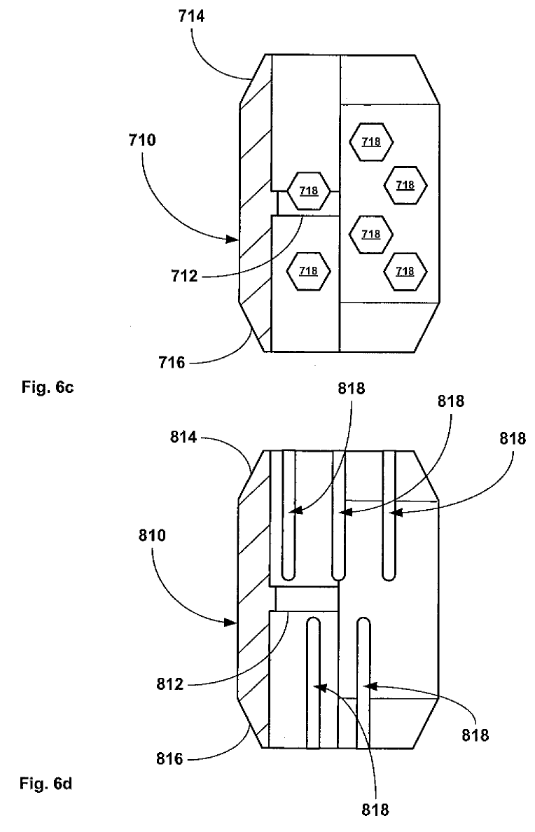

Referring to FIG. 6a, in an exemplary embodiment, a tubular sleeve 510 includes an internal flange 512, tapered portions, 514 and 516, at opposite ends, and defines one or more axial slots 518. In an exemplary embodiment, during the radial expansion and plastic deformation of the first and second tubular members, 10 and 28, the axial slots 518 reduce the required radial expansion forces.

Referring to FIG. 6b, in an exemplary embodiment, a tubular sleeve 610 includes an internal flange 612, tapered portions, 614 and 616, at opposite ends, and defines one or more offset axial slots 618. In an exemplary embodiment, during the radial expansion and plastic deformation of the first and second tubular members, 10 and 28, the axial slots 618 reduce the required radial expansion forces.

Referring to FIG. 6c, in an exemplary embodiment, a tubular sleeve 710 includes an internal flange 712, tapered portions, 714 and 716, at opposite ends, and defines one or more radial openings 718. In an exemplary embodiment, during the radial expansion and plastic deformation of the first and second tubular members, 10 and 28, the radial openings 718 reduce the required radial expansion forces.

Referring to FIG. 6d, in an exemplary embodiment, a tubular sleeve 810 includes an internal flange 812, tapered portions, 814 and 816, at opposite ends, and defines one or more axial slots 818 that extend from the ends of the tubular sleeve. In an exemplary embodiment, during the radial expansion and plastic deformation of the first and second tubular members, 10 and 28, the axial slots 818 reduce the required radial expansion forces.

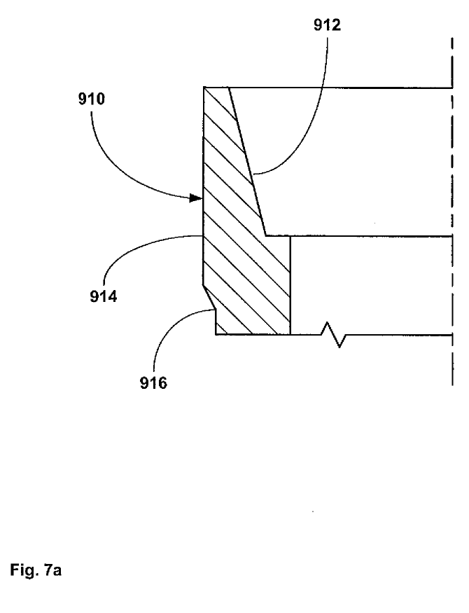

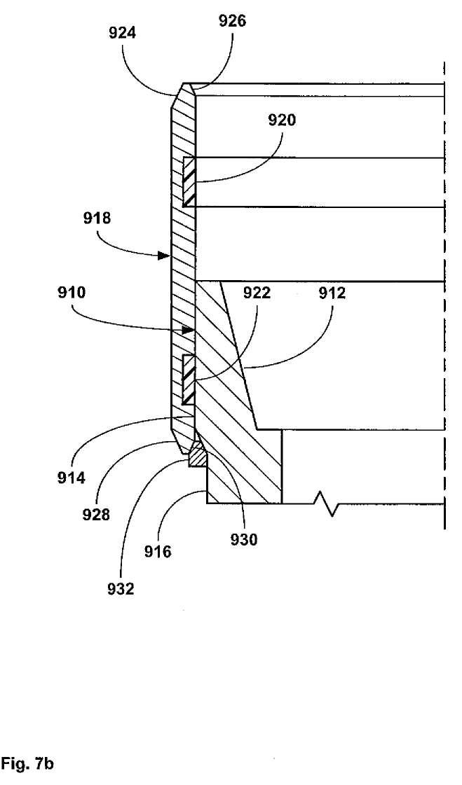

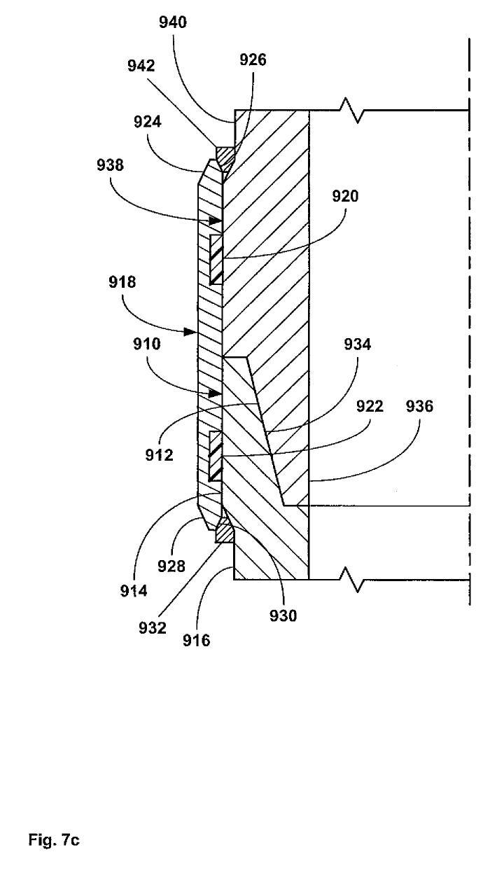

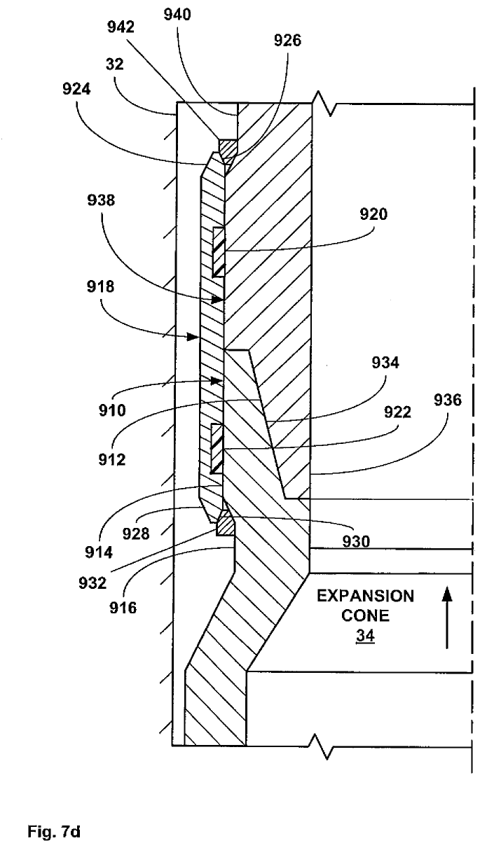

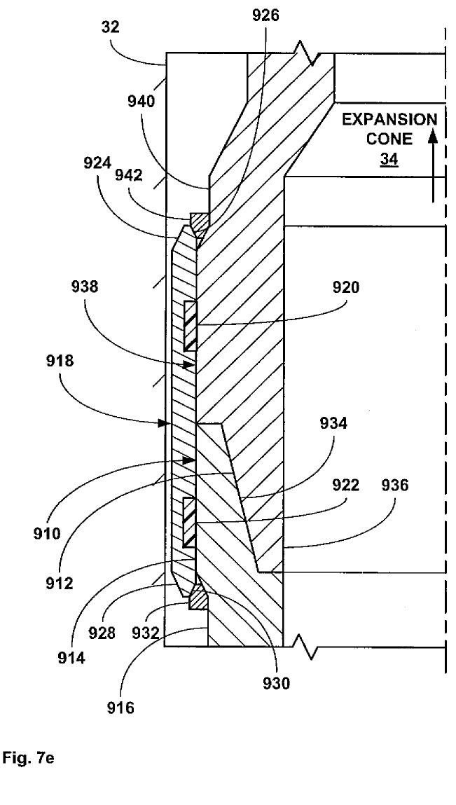

Referring to FIG. 7a, a first tubular member 910 includes an internally threaded connection 912 at an end portion 914 and a recessed portion 916 having a reduced outside diameter. As illustrated in FIG. 7b, a first end of a tubular sleeve 918 that includes annular sealing members, 920 and 922, at opposite ends, tapered portions, 924 and 926, at one end, and tapered portions, 928 and 930, at another end is then mounted upon and receives the end portion 914 of the first tubular member 910. In an exemplary embodiment, a resilient retaining ring 930 is positioned between the lower end of the tubular sleeve 918 and the recessed portion 916 of the first tubular member 910 in order to couple the tubular sleeve to the first tubular member. In an exemplary embodiment, the resilient retaining ring 930 is a split ring having a toothed surface in order to lock the tubular sleeve 918 in place.

As illustrated in FIG. 7c, an externally threaded connection 934 of an end portion 936 of a second tubular member 938 having a recessed portion 940 having a reduced outside diameter is then positioned within the tubular sleeve 918 and threadably coupled to the internally threaded connection 912 of the end portion 914 of the first tubular member 910. In an exemplary embodiment, a resilient retaining ring 942 is positioned between the upper end of the tubular sleeve 918 and the recessed portion 940 of the second tubular member 938 in order to couple the tubular sleeve to the second tubular member. In an exemplary embodiment, the resilient retaining ring 942 is a split ring having a toothed surface in order to lock the tubular sleeve 918 in place.

In an exemplary embodiment, the internally threaded connection 912 of the end portion 914 of the first tubular member 910 is a box connection, and the externally threaded connection 934 of the end portion 936 of the second tubular member 938 is a pin connection. In an exemplary embodiment, the internal diameter of the tubular sleeve 918 is at least approximately 0.020″ greater than the outside diameters of the end portions, 914 and 936, of the first and second tubular members, 910 and 938. In this manner, during the threaded coupling of the first and second tubular members, 910 and 938, fluidic materials within the first and second tubular members may be vented from the tubular members.

In an exemplary embodiment, as illustrated in FIGS. 7d and 7e, the first and second tubular members, 910 and 938, and the tubular sleeve 918 may then be positioned within another structure 32 such as, for example, a wellbore, and radially expanded and plastically deformed, for example, by moving an expansion cone 34 through the interiors of the first and second tubular members. The tapered portions, 924 and 928, of the tubular sleeve 918 facilitate the insertion and movement of the first and second tubular members within and through the structure 32, and the movement of the expansion cone 34 through the interiors of the first and second tubular members, 910 and 938, may be from top to bottom or from bottom to top.

In an exemplary embodiment, during the radial expansion and plastic deformation of the first and second tubular members, 910 and 938, the tubular sleeve 918 is also radially expanded and plastically deformed. In an exemplary embodiment, as a result, the tubular sleeve 918 may be maintained in circumferential tension and the end portions, 914 and 936, of the first and second tubular members, 910 and 938, may be maintained in circumferential compression.

The use of the tubular sleeve 918 during (a) the coupling of the first tubular member 910 to the second tubular member 938, (b) the placement of the first and second tubular members in the structure 32, and (c) the radial expansion and plastic deformation of the first and second tubular members provides a number of significant benefits. For example, the tubular sleeve 918 protects the exterior surfaces of the end portions, 914 and 936, of the first and second tubular members, 910 and 938, during handling and insertion of the tubular members within the structure 32. In this manner, damage to the exterior surfaces of the end portions, 914 and 936, of the first and second tubular member, 910 and 938, are prevented that could result in stress concentrations that could result in a catastrophic failure during subsequent radial expansion operations. Furthermore, the tubular sleeve 918 provides an alignment guide that facilitates the insertion and threaded coupling of the second tubular member 938 to the first tubular member 910. In this manner, misalignment that could result in damage to the threaded connections, 912 and 934, of the first and second tubular members, 910 and 938, may be avoided. Furthermore, the tubular sleeve 918 may prevent crack propagation during the radial expansion and plastic deformation of the first and second tubular members, 910 and 938. In this manner, failure modes such as, for example, longitudinal cracks in the end portions, 914 and 936, of the first and second tubular members may be limited in severity or eliminated all together. In addition, after completing the radial expansion and plastic deformation of the first and second tubular members, 910 and 938, the tubular sleeve 918 may provide a fluid tight metal-to-metal seal between interior surface of the tubular sleeve and the exterior surfaces of the end portions, 914 and 936, of the first and second tubular members. In this manner, fluidic materials are prevented from passing through the threaded connections, 912 and 934, of the first and second tubular members, 910 and 938, into the annulus between the first and second tubular members and the structure 32. Furthermore, because, following the radial expansion and plastic deformation of the first and second tubular members, 910 and 938, the tubular sleeve 918 may be maintained in circumferential tension and the end portions, 914 and 936, of the first and second tubular members, 910 and 938, may be maintained in circumferential compression, axial loads and/or torque loads may be transmitted through the tubular sleeve. In addition, the annular sealing members, 920 and 922, of the tubular sleeve 918 may provide a fluid tight seal between the tubular sleeve and the end portions, 914 and 936, of the first and second tubular members, 910 and 938. Furthermore, the tubular sleeve 918 may also increase the collapse strength of the end portions, 914 and 936, of the first and second tubular members, 910 and 938.

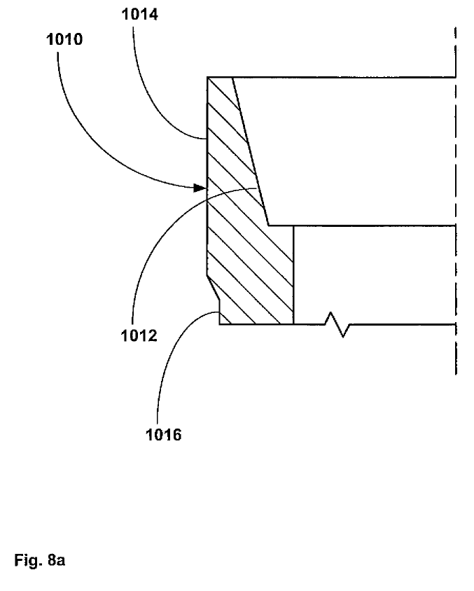

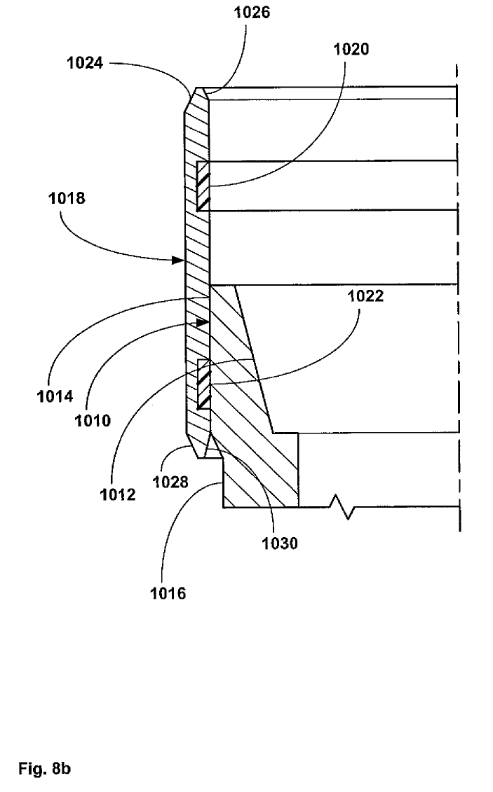

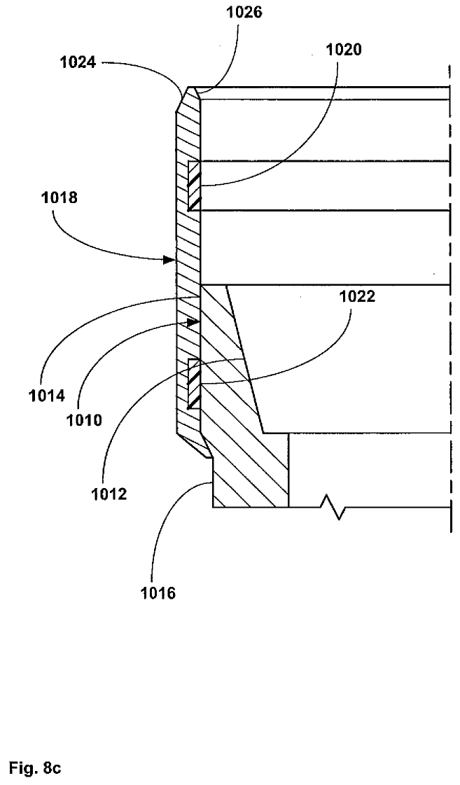

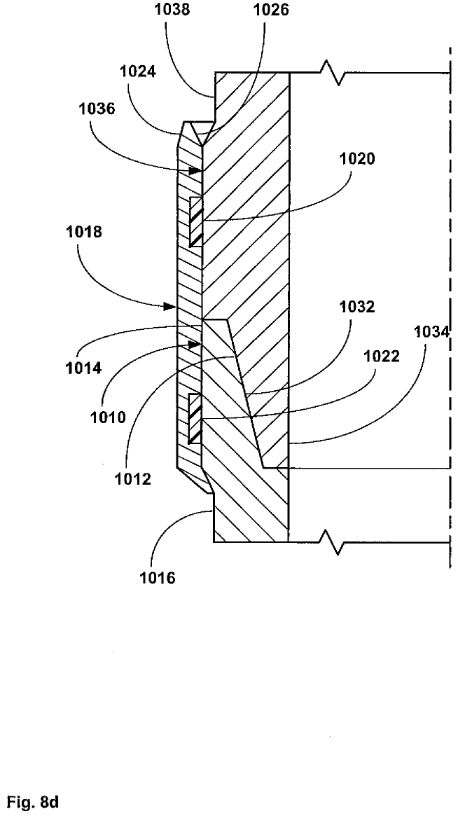

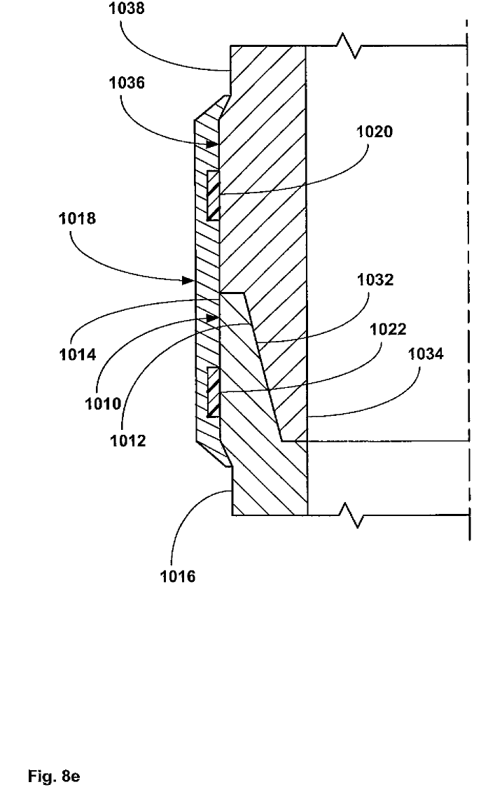

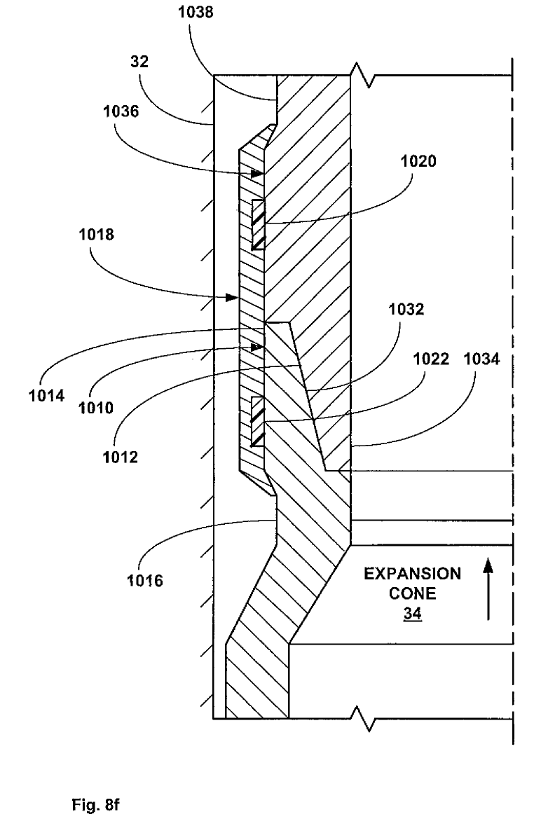

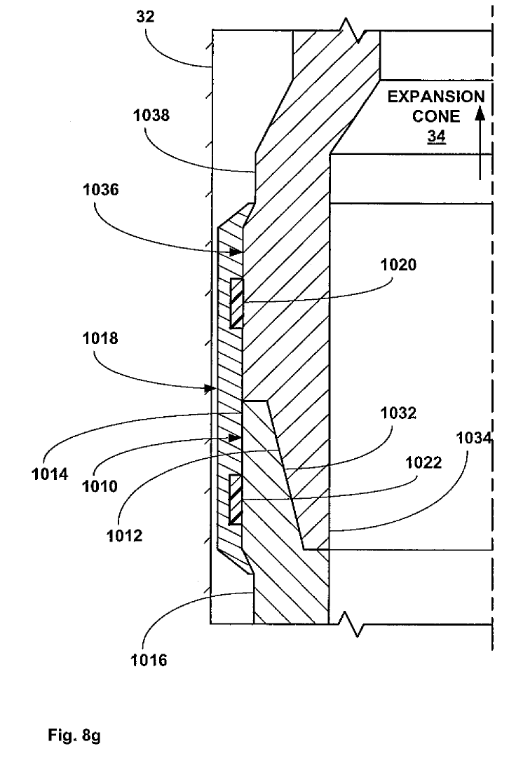

Referring to FIG. 8a, a first tubular member 1010 includes an internally threaded connection 1012 at an end portion 1014 and a recessed portion 1016 having a reduced outside diameter. As illustrated in FIG. 8b, a first end of a tubular sleeve 1018 that includes annular sealing members, 1020 and 1022, at opposite ends, tapered portions, 1024 and 1026, at one end, and tapered portions, 1028 and 1030, at another end is then mounted upon and receives the end portion 1014 of the first tubular member 1010. In an exemplary embodiment, as illustrated in FIG. 8c, the end of the tubular sleeve 1018 is then crimped onto the recessed portion 1016 of the first tubular member 1010 in order to couple the tubular sleeve to the first tubular member.

As illustrated in FIG. 8d, an externally threaded connection 1032 of an end portion 1034 of a second tubular member 1036 having a recessed portion 1038 having a reduced external diameter is then positioned within the tubular sleeve 1018 and threadably coupled to the internally threaded connection 1012 of the end portion 1014 of the first tubular member 1010. In an exemplary embodiment, as illustrated in FIG. 8e, the other end of the tubular sleeve 1018 is then crimped into the recessed portion 1038 of the second tubular member 1036 in order to couple the tubular sleeve to the second tubular member.

In an exemplary embodiment, the internally threaded connection 1012 of the end portion 1014 of the first tubular member 1010 is a box connection, and the externally threaded connection 1032 of the end portion 1034 of the second tubular member 1036 is a pin connection. In an exemplary embodiment, the internal diameter of the tubular sleeve 1018 is at least approximately 0.020″ greater than the outside diameters of the end portions, 1014 and 1034, of the first and second tubular members, 1010 and 1036. In this manner, during the threaded coupling of the first and second tubular members, 1010 and 1036, fluidic materials within the first and second tubular members may be vented from the tubular members.

In an exemplary embodiment, as illustrated in FIGS. 8f and 8g, the first and second tubular members, 1010 and 1036, and the tubular sleeve 1018 may then be positioned within another structure 32 such as, for example, a wellbore, and radially expanded and plastically deformed, for example, by moving an expansion cone 34 through the interiors of the first and second tubular members. The movement of the expansion cone 34 through the interiors of the first and second tubular members, 1010 and 1036, may be from top to bottom or from bottom to top.

In an exemplary embodiment, during the radial expansion and plastic deformation of the first and second tubular members, 1010 and 1036, the tubular sleeve 1018 is also radially expanded and plastically deformed. In an exemplary embodiment, as a result, the tubular sleeve 1018 may be maintained in circumferential tension and the end portions, 1014 and 1034, of the first and second tubular members, 1010 and 1036, may be maintained in circumferential compression.

The use of the tubular sleeve 1018 during (a) the coupling of the first tubular member 1010 to the second tubular member 1036, (b) the placement of the first and second tubular members in the structure 32, and (c) the radial expansion and plastic deformation of the first and second tubular members provides a number of significant benefits. For example, the tubular sleeve 1018 protects the exterior surfaces of the end portions, 1014 and 1034, of the first and second tubular members, 1010 and 1036, during handling and insertion of the tubular members within the structure 32. In this manner, damage to the exterior surfaces of the end portions, 1014 and 1034, of the first and second tubular members, 1010 and 1036, are prevented that could result in stress concentrations that could result in a catastrophic failure during subsequent radial expansion operations. Furthermore, the tubular sleeve 1018 provides an alignment guide that facilitates the insertion and threaded coupling of the second tubular member 1036 to the first tubular member 1010. In this manner, misalignment that could result in damage to the threaded connections, 1012 and 1032, of the first and second tubular members, 1010 and 1036, may be avoided. Furthermore, the tubular sleeve 1018 may prevent crack propagation during the radial expansion and plastic deformation of the first and second tubular members, 1010 and 1036. In this manner, failure modes such as, for example, longitudinal cracks in the end portions, 1014 and 1034, of the first and second tubular members may be limited in severity or eliminated all together. In addition, after completing the radial expansion and plastic deformation of the first and second tubular members, 1010 and 1036, the tubular sleeve 1018 may provide a fluid tight metal-to-metal seal between interior surface of the tubular sleeve and the exterior surfaces of the end portions, 1014 and 1034, of the first and second tubular members. In this manner, fluidic materials are prevented from passing through the threaded connections, 1012 and 1032, of the first and second tubular members, 1010 and 1036, into the annulus between the first and second tubular members and the structure 32. Furthermore, because, following the radial expansion and plastic deformation of the first and second tubular members, 1010 and 1036, the tubular sleeve 1018 may be maintained in circumferential tension and the end portions, 1014 and 1034, of the first and second tubular members, 1010 and 1036, may be maintained in circumferential compression, axial loads and/or torque loads may be transmitted through the tubular sleeve. In addition, the annular sealing members, 1020 and 1022, of the tubular sleeve 1018 may provide a fluid tight seal between the tubular sleeve and the end portions, 1014 and 1034, of the first and second tubular members, 1010 and 1036. Furthermore, the tubular sleeve 1018 may also increase the collapse strength of the end portions, 1014 and 1034, of the first and second tubular members, 1010 and 1036.

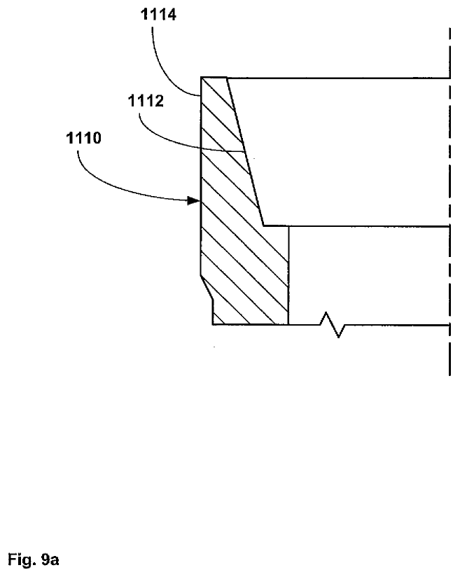

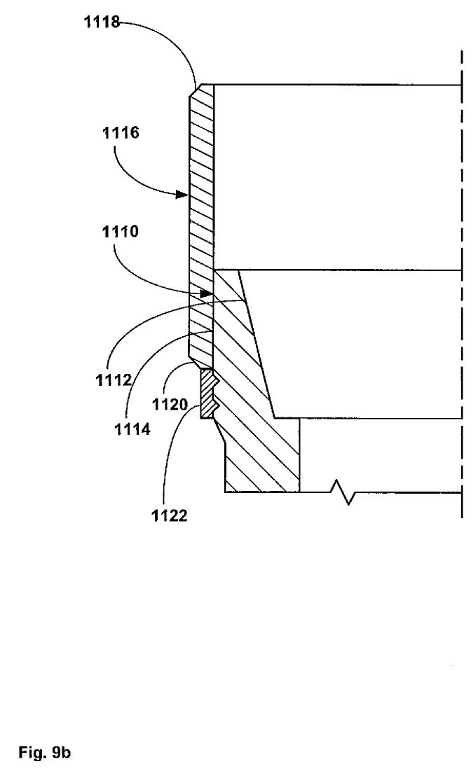

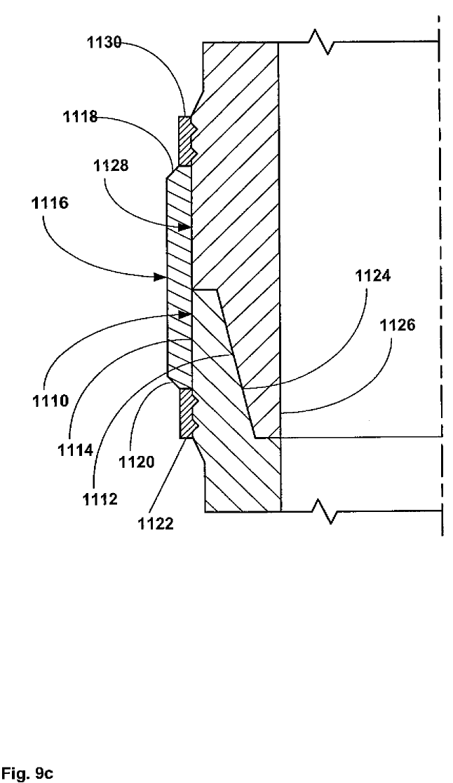

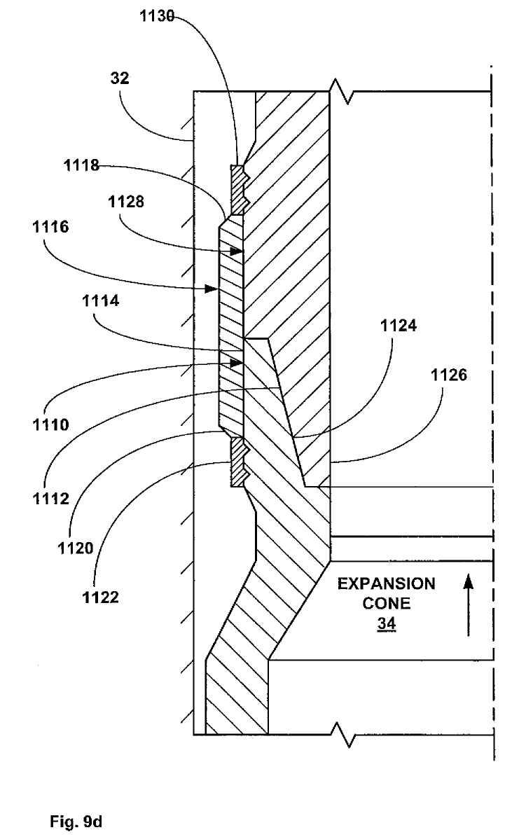

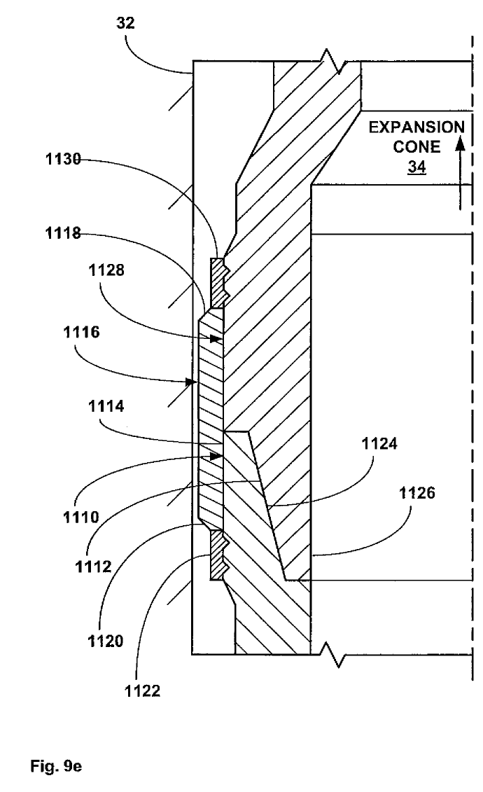

Referring to FIG. 9a, a first tubular member 1110 includes an internally threaded connection 1112 at an end portion 1114. As illustrated in FIG. 9b, a first end of a tubular sleeve 1116 having tapered portions, 1118 and 1120, at opposite ends, is then mounted upon and receives the end portion 1114 of the first tubular member 1110. In an exemplary embodiment, a toothed resilient retaining ring 1122 is then attached to first tubular member 1010 below the end of the tubular sleeve 1116 in order to couple the tubular sleeve to the first tubular member.

As illustrated in FIG. 9c, an externally threaded connection 1124 of an end portion 1126 of a second tubular member 1128 is then positioned within the tubular sleeve 1116 and threadably coupled to the internally threaded connection 1112 of the end portion 1114 of the first tubular member 1110. In an exemplary embodiment, a toothed resilient retaining ring 1130 is then attached to second tubular member 1128 above the end of the tubular sleeve 1116 in order to couple the tubular sleeve to the second tubular member.

In an exemplary embodiment, the internally threaded connection 1112 of the end portion 1114 of the first tubular member 1110 is a box connection, and the externally threaded connection 1124 of the end portion 1126 of the second tubular member 1128 is a pin connection. In an exemplary embodiment, the internal diameter of the tubular sleeve 1116 is at least approximately 0.020″ greater than the outside diameters of the end portions, 1114 and 1126, of the first and second tubular members, 1110 and 1128. In this manner, during the threaded coupling of the first and second tubular members, 1110 and 1128, fluidic materials within the first and second tubular members may be vented from the tubular members.

In an exemplary embodiment, as illustrated in FIGS. 9d and 9e, the first and second tubular members, 1110 and 1128, and the tubular sleeve 1116 may then be positioned within another structure 32 such as, for example, a wellbore, and radially expanded and plastically deformed, for example, by moving an expansion cone 34 through the interiors of the first and second tubular members. The movement of the expansion cone 34 through the interiors of the first and second tubular members, 1110 and 1128, may be from top to bottom or from bottom to top.

In an exemplary embodiment, during the radial expansion and plastic deformation of the first and second tubular members, 1110 and 1128, the tubular sleeve 1116 is also radially expanded and plastically deformed. In an exemplary embodiment, as a result, the tubular sleeve 1116 may be maintained in circumferential tension and the end portions, 1114 and 1126, of the first and second tubular members, 1110 and 1128, may be maintained in circumferential compression.

The use of the tubular sleeve 1116 during (a) the coupling of the first tubular member 1110 to the second tubular member 1128, (b) the placement of the first and second tubular members in the structure 32, and (c) the radial expansion and plastic deformation of the first and second tubular members provides a number of significant benefits. For example, the tubular sleeve 1116 protects the exterior surfaces of the end portions, 1114 and 1126, of the first and second tubular members, 1110 and 1128, during handling and insertion of the tubular members within the structure 32. In this manner, damage to the exterior surfaces of the end portions, 1114 and 1126, of the first and second tubular members, 1110 and 1128, are prevented that could result in stress concentrations that could result in a catastrophic failure during subsequent radial expansion operations. Furthermore, the tubular sleeve 1116 provides an alignment guide that facilitates the insertion and threaded coupling of the second tubular member 1128 to the first tubular member 1110. In this manner, misalignment that could result in damage to the threaded connections, 1112 and 1124, of the first and second tubular members, 1110 and 1128, may be avoided. Furthermore, the tubular sleeve 1116 may prevent crack propagation during the radial expansion and plastic deformation of the first and second tubular members, 1110 and 1128. In this manner, failure modes such as, for example, longitudinal cracks in the end portions, 1114 and 1126, of the first and second tubular members may be limited in severity or eliminated all together. In addition, after completing the radial expansion and plastic deformation of the first and second tubular members, 1110 and 1128, the tubular sleeve 1116 may provide a fluid tight metal-to-metal seal between interior surface of the tubular sleeve and the exterior surfaces of the end portions, 1114 and 1128, of the first and second tubular members. In this manner, fluidic materials are prevented from passing through the threaded connections, 1112 and 1124, of the first and second tubular members, 1110 and 1128, into the annulus between the first and second tubular members and the structure 32. Furthermore, because, following the radial expansion and plastic deformation of the first and second tubular members, 1110 and 1128, the tubular sleeve 1116 may be maintained in circumferential tension and the end portions, 1114 and 1126, of the first and second tubular members, 1110 and 1128, may be maintained in circumferential compression, axial loads and/or torque loads may be transmitted through the tubular sleeve. In addition, the tubular sleeve 1116 may also increase the collapse strength of the end portions, 1114 and 1126, of the first and second tubular members.

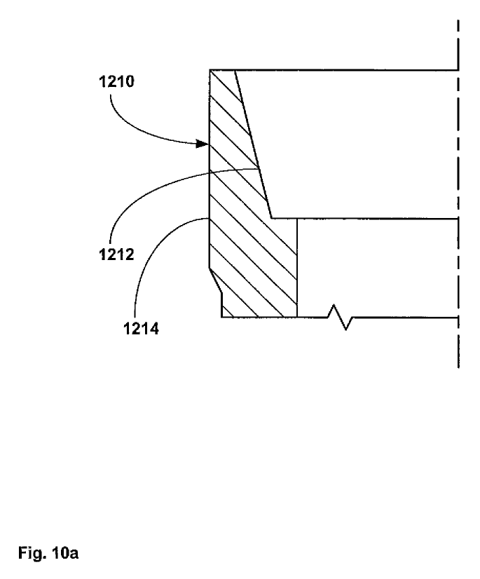

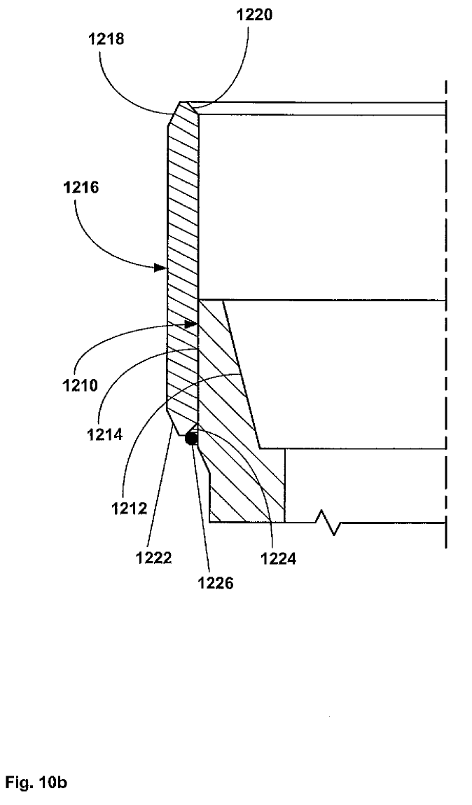

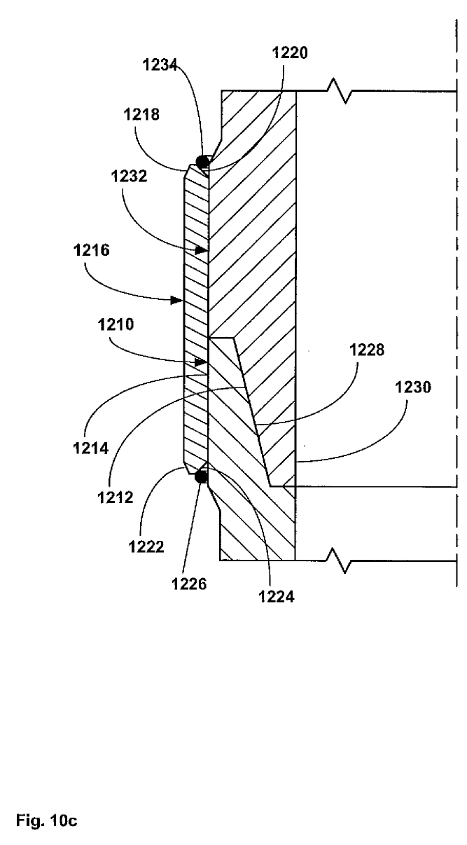

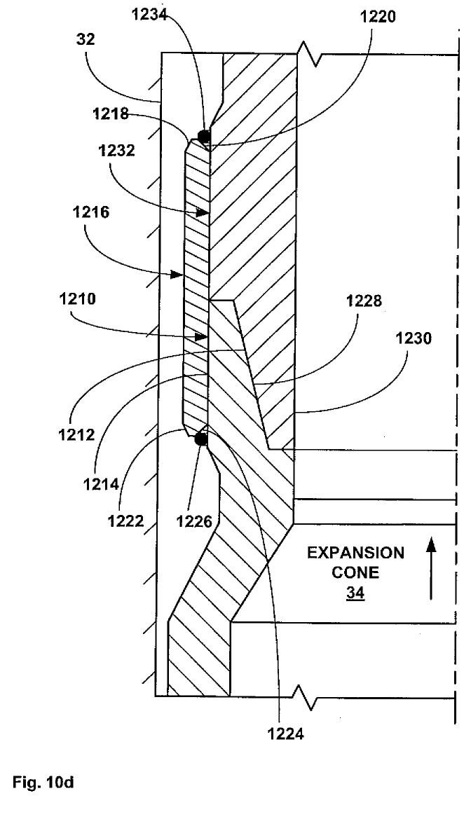

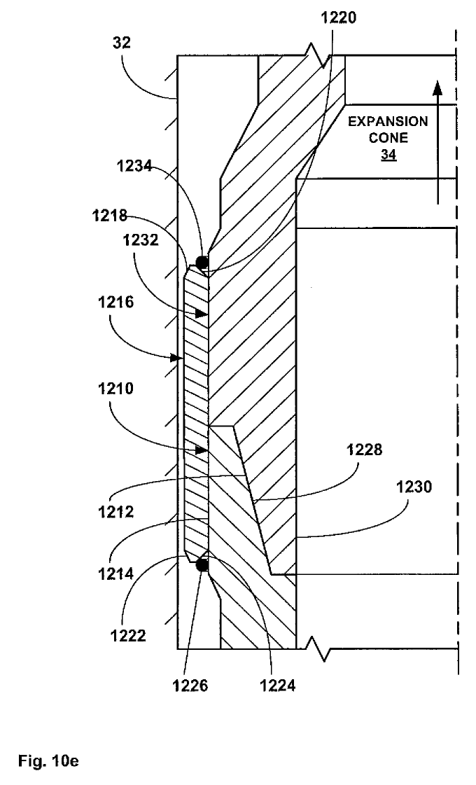

Referring to FIG. 10a, a first tubular member 1210 includes an internally threaded connection 1212 at an end portion 1214. As illustrated in FIG. 10b, a first end of a tubular sleeve 1216 having tapered portions, 1218 and 1220, at one end and tapered portions, 1222 and 1224, at another end, is then mounted upon and receives the end portion 1114 of the first tubular member 1110. In an exemplary embodiment, a resilient elastomeric O-ring 1226 is then positioned on the first tubular member 1210 below the tapered portion 1224 of the tubular sleeve 1216 in order to couple the tubular sleeve to the first tubular member.

As illustrated in FIG. 10c, an externally threaded connection 1228 of an end portion 1230 of a second tubular member 1232 is then positioned within the tubular sleeve 1216 and threadably coupled to the internally threaded connection 1212 of the end portion 1214 of the first tubular member 1210. In an exemplary embodiment, a resilient elastomeric O-ring 1234 is then positioned on the second tubular member 1232 below the tapered portion 1220 of the tubular sleeve 1216 in order to couple the tubular sleeve to the first tubular member.

In an exemplary embodiment, the internally threaded connection 1212 of the end portion 1214 of the first tubular member 1210 is a box connection, and the externally threaded connection 1228 of the end portion 1230 of the second tubular member 1232 is a pin connection. In an exemplary embodiment, the internal diameter of the tubular sleeve 1216 is at least approximately 0.020″ greater than the outside diameters of the end portions, 1214 and 1230, of the first and second tubular members, 1210 and 1232. In this manner, during the threaded coupling of the first and second tubular members, 1210 and 1232, fluidic materials within the first and second tubular members may be vented from the tubular members.

In an exemplary embodiment, as illustrated in FIGS. 10d and 10e, the first and second tubular members, 1210 and 1232, and the tubular sleeve 1216 may then be positioned within another structure 32 such as, for example, a wellbore, and radially expanded and plastically deformed, for example, by moving an expansion cone 34 through the interiors of the first and second tubular members. The movement of the expansion cone 34 through the interiors of the first and second tubular members, 1210 and 1232, may be from top to bottom or from bottom to top.

In an exemplary embodiment, during the radial expansion and plastic deformation of the first and second tubular members, 1210 and 1232, the tubular sleeve 1216 is also radially expanded and plastically deformed. In an exemplary embodiment, as a result, the tubular sleeve 1216 may be maintained in circumferential tension and the end portions, 1214 and 1230, of the first and second tubular members, 1210 and 1232, may be maintained in circumferential compression.

The use of the tubular sleeve 1216 during (a) the coupling of the first tubular member 1210 to the second tubular member 1232, (b) the placement of the first and second tubular members in the structure 32, and (c) the radial expansion and plastic deformation of the first and second tubular members provides a number of significant benefits. For example, the tubular sleeve 1216 protects the exterior surfaces of the end portions, 1214 and 1230, of the first and second tubular members, 1210 and 1232, during handling and insertion of the tubular members within the structure 32. In this manner, damage to the exterior surfaces of the end portions, 1214 and 1230, of the first and second tubular members, 1210 and 1232, are prevented that could result in stress concentrations that could result in a catastrophic failure during subsequent radial expansion operations. Furthermore, the tubular sleeve 1216 provides an alignment guide that facilitates the insertion and threaded coupling of the second tubular member 1232 to the first tubular member 1210. In this manner, misalignment that could result in damage to the threaded connections, 1212 and 1228, of the first and second tubular members, 1210 and 1232, may be avoided. Furthermore, the tubular sleeve 1216 may prevent crack propagation during the radial expansion and plastic deformation of the first and second tubular members, 1210 and 1232. In this manner, failure modes such as, for example, longitudinal cracks in the end portions, 1214 and 1230, of the first and second tubular members may be limited in severity or eliminated all together. In addition, after completing the radial expansion and plastic deformation of the first and second tubular members, 1210 and 1232, the tubular sleeve 1216 may provide a fluid tight metal-to-metal seal between interior surface of the tubular sleeve and the exterior surfaces of the end portions, 1214 and 1230, of the first and second tubular members. In this manner, fluidic materials are prevented from passing through the threaded connections, 1212 and 1228, of the first and second tubular members, 1210 and 1232, into the annulus between the first and second tubular members and the structure 32. Furthermore, because, following the radial expansion and plastic deformation of the first and second tubular members, 1210 and 1232, the tubular sleeve 1216 may be maintained in circumferential tension and the end portions, 1214 and 1230, of the first and second tubular members, 1210 and 1232, may be maintained in circumferential compression, axial loads and/or torque loads may be transmitted through the tubular sleeve. In addition, the tubular sleeve 1216 may also increase the collapse strength of the end portions, 1214 and 1230, of the first and second tubular members 1210 and 1232.

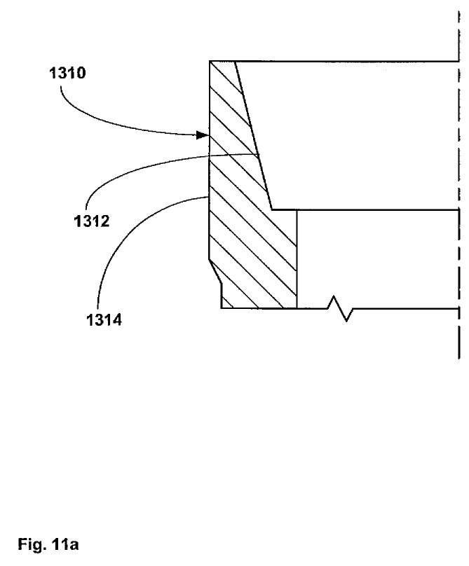

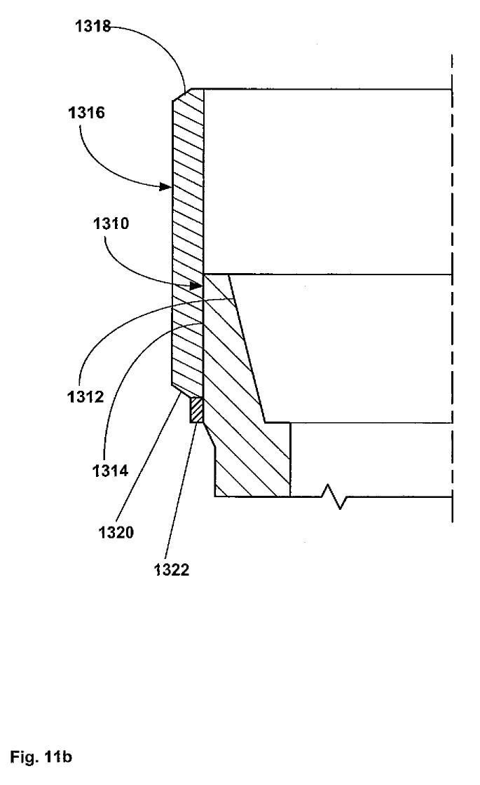

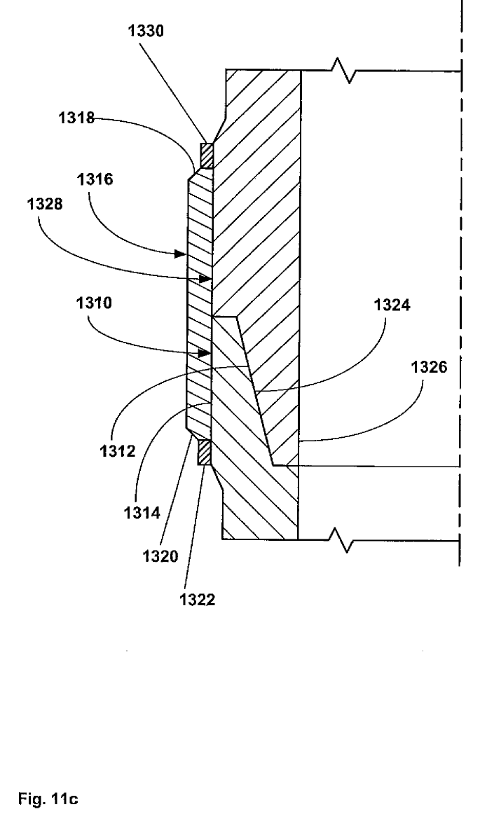

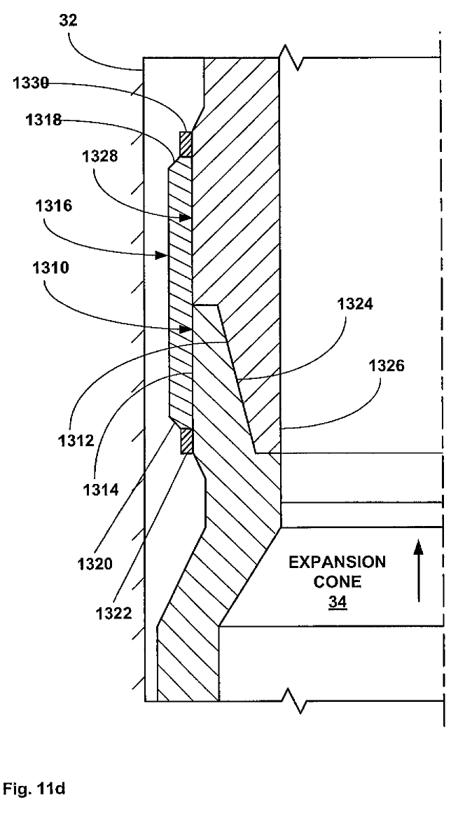

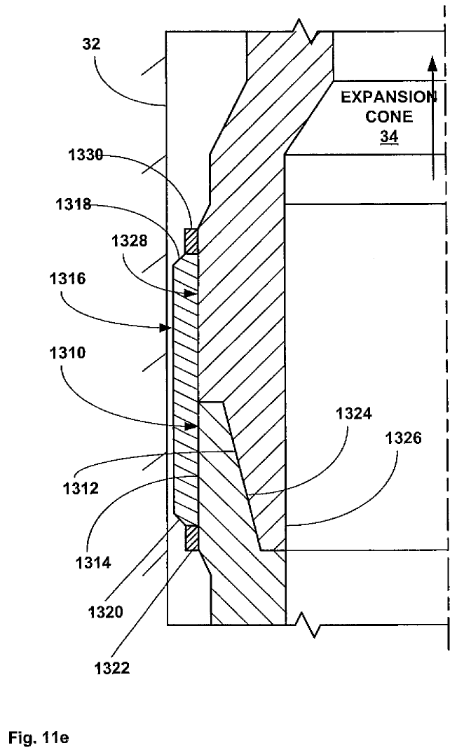

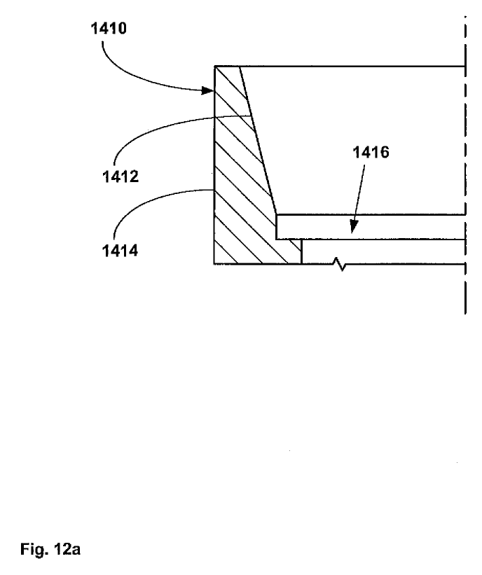

Referring to FIG. 11a, a first tubular member 1310 includes an internally threaded connection 1312 at an end portion 1314. As illustrated in FIG. 11b, a first end of a tubular sleeve 1316 having tapered portions, 1318 and 1320, at opposite ends is then mounted upon and receives the end portion 1314 of the first tubular member 1310. In an exemplary embodiment an annular resilient retaining member 1322 is then positioned on the first tubular member 1310 below the bottom end of the tubular sleeve 1316 in order to couple the tubular sleeve to the first tubular member.

As illustrated in FIG. 11c, an externally threaded connection 1324 of an end portion 1326 of a second tubular member 1328 is then positioned within the tubular sleeve 1316 and threadably coupled to the internally threaded connection 1312 of the end portion 1314 of the first tubular member 1310. In an exemplary embodiment, an annular resilient retaining member 1330 is then positioned on the second tubular member 1328 above the top end of the tubular sleeve 1316 in order to couple the tubular sleeve to the second tubular member.

In an exemplary embodiment, the internally threaded connection 1312 of the end portion 1314 of the first tubular member 1310 is a box connection, and the externally threaded connection 1324 of the end portion 1326 of the second tubular member 1328 is a pin connection. In an exemplary embodiment, the internal diameter of the tubular sleeve 1316 is at least approximately 0.020″ greater than the outside diameters of the end portions, 1314 and 1326, of the first and second tubular members, 1310 and 1328. In this manner, during the threaded coupling of the first and second tubular members, 1310 and 1328, fluidic materials within the first and second tubular members may be vented from the tubular members.

In an exemplary embodiment, as illustrated in FIGS. 11d and 11e, the first and second tubular members, 1310 and 1328, and the tubular sleeve 1316 may then be positioned within another structure 32 such as, for example, a wellbore, and radially expanded and plastically deformed, for example, by moving an expansion cone 34 through the interiors of the first and second tubular members. The movement of the expansion cone 34 through the interiors of the first and second tubular members, 1310 and 1328, may be from top to bottom or from bottom to top.

In an exemplary embodiment, during the radial expansion and plastic deformation of the first and second tubular members, 1310 and 1328, the tubular sleeve 1316 is also radially expanded and plastically deformed. In an exemplary embodiment, as a result, the tubular sleeve 1316 may be maintained in circumferential tension and the end portions, 1314 and 1326, of the first and second tubular members, 1310 and 1328, may be maintained in circumferential compression.

The use of the tubular sleeve 1316 during (a) the coupling of the first tubular member 1310 to the second tubular member 1328, (b) the placement of the first and second tubular members in the structure 32, and (c) the radial expansion and plastic deformation of the first and second tubular members provides a number of significant benefits. For example, the tubular sleeve 1316 protects the exterior surfaces of the end portions, 1314 and 1326, of the first and second tubular members, 1310 and 1328, during handling and insertion of the tubular members within the structure 32. In this manner, damage to the exterior surfaces of the end portions, 1314 and 1326, of the first and second tubular members, 1310 and 1328, are prevented that could result in stress concentrations that could result in a catastrophic failure during subsequent radial expansion operations. Furthermore, the tubular sleeve 1316 provides an alignment guide that facilitates the insertion and threaded coupling of the second tubular member 1328 to the first tubular member 1310. In this manner, misalignment that could result in damage to the threaded connections, 1312 and 1324, of the first and second tubular members, 1310 and 1328, may be avoided. Furthermore, the tubular sleeve 1316 may prevent crack propagation during the radial expansion and plastic deformation of the first and second tubular members, 1310 and 1328. In this manner, failure modes such as, for example, longitudinal cracks in the end portions, 1314 and 1326, of the first and second tubular members may be limited in severity or eliminated all together. In addition, after completing the radial expansion and plastic deformation of the first and second tubular members, 1310 and 1328, the tubular sleeve 1316 may provide a fluid tight metal-to-metal seal between interior surface of the tubular sleeve and the exterior surfaces of the end portions, 1314 and 1326, of the first and second tubular members. In this manner, fluidic materials are prevented from passing through the threaded connections, 1312 and 1324, of the first and second tubular members, 1310 and 1328, into the annulus between the first and second tubular members and the structure 32. Furthermore, because, following the radial expansion and plastic deformation of the first and second tubular members, 1310 and 1328, the tubular sleeve 1316 may be maintained in circumferential tension and the end portions, 1314 and 1326, of the first and second tubular members, 1310 and 1328, may be maintained in circumferential compression, axial loads and/or torque loads may be transmitted through the tubular sleeve. In addition, the tubular sleeve 1316 may also increase the collapse strength of the end portions, 1314 and 1326, of the first and second tubular members, 1310 and 1328.

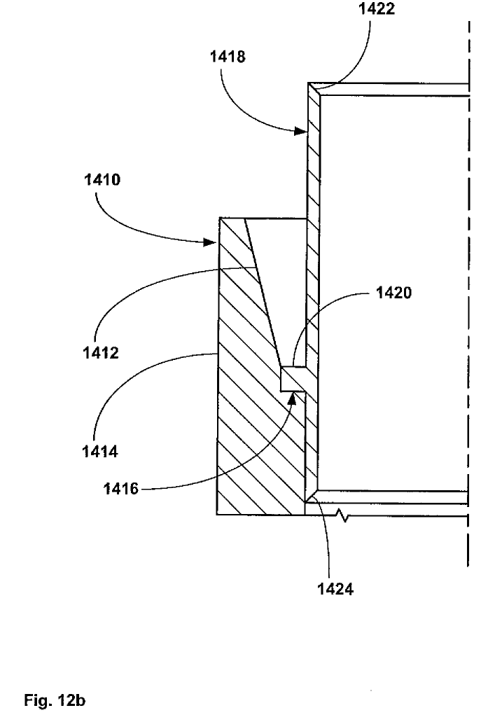

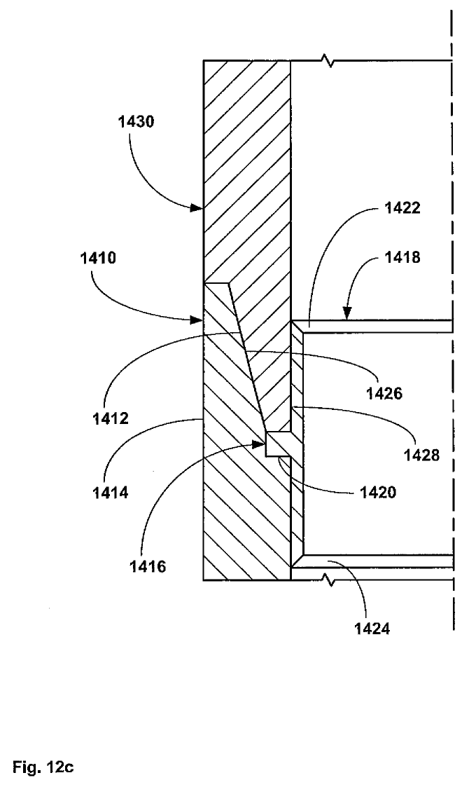

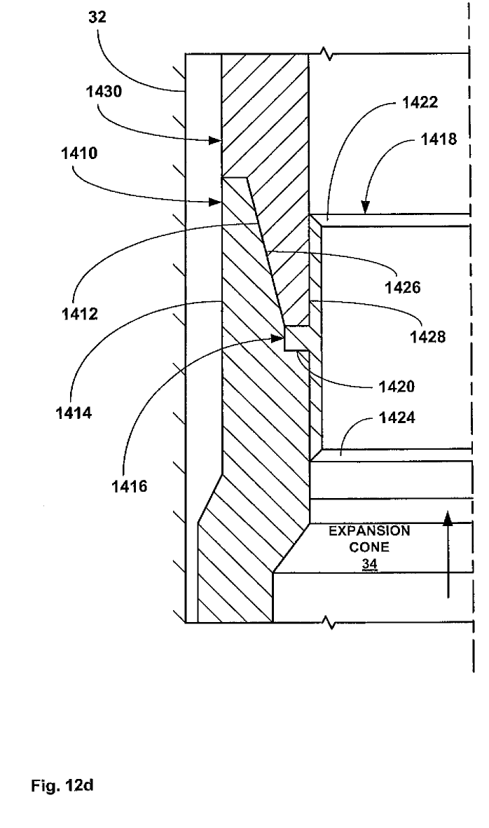

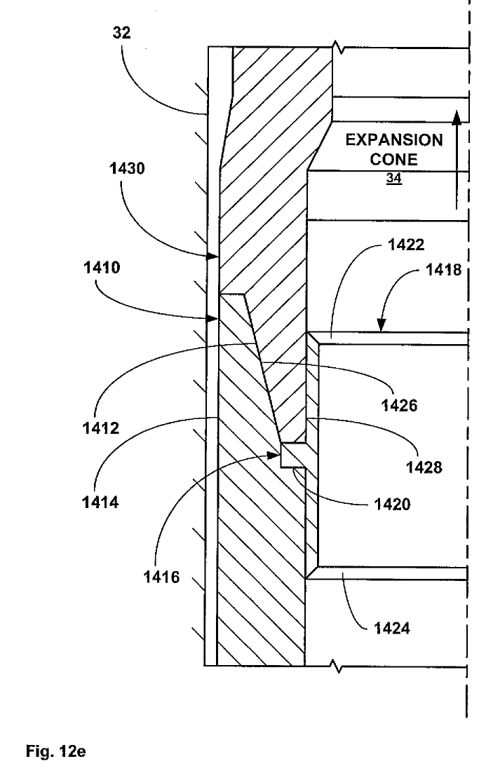

Referring to FIG. 12a, a first tubular member 1410 includes an internally threaded connection 1412 and an annular recess 1414 at an end portion 1416. As illustrated in FIG. 12b, a first end of a tubular sleeve 1418 that includes an external flange 1420 and tapered portions, 1422 and 1424, at opposite ends is then mounted within the end portion 1416 of the first tubular member 1410. In an exemplary embodiment, the external flange 1420 of the tubular sleeve 1418 is received within and is supported by the annular recess 1414 of the end portion 1416 of the first tubular member 1410. As illustrated in FIG. 12c, an externally threaded connection 1426 of an end portion 1428 of a second tubular member 1430 is then positioned around a second end of the tubular sleeve 1418 and threadably coupled to the internally threaded connection 1412 of the end portion 1414 of the first tubular member 1410. In an exemplary embodiment, the external flange 1420 of the tubular sleeve 1418 mates with and is received within the annular recess 1416 of the end portion 1414 of the first tubular member 1410, and the external flange of the tubular sleeve is retained in the annular recess by the end portion 1428 of the second tubular member 1430. Thus, the tubular sleeve 1416 is coupled to and is surrounded by the internal surfaces of the first and second tubular members, 1410 and 1430.

In an exemplary embodiment, the internally threaded connection 1412 of the end portion 1414 of the first tubular member 1410 is a box connection, and the externally threaded connection 1426 of the end portion 1428 of the second tubular member 1430 is a pin connection. In an exemplary embodiment, the external diameter of the tubular sleeve 1418 is at least approximately 0.020″ less than the inside diameters of the first and second tubular members, 1410 and 1430. In this manner, during the threaded coupling of the first and second tubular members, 1410 and 1430, fluidic materials within the first and second tubular members may be vented from the tubular members.

In an exemplary embodiment, as illustrated in FIGS. 12d and 12e, the first and second tubular members, 1410 and 1430, and the tubular sleeve 1418 may then be positioned within another structure 32 such as, for example, a wellbore, and radially expanded and plastically deformed, for example, by moving an expansion cone 34 through the interiors of the first and second tubular members. The tapered portions, 1422 and 1424, of the tubular sleeve 1418 facilitate the movement of the expansion cone 34 through the first and second tubular members, 1410 and 1430, and the movement of the expansion cone 34 through the interiors of the first and second tubular members, 1410 and 1430, may be from top to bottom or from bottom to top.

In an exemplary embodiment, during the radial expansion and plastic deformation of the first and second tubular members, 1410 and 1430, the tubular sleeve 1418 is also radially expanded and plastically deformed. In an exemplary embodiment, as a result, the tubular sleeve 1418 may be maintained in circumferential compression and the end portions, 1414 and 1428, of the first and second tubular members, 1410 and 1430, may be maintained in circumferential tension.

In several alternative embodiments, the first and second tubular members, 1410 and 1430, are radially expanded and plastically deformed using other conventional methods for radially expanding and plastically deforming tubular members such as, for example, internal pressurization and/or roller expansion devices.

The use of the tubular sleeve 1418 during (a) the coupling of the first tubular member 1410 to the second tubular member 1430, (b) the placement of the first and second tubular members in the structure 32, and (c) the radial expansion and plastic deformation of the first and second tubular members provides a number of significant benefits. For example, the tubular sleeve 1418 provides an alignment guide that facilitates the insertion and threaded coupling of the second tubular member 1430 to the first tubular member 1410. In this manner, misalignment that could result in damage to the threaded connections, 1412 and 1426, of the first and second tubular members, 1410 and 1430, may be avoided. In addition, during the relative rotation of the second tubular member with respect to the first tubular member, required during the threaded coupling of the first and second tubular members, the tubular sleeve 1418 provides an indication of to what degree the first and second tubular members are threadably coupled. For example, if the tubular sleeve 1418 can be easily rotated, that would indicate that the first and second tubular members, 1410 and 1430, are not fully threadably coupled and in intimate contact with the internal flange 1420 of the tubular sleeve. Furthermore, the tubular sleeve 1418 may prevent crack propagation during the radial expansion and plastic deformation of the first and second tubular members, 1410 and 1430. In this manner, failure modes such as, for example, longitudinal cracks in the end portions, 1414 and 1428, of the first and second tubular members may be limited in severity or eliminated all together. In addition, after completing the radial expansion and plastic deformation of the first and second tubular members, 1410 and 1430, the tubular sleeve 1418 may provide a fluid tight metal-to-metal seal between the exterior surface of the tubular sleeve and the interior surfaces of the end portions, 1414 and 1428, of the first and second tubular members. In this manner, fluidic materials are prevented from passing through the threaded connections, 1412 and 1426, of the first and second tubular members, 1410 and 1430, into the annulus between the first and second tubular members and the structure 32. Furthermore, because, following the radial expansion and plastic deformation of the first and second tubular members, 1410 and 1430, the tubular sleeve 1418 may be maintained in circumferential compression and the end portions, 1414 and 1428, of the first and second tubular members, 1410 and 1430, may be maintained in circumferential tension, axial loads and/or torque loads may be transmitted through the tubular sleeve. In addition, the tubular sleeve 1418 may also increase the collapse strength of the end portions, 1414 and 1428, of the first and second tubular members, 1410 and 1430.

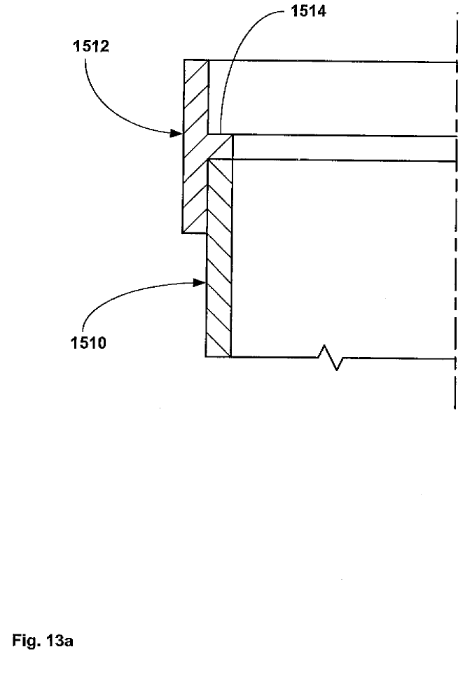

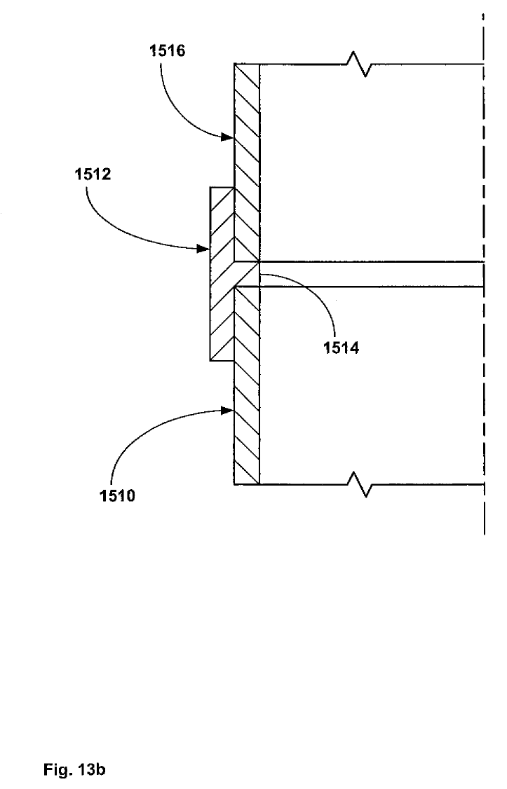

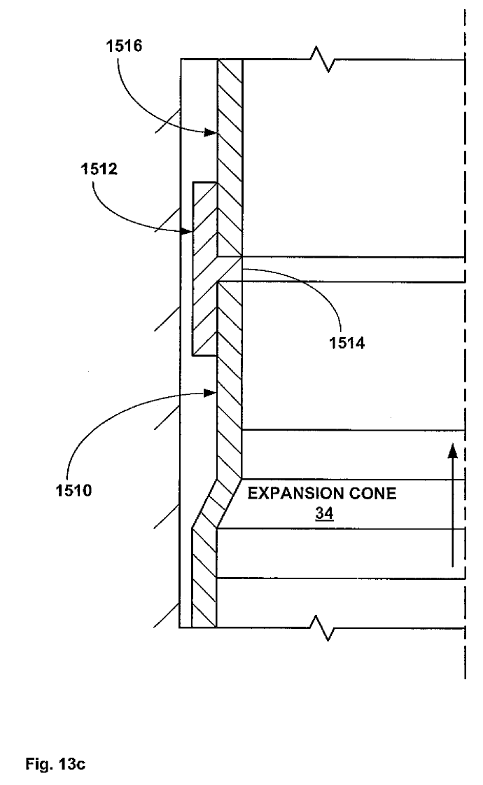

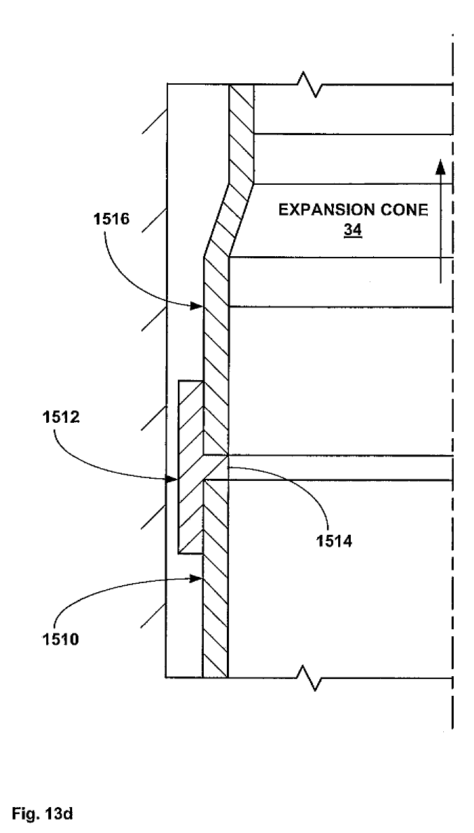

Referring to FIG. 13a, an end of a first tubular member 1510 is positioned within and coupled to an end of a tubular sleeve 1512 having an internal flange 1514. In an exemplary embodiment, the end of the first tubular member 1510 abuts one side of the internal flange 1514. As illustrated in FIG. 13b, an end of second tubular member 1516 is then positioned within and coupled to another end of the tubular sleeve 1512. In an exemplary embodiment, the end of the second tubular member 1516 abuts another side of the internal flange 1514. In an exemplary embodiment, the tubular sleeve 1512 is coupled to the ends of the first and second tubular members, 1510 and 1516, by expanding the tubular sleeve 1512 using heat and then inserting the ends of the first and second tubular members into the expanded tubular sleeve 1512. After cooling the tubular sleeve 1512, the tubular sleeve is coupled to the ends of the first and second tubular members, 1510 and 1516.

In an exemplary embodiment, as illustrated in FIGS. 13c and 13d, the first and second tubular members, 1510 and 1516, and the tubular sleeve 1512 may then be positioned within another structure 32 such as, for example, a wellbore, and radially expanded and plastically deformed, for example, by moving an expansion cone 34 through the interiors of the first and second tubular members. The movement of the expansion cone 34 through the interiors of the first and second tubular members, 1510 and 1516, may be from top to bottom or from bottom to top.

In an exemplary embodiment, during the radial expansion and plastic deformation of the first and second tubular members, 1510 and 1516, the tubular sleeve 1512 is also radially expanded and plastically deformed. In an exemplary embodiment, as a result, the tubular sleeve 1512 may be maintained in circumferential tension and the ends of the first and second tubular members, 1510 and 1516, may be maintained in circumferential compression.

The use of the tubular sleeve 1512 during (a) the placement of the first and second tubular members, 1510 and 1516, in the structure 32 and (b) the radial expansion and plastic deformation of the first and second tubular members provides a number of significant benefits. For example, the tubular sleeve 1512 may prevent crack propagation during the radial expansion and plastic deformation of the first and second tubular members, 1510 and 1516. In this manner, failure modes such as, for example, longitudinal cracks in the ends of the first and second tubular members, 1510 and 1516, may be limited in severity or eliminated all together. In addition, after completing the radial expansion and plastic deformation of the first and second tubular members, 1510 and 1516, the tubular sleeve 1512 may provide a fluid tight metal-to-metal seal between the exterior surface of the tubular sleeve and the interior surfaces of the end of the first and second tubular members. Furthermore, because, following the radial expansion and plastic deformation of the first and second tubular members, 1510 and 1516, the tubular sleeve 1512 may be maintained in circumferential compression and the ends of the first and second tubular members, 1510 and 1516, may be maintained in circumferential tension, axial loads and/or torque loads may be transmitted through the tubular sleeve. In addition, the tubular sleeve 1512 may also increase the collapse strength of the end portions of the first and second tubular members, 1510 and 1516.

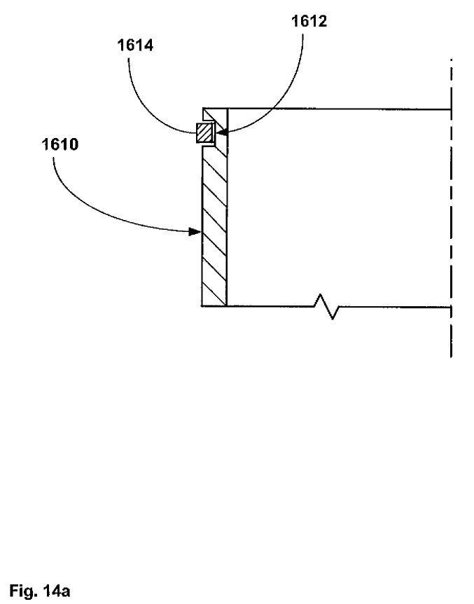

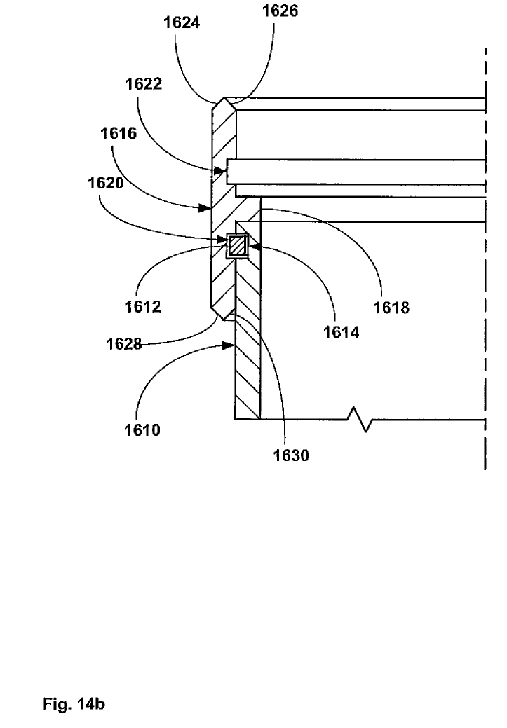

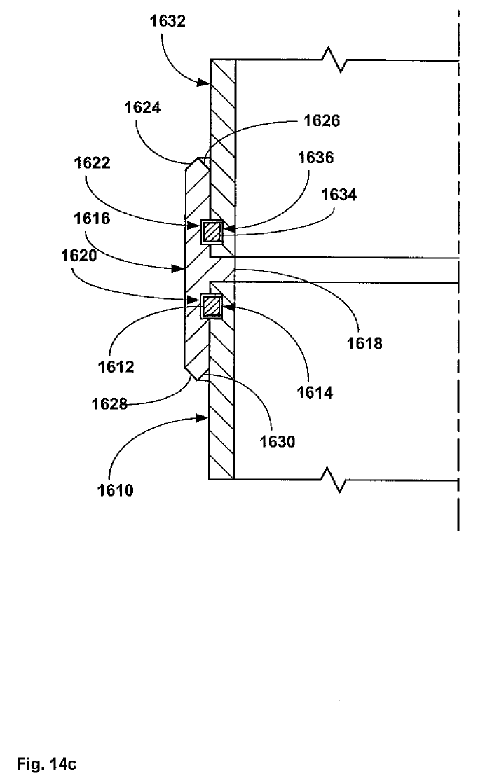

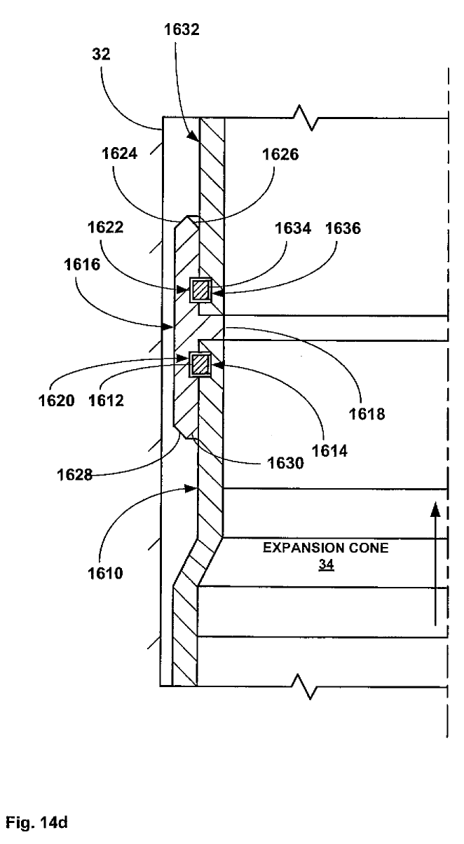

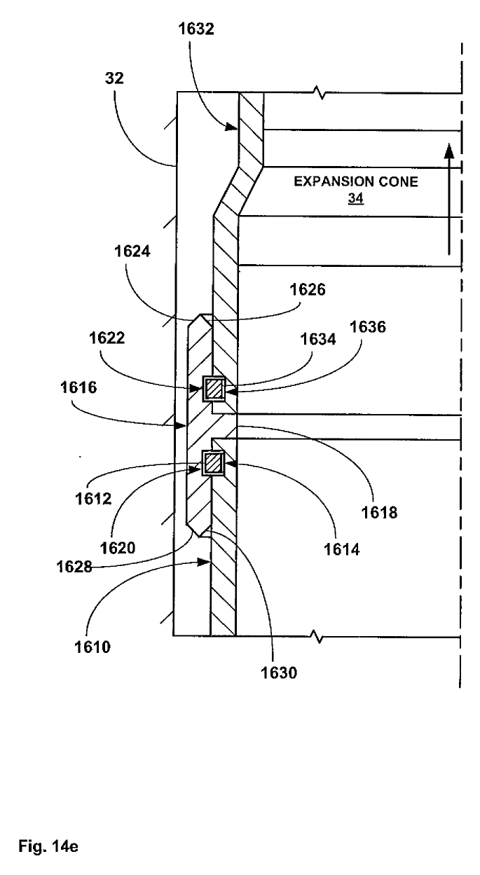

Referring to FIG. 14a, a first tubular member 1610 includes a resilient retaining ring 1612 mounted within an annular recess 1614. As illustrated in FIG. 14b, the end of the first tubular member 1610 is then inserted into and coupled to an end of a tubular sleeve 1616 including an internal flange 1618 and annular recesses, 1620 and 1622, positioned on opposite sides of the internal flange, tapered portions, 1624 and 1626, on one end of the tubular sleeve, and tapered portions, 1628 and 1630, on the other end of the tubular sleeve. In an exemplary embodiment, the resilient retaining ring 1612 is thereby positioned at least partially in the annular recesses, 1614 and 1620, thereby coupling the first tubular member 1610 to the tubular sleeve 1616, and the end of the first tubular member 1610 abuts one side of the internal flange 1618. During the coupling of the first tubular member 1610 to the tubular sleeve 1616, the tapered portion 1630 facilitates the radial compression of the resilient retaining ring 1612 during the insertion of the first tubular member into the tubular sleeve.

As illustrated in FIG. 14c, an end of a second tubular member 1632 that includes a resilient retaining ring 1634 mounted within an annular recess 1636 is then inserted into and coupled to another end of the tubular sleeve 1616. In an exemplary embodiment, the resilient retaining ring 1634 is thereby positioned at least partially in the annular recesses, 1636 and 1622, thereby coupling the second tubular member 1632 to the tubular sleeve 1616, and the end of the second tubular member 1632 abuts another side of the internal flange 1618. During the coupling of the second tubular member 1632 to the tubular sleeve 1616, the tapered portion 1626 facilitates the radial compression of the resilient retaining ring 1634 during the insertion of the second tubular member into the tubular sleeve.

In an exemplary embodiment, as illustrated in FIGS. 14d and 14e, the first and second tubular members, 1610 and 1632, and the tubular sleeve 1616 may then be positioned within another structure 32 such as, for example, a wellbore, and radially expanded and plastically deformed, for example, by moving an expansion cone 34 through the interiors of the first and second tubular members. The movement of the expansion cone 34 through the interiors of the first and second tubular members, 1610 and 1632, may be from top to bottom or from bottom to top.

In an exemplary embodiment, during the radial expansion and plastic deformation of the first and second tubular members, 1610 and 1632, the tubular sleeve 1616 is also radially expanded and plastically deformed. In an exemplary embodiment, as a result, the tubular sleeve 1616 may be maintained in circumferential tension and the ends of the first and second tubular members, 1610 and 1632, may be maintained in circumferential compression.

The use of the tubular sleeve 1616 during (a) the placement of the first and second tubular members, 1610 and 1632, in the stricture 32, and (b) the radial expansion and plastic deformation of the first and second tubular members provides a number of significant benefits. For example, the tubular sleeve 1616 protects the exterior surfaces of the ends of the first and second tubular members, 1610 and 1632, during handling and insertion of the tubular members within the structure 32. In this manner, damage to the exterior surfaces of the ends of the first and second tubular member, 1610 and 1632, are prevented that could result in stress concentrations that could result in a catastrophic failure during subsequent radial expansion operations. Furthermore, the tubular sleeve 1616 may prevent crack propagation during the radial expansion and plastic deformation of the first and second tubular members, 1610 and 1632. In this manner, failure modes such as, for example, longitudinal cracks in the ends of the first and second tubular members, 1610 and 1632, may be limited in severity or eliminated all together. In addition, after completing the radial expansion and plastic deformation of the first and second tubular members, 1610 and 1632, the tubular sleeve 1616 may provide a fluid tight metal-to-metal seal between interior surface of the tubular sleeve and the exterior surfaces of the ends of the first and second tubular members. Furthermore, because, following the radial expansion and plastic deformation of the first and second tubular members, 1610 and 1632, the tubular sleeve 1616 may be maintained in circumferential tension and the ends of the first and second tubular members, 1610 and 1632, may be maintained in circumferential compression, axial loads and/or torque loads may be transmitted through the tubular sleeve. In addition, the tubular sleeve 1616 may also increase the collapse strength of the end portions of the first and second tubular members, 1610 and 1632.

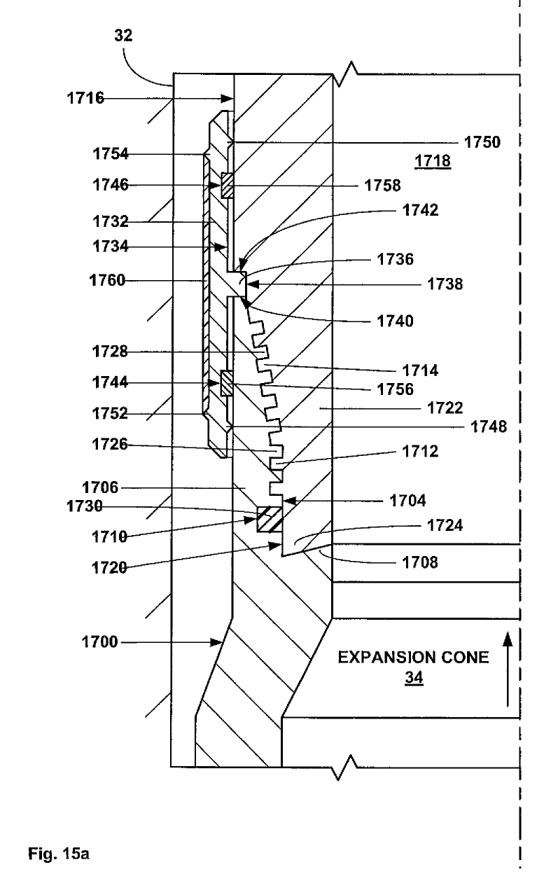

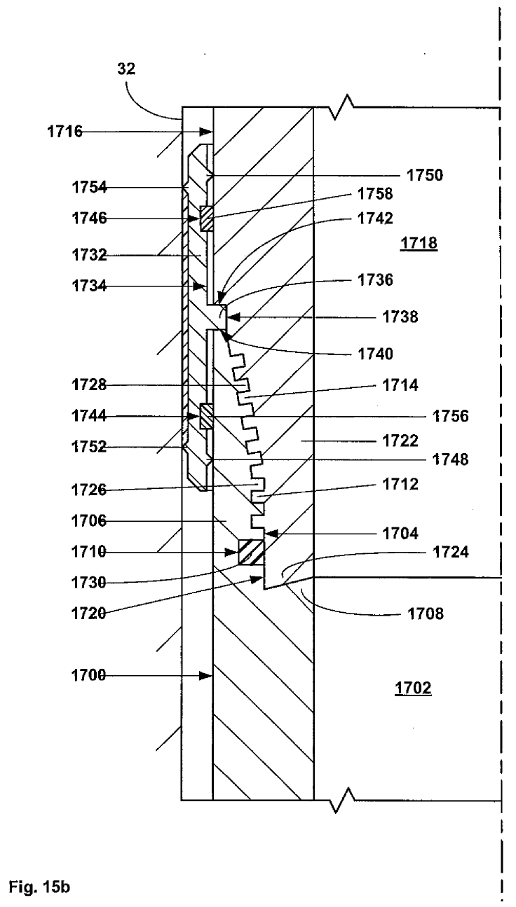

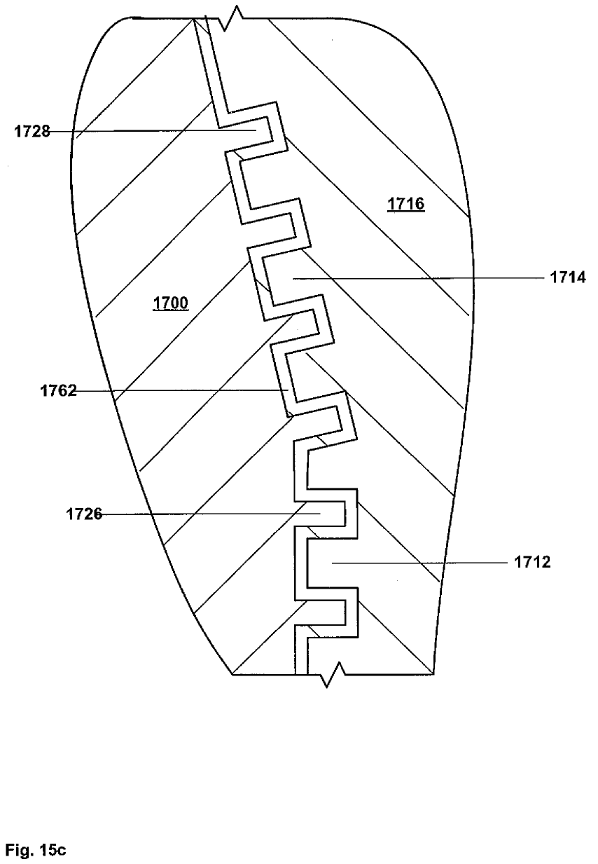

Referring to FIG. 15a, a first tubular member 1700 defines a passage 1702 and a counterbore 1704 at an end portion 1706. The counterbore 1704 includes a tapered shoulder 1708, an annular recess 1710, non-tapered internal threads, 1712, and tapered internal threads 1714. A second tubular member 1716 that defines a passage 1718 includes a recessed portion 1720 at an end portion 1722 that includes a tapered end portion 1724 that is adapted to mate with the tapered shoulder 1708 of the counterbore 1704 of the first tubular member 1700, non-tapered external threads 1726 adapted to mate with the non tapered internal threads 1712 of the counterbore of the first tubular member, and tapered external threads 1728 adapted to mate with the tapered internal threads 1714 of the counterbore of the first tubular member. A sealing ring 1730 is received within the annular recess 1710 of the counterbore 1704 of the of the first tubular member 1700 for fluidicly sealing the interface between the counterbore of the first tubular member and the recessed portion 1720 of the second tubular member 1716. In an exemplary embodiment, the threads, 1712, 1714, 1726, and 1728, are left-handed threads in order to prevent de-coupling of the first and second tubular members, 1700 and 1716, during placement of the tubular members within the structure 32. In an exemplary embodiment, the sealing ring 1730 is an elastomeric sealing ring.

A tubular sleeve 1732 that defines a passage 1734 for receiving the end portions, 1706 and 1722, of the first and second tubular members, 1700 and 1716, respectively, includes an internal flange 1736 that mates with and is received within an annular recess 1738 that is defined between an end face 1740 of the end portion of the first tubular member and an end face 1742 of the recessed portion 1720 of the end portion of the second tubular member. In this manner, the tubular sleeve 1732 is coupled to the first and second tubular members, 1700 and 1716. The tubular sleeve 1732 further includes first and second internal annular recesses, 1744 and 1746, internal tapered flanges, 1748 and 1750, and external tapered flanges, 1752 and 1754.

Sealing members, 1756 and 1758, are received within and mate with the internal annular recesses, 1744 and 1746, respectively, of the tubular sleeve 1732 that fluidicly seal the interface between the tubular sleeve and the first and second tubular members, 1700 and 1716, respectively. A sealing member 1760 is coupled to the exterior surface of the tubular sleeve 1732 for fluidicly sealing the interface between the tubular sleeve and the interior surface of the preexisting structure 32 following the radial expansion of the first and second tubular members, 1700 and 1716, and the tubular sleeve using the expansion cone 34. In an exemplary embodiment, the sealing members, 1756 and 1758, may be, for example, elastomeric or non-elastomeric sealing members fabricated from nitrile, viton, or Teflon™ materials. In an exemplary embodiment, the sealing member 1760 is fabricated from an elastomeric material.

In an exemplary embodiment, during the radial expansion and plastic deformation of the first and second tubular members, 1700 and 1716, the tubular sleeve 1732 is also radially expanded and plastically deformed. In an exemplary embodiment, as a result of the radial expansion, the tubular sleeve 1732 may be maintained in circumferential tension and the end portions, 1706 and 1722, of the first and second tubular members, 1700 and 1716, may be maintained in circumferential compression. Furthermore, in an exemplary embodiment, during and following the radial expansion and plastic deformation of the first and second tubular members, 1700 and 1716, respectively: (a) the sealing members, 1756 and 1758, of the tubular sleeve 1732 engage and fluidicly seal the interface between the tubular sleeve and the end portions, 1706 and 1722, of the first and second tubular members, (b) the internal tapered flanges, 1748 and 1750, of the tubular sleeve engage, and couple the tubular sleeve to, the end portions of the first and second tubular members, (c) the external tapered flanges, 1752 and 1754, of the tubular sleeve engage, and couple the tubular sleeve to, the structure 32, and (d) the sealing member 1760 engages and fluidicly seals the interface between the tubular sleeve and the structure.

In several exemplary embodiments, the first and second tubular members, 1700 and 1716, are radially expanded and plastically deformed using the expansion cone 34 in a conventional manner and/or using one or more of the methods and apparatus disclosed in one or more of the following: (1) U.S. patent application Ser. No. 09/454,139, filed on Dec. 13, 1999, (2) U.S. patent application Ser. No. 09/510,913, filed on Feb. 23, 2000, (3) U.S. patent application Ser. No. 09/502,350, filed on Feb. 10, 2000, (4) U.S. patent application Ser. No. 09/440,338, filed on Nov. 15, 1999, (5) U.S. patent application Ser. No. 09/523,460, filed on Mar. 10, 2000, (6) U.S. patent application Ser. No. 09/512,895, filed on Feb. 24, 2000, (7) U.S. patent application Ser. No. 09/511,941, filed on Feb. 24, 2000, (8) U.S. patent application Ser. No. 09/588,946, filed on Jun. 17, 2000, (9) U.S. patent application Ser. No. 09/559,122, filed on Apr. 26, 2000, (10) PCT patent application serial no. PCT/US00/18635, filed on Jul. 9, 2000, (11) U.S. provisional patent application Ser. No. 60/162,671, filed on Nov. 1, 1999, (12) U.S. provisional patent application Ser. No. 60/154,047, filed on Sep. 16, 1999, (13) U.S. provisional patent application Ser. No. 60/159,082, filed on Oct. 12, 1999, (14) U.S. provisional patent application Ser. No. 60/159,039, filed on Oct. 12, 1999, (15) U.S. provisional patent application Ser. No. 60/159,033, filed on Oct. 12, 1999, (16) U.S. provisional patent application Ser. No. 60/212,359, filed on Jun. 19, 2000, (17) U.S. provisional patent application Ser. No. 60/165,228, filed on Nov. 12, 1999, (18) U.S. provisional patent application Ser. No. 60/221,443, filed on Jul. 28, 2000, (19) U.S. provisional patent application Ser. No. 60/221,645, filed on Jul. 28, 2000, (20) U.S. provisional patent application Ser. No. 60/233,638, filed on Sep. 18, 2000, (21) U.S. provisional patent application Ser. No. 60/237,334, filed on Oct. 2, 2000, (22) U.S. provisional patent application Ser. No. 60/270,007, filed on Feb. 20, 2001, (23) U.S. provisional patent application Ser. No. 60/262,434, filed on Jan. 17, 2001, (24) U.S. provisional patent application Ser. No. 60/259,486, filed on Jan. 3, 2001, (25) U.S. provisional patent application Ser. No. 60/303,740, filed on Jul. 6, 2001, (26) U.S. provisional patent application Ser. No. 60/313,453, filed on Aug. 20, 2001, (27) U.S. provisional patent application Ser. No. 60/317,985, filed on Sep. 6, 2001, (28) U.S. provisional patent application Ser. No. 60/318,386, filed on Sep. 10, 2001, (29) U.S. utility patent application Ser. No. 09/969,922, filed on Oct. 3, 2001, (30) U.S. utility patent application Ser. No. 10/016,467, filed on Dec. 10, 2001; (31) U.S. provisional patent application Ser. No. 60/343,674, filed on Dec. 27, 2001; (32) U.S. provisional patent application Ser. No. 60/346,309, filed on Jan. 7, 2002; and (33) U.S. provisional patent application Ser. No. 60/372,478, filed on Apr. 12, 2002, the disclosures of which are incorporated herein by reference.

In several alternative embodiments, the first and second tubular members, 1700 and 1716, are radially expanded and plastically deformed using other conventional methods for radially expanding and plastically deforming tubular members such as, for example, internal pressurization and/or roller expansion devices such as, for example, that disclosed in U.S. patent application publication no. US 2001/0045284 A1, the disclosure of which is incorporated herein by reference.

The use of the tubular sleeve 1732 during (a) the threaded coupling of the first tubular member 1700 to the second tubular member 1716, (b) the placement of the first and second tubular members in the structure 32, and (c) the radial expansion and plastic deformation of the first and second tubular members provides a number of significant benefits. For example, the tubular sleeve 1732 protects the exterior surfaces of the end portions, 1706 and 1722, of the first and second tubular members, 1700 and 1716, during handling and insertion of the tubular members within the structure 32. In this manner, damage to the exterior surfaces of the end portions, 1706 and 1722, of the first and second tubular member, 1700 and 1716, are prevented that could result in stress concentrations that could result in a catastrophic failure during subsequent radial expansion operations. Furthermore, the tubular sleeve 1732 provides an alignment guide that facilitates the insertion and threaded coupling of the second tubular member 1716 to the first tubular member 1700. In this manner, misalignment that could result in damage to the threaded connections, 1712, 1714, 1726, and 1728, of the first and second tubular members, 1700 and 1716, may be avoided. In addition, during the relative rotation of the second tubular member with respect to the first tubular member, required during the threaded coupling of the first and second tubular members, the tubular sleeve 1732 provides an indication of to what degree the first and second tubular members are threadably coupled. For example, if the tubular sleeve 1732 can be easily rotated, that would indicate that the first and second tubular members, 1700 and 1716, are not fully threadably coupled and in intimate contact with the internal flange 1736 of the tubular sleeve. Furthermore, the tubular sleeve 1732 may prevent crack propagation during the radial expansion and plastic deformation of the first and second tubular members, 1700 and 1716. In this manner, failure modes such as, for example, longitudinal cracks in the end portions, 1706 and 1722, of the first and second tubular members may be limited in severity or eliminated all together. In addition, after completing the radial expansion and plastic deformation of the first and second tubular members, 1700 and 1716, the tubular sleeve 16 may provide a fluid tight metal-to-metal seal between interior surface of the tubular sleeve and the exterior surfaces of the end portions, 1706 and 1722, of the first and second tubular members. In this manner, fluidic materials are prevented from passing through the threaded connections, 1712, 1714, 1726, and 1728, of the first and second tubular members, 1700 and 1716, into the annulus between the first and second tubular members and the structure 32. Furthermore, because, following the radial expansion and plastic deformation of the first and second tubular members, 1700 and 1716, the tubular sleeve 1732 may be maintained in circumferential tension and the end portions, 1706 and 1722, of the first and second tubular members, 1700 and 1716, may be maintained in circumferential compression, axial loads and/or torque loads may be transmitted through the tubular sleeve. In addition, the tubular sleeve 1732 may also increase the collapse strength of the end portions, 1706 and 1722, of the first and second tubular members, 1700 and 1716.

In an exemplary experimental implementation, following the radial expansion and plastic deformation of the first and second tubular members, 1700 and 1716, and the tubular sleeve 1732, the threads, 1712, 1714, 1726, and 1728, of the end portions, 1706 and 1722, of the first and second tubular members were unexpectedly deformed such that a fluidic seal was unexpectedly formed between and among the threads of the first and second tubular members. In this manner, a fluid tight seal was unexpectedly provided between the first and second tubular member, 1700 and 1716, due to the presence of the tubular sleeve 1732 during the radial expansion and plastic deformation of the end portions, 1706 and 1722, of the first and second tubular members.

In an exemplary embodiment, the rate and degree of radial expansion and plastic deformation of the first and second tubular members, 1700 and 1716, and the tubular sleeve 1732 are adjusted to generate sufficient localized heating to result in amorphous bonding or welding of the threads, 1712, 1714, 1726, and 1728. As a result, the first and second tubular members, 1700 and 1716, may be amorphously bonded resulting a joint between the first and second tubulars that is nearly metallurgically homogeneous.

In an alternative embodiment, as illustrated in FIG. 15c, a metallic foil 1762 of a suitable alloy is placed between and among the threads, 1712, 1714, 1726, and 1728, and during the radial expansion and plastic deformation of the first and second tubular members, 1700 and 1716, and the tubular sleeve 1732, localized heating of the region proximate the threads, 1712, 1714, 1726, and 1728, results in amorphous bonding or a brazing joint of the threads. As a result, the first and second tubular members, 1700 and 1716, may be amorphously bonded resulting a joint between the first and second tubulars that is nearly metallurgically homogeneous.

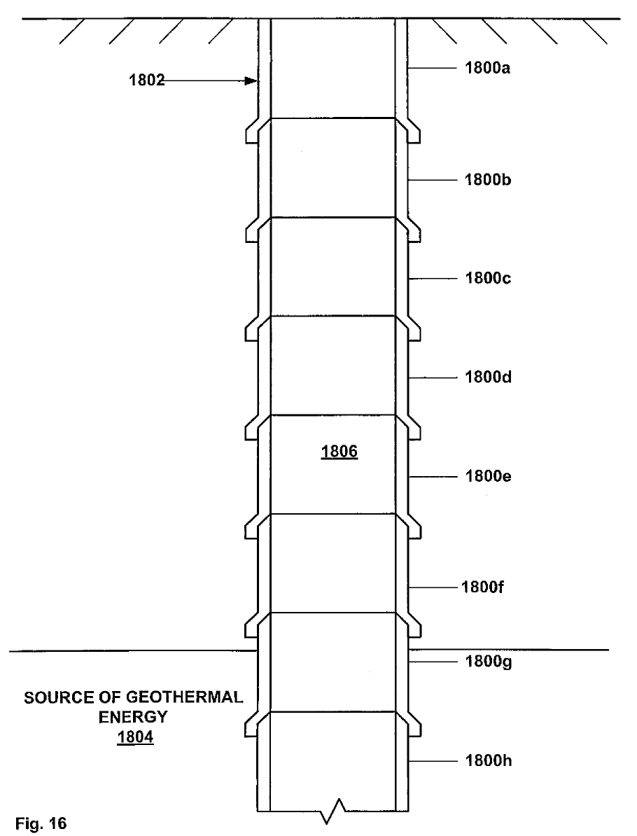

In an exemplary embodiment, as illustrated in FIG. 16, a plurality of overlapping wellbore casing strings 1800a-1800h, are positioned within a borehole 1802 that traverses a subterranean source 1804 of geothermal energy. In this manner, geothermal energy may then be extracted from the subterranean source 1804 geothermal energy using conventional methods of extraction. In an exemplary embodiment, one or more of the wellbore casing strings 1800 include one or more of the first and second tubular members, 10, 28, 910, 938, 1010, 1036, 1110, 1128, 1210, 1232, 1310, 1328, 1410, 1430, 1510, 1516, 1610, 1632, 1700 and/or 1716, that are coupled end-to-end and include one or more of the tubular sleeves, 16, 110, 210, 310, 410, 510, 610, 710, 810, 918, 1018, 1116, 1216, 1316, 1418, 1512, 1616 and/or 1732. In an exemplary embodiment, the wellbore casing strings, 1800a-1800h, are radially expanded and plastically deformed in overlapping fashion within the borehole 1802.

For example, the wellbore casing string 1800a is positioned within the borehole 1802 and then radially expanded and plastically deformed. The wellbore casing string 1800b is then positioned within the borehole 1802 in overlapping relation to the wellbore casing string 1800a and then radially expanded and plastically deformed. In this manner, a mono-diameter wellbore casing may be formed that includes the overlapping wellbore casing strings 1800a and 1800b. This process may then be repeated for wellbore casing strings 1800c-1800h. As a result, a mono-diameter wellbore casing may be produced that extends from a surface location to the source 1804 of geothermal energy in which the inside diameter of a passage 1806 defined by the interiors of the wellbore casing strings 1800a-1800h is constant. In this manner, the geothermal energy from the source 1804 may be efficiently and economically extracted. Furthermore, because variations in the inside diameter of the wellbore casing strings 1800 is eliminated by the resulting mono-diameter design, the depth of the borehole 1802 may be virtually limitless. As a result, using the teachings of the present exemplary embodiments, sources of geothermal energy can now be extracted from depths of over 50,000 feet.

In several exemplary embodiments, the wellbore casing strings 1800a-1800h are radially expanded and plastically deformed using the expansion cone 34 using one or more of the methods and apparatus disclosed in one or more of the following: (1) U.S. patent application Ser. No. 09/454,139, filed on Dec. 13, 1999, (2) U.S. patent application Ser. No. 09/510,913, filed on Feb. 23, 2000, (3) U.S. patent application Ser. No. 09/502,350, filed on Feb. 10, 2000, (4) U.S. patent application Ser. No. 09/440,338, filed on Nov. 15, 1999, (5) U.S. patent application Ser. No. 09/523,460, filed on Mar. 10, 2000, (6) U.S. patent application Ser. No. 09/512,895, filed on Feb. 24, 2000, (7) U.S. patent application Ser. No. 09/511,941, filed on Feb. 24, 2000, (8) U.S. patent application Ser. No. 09/588,946, filed on Jun. 17, 2000, (9) U.S. patent application Ser. No. 09/559,122, filed on Apr. 26, 2000, (10) PCT patent application serial no. PCT/US00/18635, filed on Jul. 9, 2000, (11) U.S. provisional patent application Ser. No. 60/162,671, filed on Nov. 1, 1999, (12) U.S. provisional patent application Ser. No. 60/154,047, filed on Sep. 16, 1999, (13) U.S. provisional patent application Ser. No. 60/159,082, filed on Oct. 12, 1999, (14) U.S. provisional patent application Ser. No. 60/159,039, filed on Oct. 12, 1999, (15) U.S. provisional patent application Ser. No. 60/159,033, filed on Oct. 12, 1999, (16) U.S. provisional patent application Ser. No. 60/212,359, filed on Jun. 19, 2000, (17) U.S. provisional patent application Ser. No. 60/165,228, filed on Nov. 12, 1999, (18) U.S. provisional patent application Ser. No. 60/221,443, filed on Jul. 28, 2000, (19) U.S. provisional patent application Ser. No. 60/221,645, filed on Jul. 28, 2000, (20) U.S. provisional patent application Ser. No. 60/233,638, filed on Sep. 18, 2000, (21) U.S. provisional patent application Ser. No. 60/237,334, filed on Oct. 2, 2000, (22) U.S. provisional patent application Ser. No. 60/270,007, filed on Feb. 20, 2001, (23) U.S. provisional patent application Ser. No. 60/262,434, filed on Jan. 17, 2001, (24) U.S. provisional patent application Ser. No. 60/259,486, filed on Jan. 3, 2001, (25) U.S. provisional patent application Ser. No. 60/303,740, filed on Jul. 6, 2001, (26) U.S. provisional patent application Ser. No. 60/313,453, filed on Aug. 20, 2001, (27) U.S. provisional patent application Ser. No. 60/317,985, filed on Sep. 6, 2001, (28) U.S. provisional patent application Ser. No. 60/318,386, filed on Sep. 10, 2001, (29) U.S. utility patent application Ser. No. 09/969,922, filed on Oct. 3, 2001, (30) U.S. utility patent application Ser. No. 10/016,467, filed on Dec. 10, 2001; (31) U.S. provisional patent application Ser. No. 60/343,674, filed on Dec. 27, 2001; (32) U.S. provisional patent application Ser. No. 60/346,309, filed on Jan. 7, 2002; and (33) U.S. provisional patent application Ser. No. 60/372,478, filed on Apr. 12, 2002, the disclosures of which are incorporated herein by reference.

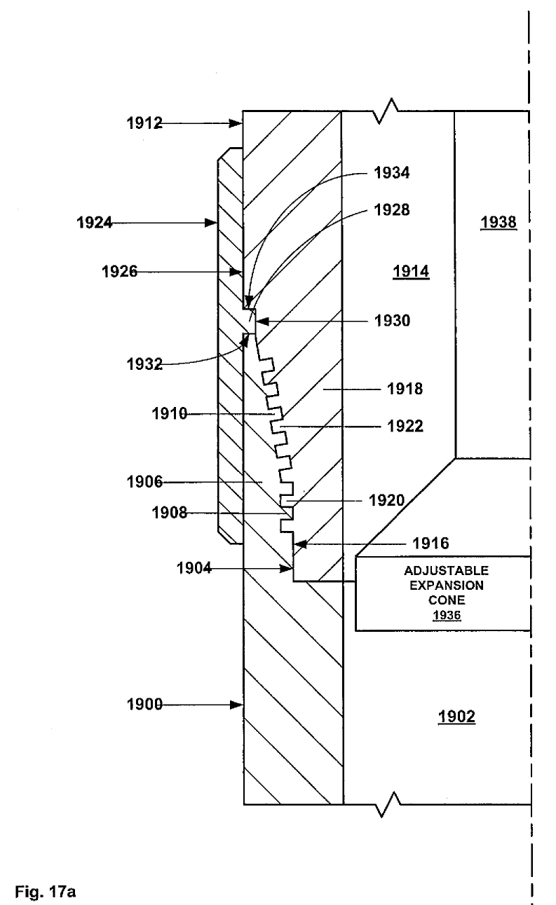

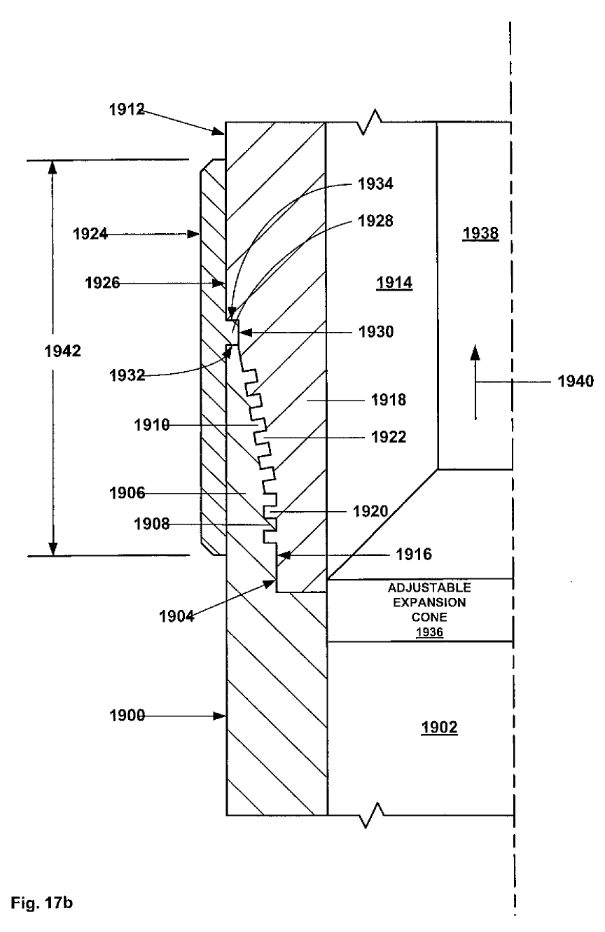

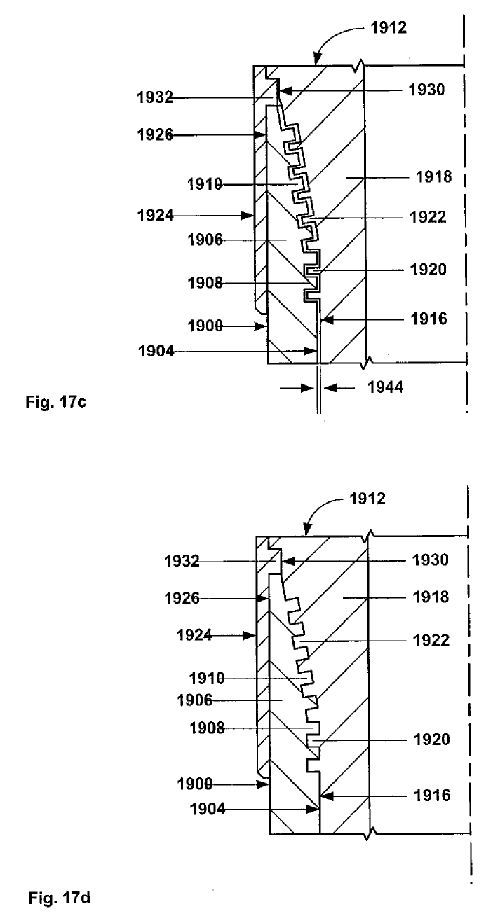

Referring to FIG. 17a, a first tubular member 1900 defines a passage 1902 and a counterbore 1904 at an end portion 1906. The counterbore 1904 includes non-tapered internal threads 1908, and tapered internal threads 1910. A second tubular member 1912 that defines a passage 1914 includes a recessed portion 1916 at an end portion 1918 that includes non-tapered external threads 1920 adapted to mate with the non-tapered internal threads 1908 of the counterbore of the first tubular member, and tapered external threads 1922 adapted to mate with the tapered internal threads 1910 of the counterbore of the first tubular member. In an exemplary embodiment, the threads, 1908, 1910, 1920, and 1922, are left-handed threads in order to prevent de-coupling of the first and second tubular members, 1900 and 1912, during handling of tubular members.

A tubular sleeve 1924 that defines a passage 1926 for receiving the end portions, 1906 and 1918, of the first and second tubular members, 1900 and 1912, respectively, includes an internal flange 1928 that mates with and is received within an annular recess 1930 that is defined between an end face 1932 of the end portion of the first tubular member and an end face 1934 of the recessed portion 1916 of the end portion of the second tubular member. In this manner, the tubular sleeve 1924 is coupled to the first and second tubular members, 1900 and 1912.

An adjustable expansion cone 1936 supported by a support member 1938 may then lowered into the first and second tubular members, 1900 and 1912, to a position proximate the vicinity of the threads, 1908, 1910, 1920, and 1922. As illustrated in FIG. 17b, The expansion cone 1936 may then be controllably increased in size until the outside circumference of the expansion cone engages and radially expands and plastically deforms the end portions of the first and second tubular members, 1900 and 1912, proximate the expansion cone. The expansion cone 1936 may then be displaced in the longitudinal direction 1940 thereby radially expanding and plastically deforming the remaining portions of the first and second tubular members, 1900 and 1912, in the vicinity of the threads, 1908, 1910, 1920, and 1922. In several exemplary embodiments, the amount of radial expansion ranged from less than about one percent to less than about five percent.

After completing the radial expansion and plastic deformation of the portions 1942 of the first and second tubular members, 1900 and 1912, in the vicinity of the threads, 1908, 1910, 1920, and 1922, the expansion cone 1936 may then be controllably reduced in size until the outside circumference of the expansion cone disengages from the portion of the second tubular above the portion of the second tubular member in the vicinity of the threads. In this manner, only the portions 1942 of the first and second tubular members, 1900 and 1912, in the vicinity of the threads, 1908, 1910, 1920, and 1922, are radially expanded and plastically deformed.

In several exemplary embodiments, the portions 1942 of the first and second tubular members, 1900 and 1912, in the vicinity of the threads, 1908, 1910, 1920, are radially expanded and plastically deformed using one or more of the methods and apparatus disclosed in one or more of the following: (1) U.S. patent application Ser. No. 09/454,139, filed on Dec. 13, 1999, (2) U.S. patent application Ser. No. 09/510,913, filed on Feb. 23, 2000, (3) U.S. patent application Ser. No. 09/502,350, filed on Feb. 10, 2000, (4) U.S. patent application Ser. No. 09/440,338, filed on Nov. 15, 1999, (5) U.S. patent application Ser. No. 09/523,460, filed on Mar. 10, 2000, (6) U.S. patent application Ser. No. 09/512,895, filed on Feb. 24, 2000, (7) U.S. patent application Ser. No. 09/511,941, filed on Feb. 24, 2000, (8) U.S. patent application Ser. No. 09/588,946, filed on Jun. 17, 2000, (9) U.S. patent application Ser. No. 09/559,122, filed on Apr. 26, 2000, (10) PCT patent application serial no. PCT/US00/18635, filed on Jul. 9, 2000, (11) U.S. provisional patent application Ser. No. 60/162,671, filed on Nov. 1, 1999, (12) U.S. provisional patent application Ser. No. 60/154,047, filed on Sep. 16, 1999, (13) U.S. provisional patent application Ser. No. 60/159,082, filed on Oct. 12, 1999, (14) U.S. provisional patent application Ser. No. 60/159,039, filed on Oct. 12, 1999, (15) U.S. provisional patent application Ser. No. 60/159,033, filed on Oct. 12, 1999, (16) U.S. provisional patent application Ser. No. 60/212,359, filed on Jun. 19, 2000, (17) U.S. provisional patent application Ser. No. 60/165,228, filed on Nov. 12, 1999, (18) U.S. provisional patent application Ser. No. 60/221,443, filed on Jul. 28, 2000, (19) U.S. provisional patent application Ser. No. 60/221,645, filed on Jul. 28, 2000, (20) U.S. provisional patent application Ser. No. 60/233,638, filed on Sep. 18, 2000, (21) U.S. provisional patent application Ser. No. 60/237,334, filed on Oct. 2, 2000, (22) U.S. provisional patent application Ser. No. 60/270,007, filed on Feb. 20, 2001, (23) U.S. provisional patent application Ser. No. 60/262,434, filed on Jan. 17, 2001, (24) U.S. provisional patent application Ser. No. 60/259,486, filed on Jan. 3, 2001, (25) U.S. provisional patent application Ser. No. 60/303,740, filed on Jul. 6, 2001, (26) U.S. provisional patent application Ser. No. 60/313,453, filed on Aug. 20, 2001, (27) U.S. provisional patent application Ser. No. 60/317,985, filed on Sep. 6, 2001, (28) U.S. provisional patent application Ser. No. 60/318,386, filed on Sep. 10, 2001, (29) U.S. utility patent application Ser. No. 09/969,922, filed on Oct. 3, 2001, (30) U.S. utility patent application Ser. No. 10/016,467, filed on Dec. 10, 2001; (31) U.S. provisional patent application Ser. No. 60/343,674, filed on Dec. 27, 2001; (32) U.S. provisional patent application Ser. No. 60/346,309, filed on Jan. 7, 2002; and (33) U.S. provisional patent application Ser. No. 60/372,478, filed on Apr. 12, 2002, the disclosures of which are incorporated herein by reference.

As illustrated in FIG. 17c, in an exemplary experimental implementation, prior to the radial expansion and plastic deformation of the portions 1942 of the first and second tubular members, 1900 and 1912, in the vicinity of the threads, 1908, 1910, 1920, and 1922, a variable gap 1944 is typically present between the threads, 1908 and 1920, and 1910 and 1922, that may permit fluidic materials to pass there through. The gap 1944 may be present, for example, in the radial, longitudinal and/or circumferential directions. The leakage of fluidic materials through the gap 1944 can cause serious problems, for example, in the extraction of subterranean fluids during oil or gas exploration and production operations, during the transport of hydrocarbons using underground pipelines, during the transport of pressurized fluids in a chemical processing plant, or within the heat exchanger tubes of a power plant.

In an exemplary experimental implementation, as illustrated in FIG. 17d, following the radial expansion and plastic deformation of the portion 1942 of the first and second tubular members, 1900 and 1912, in the vicinity of the threads, 1908, 1910, 1920, and 1922, the gap 1944 between the threads was unexpectedly eliminated thereby creating a fluid tight seal. As a result a fluid tight seal may be provided within the threads, 1908, 1910, 1920, and 1922, of the first and second tubular members, 1900 and 1912, without an elastomeric, or other conventional, sealing element present.

Furthermore, in an exemplary experimental implementation, following the radial expansion and plastic deformation of the portions 1942 of the first and second tubular members, 1900 and 1912, in the vicinity of the threads, 1908, 1910, 1920, and 1922, a fluid tight seal was also created between the interior circumference of the tubular sleeve 1924 and the exterior circumferences of the first and second tubular members, 1900 and 1912.

Thus, the teachings of the present illustrative embodiments of FIGS. 17a-17d may also be used to provide a fluid tight seal between the first and second tubular members, 10, 28, 910, 938, 1010, 1036, 1110, 1128, 1210, 1232, 1310, 1328, 1410, 1430, 1510, 1516, 1610, 1632, 1700 and/or 1716, that are coupled end-to-end and include one or more of the tubular sleeves, 16, 110, 210, 310, 410, 510, 610, 710, 810, 918, 1018, 1116, 1216, 1316, 1418, 1512, 1616 and/or 1732. A fluid tight seal may thereby be formed within the threaded connection between the adjacent tubular members and/or between the tubular sleeve and the adjacent tubular members.

More generally, the teachings of the present illustrative embodiments may be used to solve the problem of providing a fluid tight seal between all types of tubular members such as, for example, wellbore casings, pipes, underground pipelines, piping used in the transport of pressurized fluids in a chemical processing plant, or within the heat exchanger tubes of a power plant.

Furthermore, the teachings of the present illustrative embodiments may be used to solve the problem of providing a fluid tight seal between all types of tubular members such as, for example, wellbore casings, chemical processing pipes and underground pipelines, without having to radially expand and plastically deform the entire length of the tubular members. Instead, only those portions of the tubular members proximate the tubular sleeve provided adjacent to the joint between the tubular members needs to be radially expanded and plastically deformed. Furthermore, in an exemplary embodiment, the amount of radial expansion and plastic deformation ranged from less than about one percent to less than about five percent. As a result, the amount of time and resources typically needed to perform the radial expansion and plastic deformation is economical.

More generally, the teachings of the exemplary embodiments may be used to provide an inexpensive and reliable fluid tight seal between tubular members. In this manner, expensive and unreliable methods of providing a fluid tight seal between tubular members such as, for example, those methods utilized in the chemical processing industries and in power plant heat exchangers may be replaced with the teachings of the present illustrative embodiments.

Furthermore, the teachings of the exemplary embodiments provide a method of radially expanding and plastically deforming the ends of adjacent coupled tubular members in which the freedom of movement of the adjacent ends of the coupled tubular members is constrained by the presence of the tubular sleeve. As a result, during the subsequent radial expansion process, the adjacent ends of the coupled tubular members are compressed into the plastic region of the stress-strain curve. Consequently, the material of the adjacent ends of the coupled tubular members such as, for example, the internal and external threads, flow into and fill any gaps or voids that may have existed within the junction of the coupled tubular members thereby providing a fluid tight seal. The creation of the fluid tight seal within the junction of the adjacent tubular members was an unexpected result that was discovered during experimental analysis and testing of the present exemplary embodiments. In fact, also unexpectedly, during a further exemplary analysis and testing of the present exemplary embodiments, a fluid tight seal was maintained within the junction between two adjacent tubulars despite being bent over 60 degrees relative to one another.

Thus the present exemplary embodiments will eliminate the need for expensive high precision threaded connection for tubular members in order to provide a fluid tight seal. Instead, a fluid tight seal can now be provided using a combination of less expensive conventional threaded connection and a tubular sleeve that are then radially expanded to provide a fluid tight seal. Thus, the commercial application of the present exemplary embodiments will dramatically reduce the cost of oil and gas exploration and production. Furthermore, the teachings of the present exemplary embodiments can be extended to provide a fluid tight seal between adjacent tubular members in other applications such as, for example, underground pipelines, piping in chemical processing plants, and piping in power plants, in which conventional, inexpensive, piping with conventional threaded connections can be coupled together with a tubular sleeve and then radially expanded to provide an inexpensive and reliable fluid tight seal between the adjacent pipe sections.

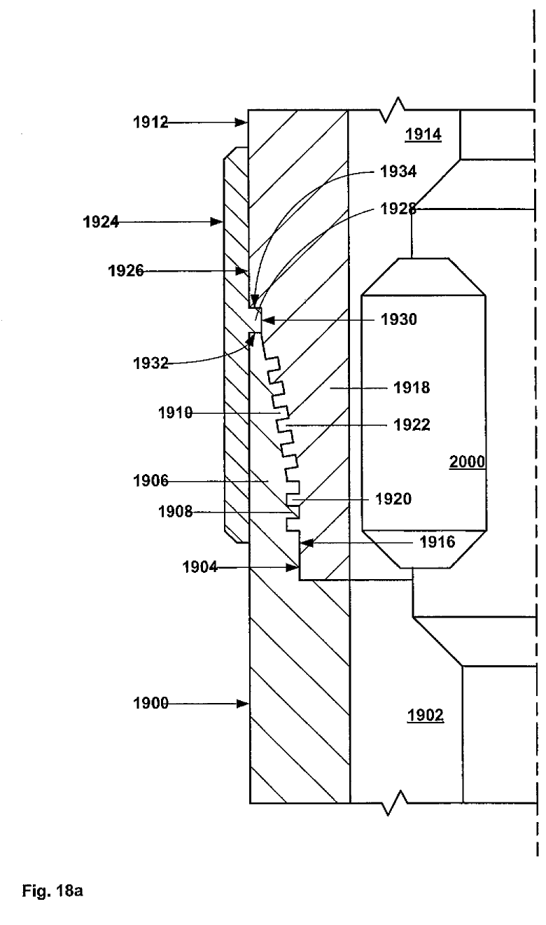

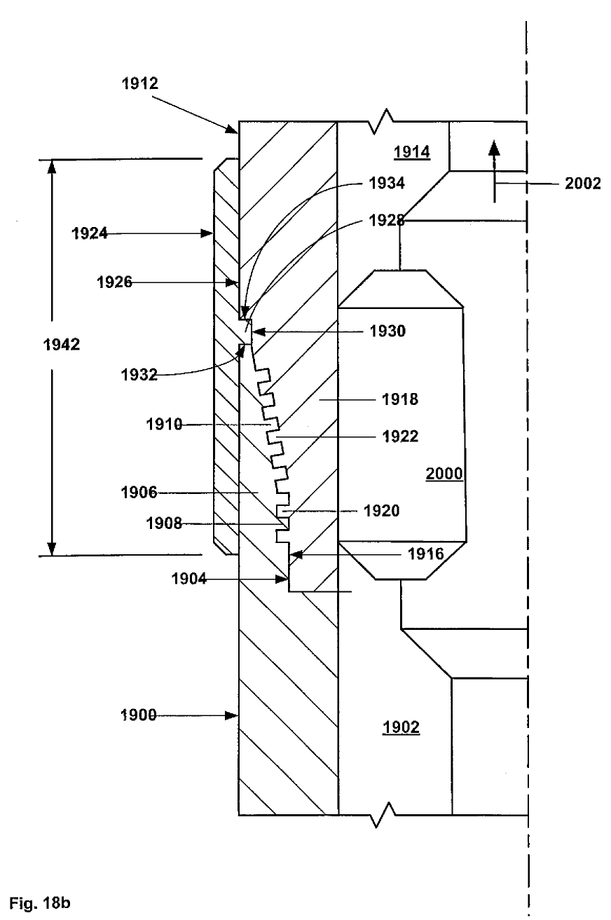

Referring to FIGS. 18a and 18b, in an alternative embodiment, a conventional rotary expansion tool 2000 may then lowered into the first and second tubular members, 1900 and 1912, to a position proximate the vicinity of the threads, 1908, 1910, 1920, and 1922. In an exemplary embodiment, the rotary expansion tool 2000 may be, for example, a rotary expansion tool as disclosed in U.S. Patent Application Publication No. U.S. 2001/0045284, WO 02/081863, WO 02/075107, U.S. Pat. No. 6,457,532, U.S. Pat. No. 6,454,013, U.S. Pat. No. 6,112,818, U.S. Pat. No. 6,425,444, U.S. Pat. No. 6,527,049, and/or U.S. Patent Application Publication No. U.S. 2002/0139540, the disclosures of which are incorporated herein by reference.

As illustrated in FIG. 18b, The rotary expansion tool 2000 may then be controllably increased in size and operated until the outside circumference of the rotary expansion tool engages and radially expands and plastically deforms the end portions of the first and second tubular members, 1900 and 1912, proximate the expansion cone. The rotary expansion tool 2000 may then be displaced in the longitudinal direction 2002 thereby radially expanding and plastically deforming the remaining portions of the first and second tubular members, 1900 and 1912, in the vicinity of the threads, 1908, 1910, 1920, and 1922. In an exemplary embodiment, the amount of radial expansion is less than about five percent. After completing the radial expansion and plastic deformation of the portion 1942 of the first and second tubular members, 1900 and 1912, in the vicinity of the threads, 1908, 1910, 1920, and 1922, the rotary expansion tool 2000 may then be controllably reduced in size until the outside circumference of the expansion cone disengages from the portion of the second tubular above the portion of the second tubular member in the vicinity of the threads. In this manner, only the portions of the first and second tubular members, 1900 and 1912, in the vicinity of the threads, 1908, 1910, 1920, and 1922, are radially expanded and plastically deformed.

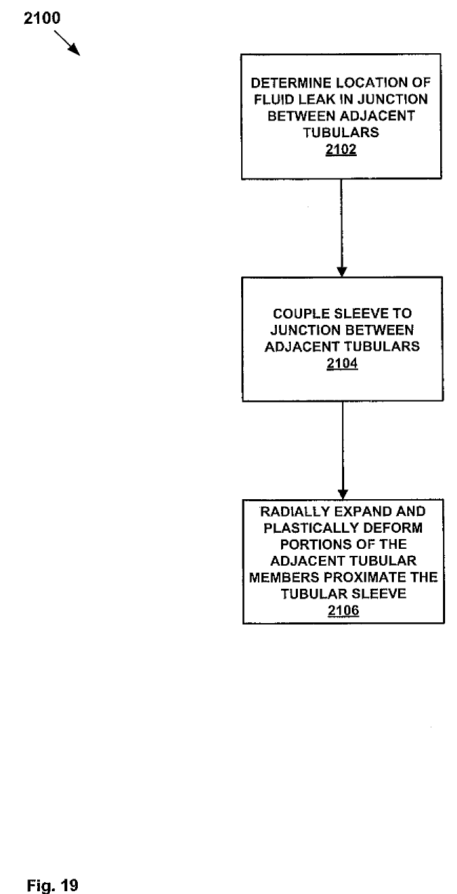

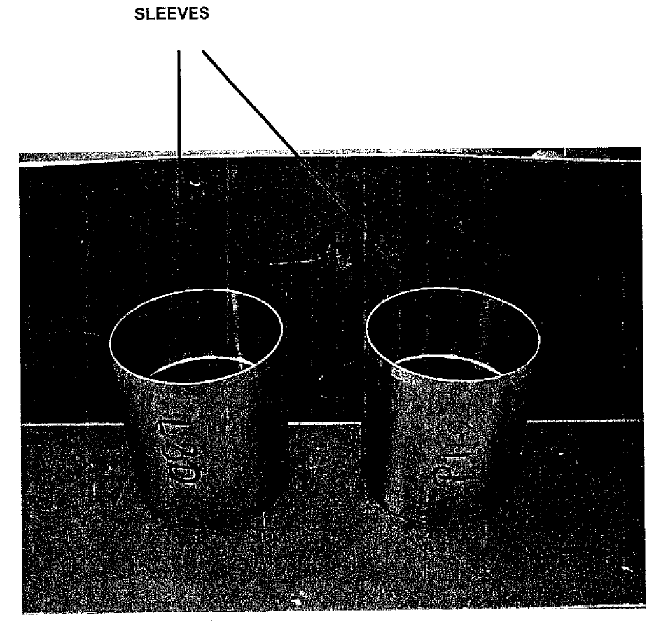

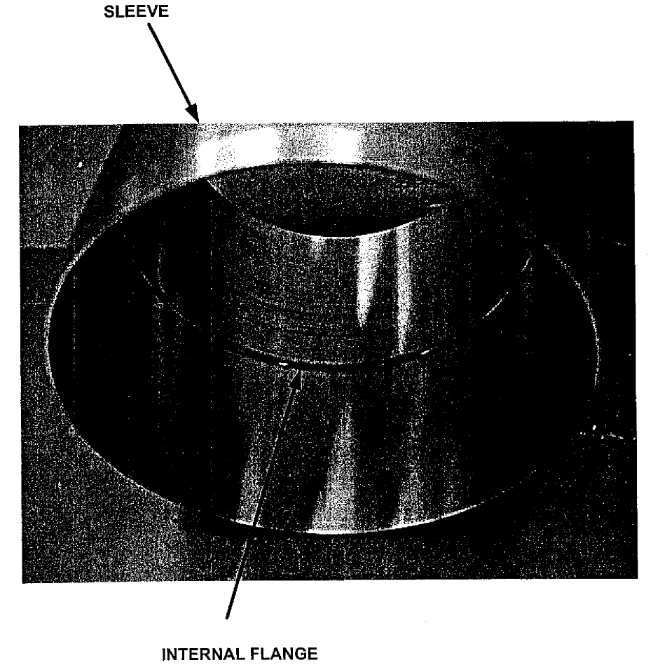

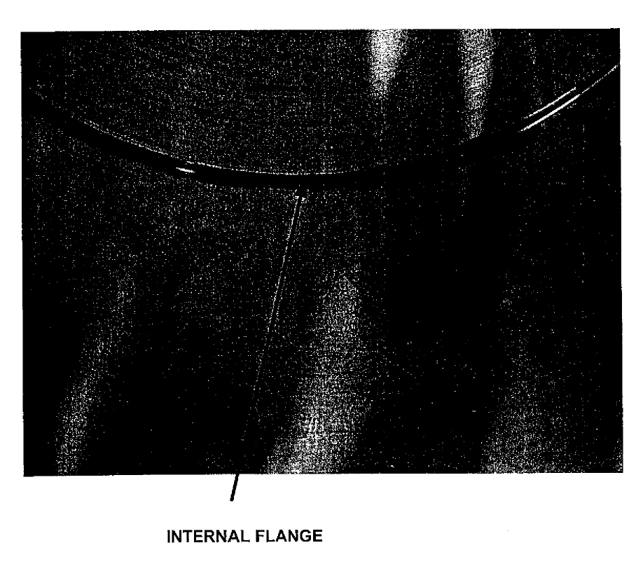

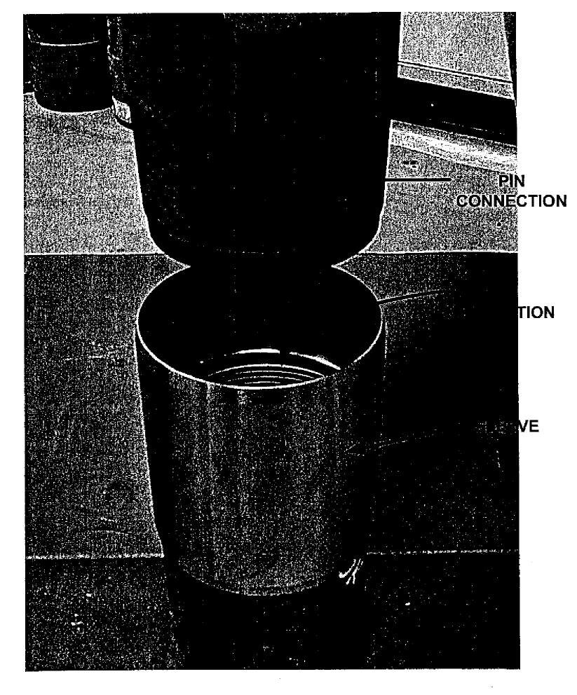

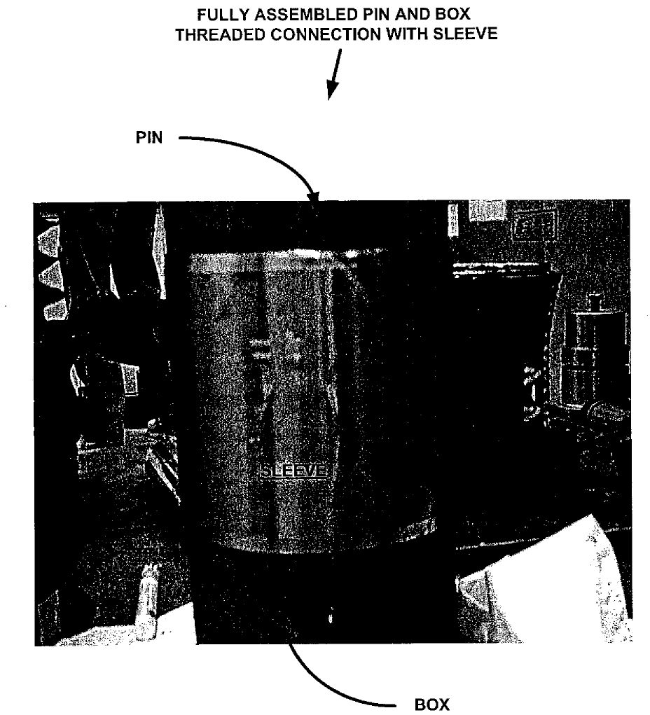

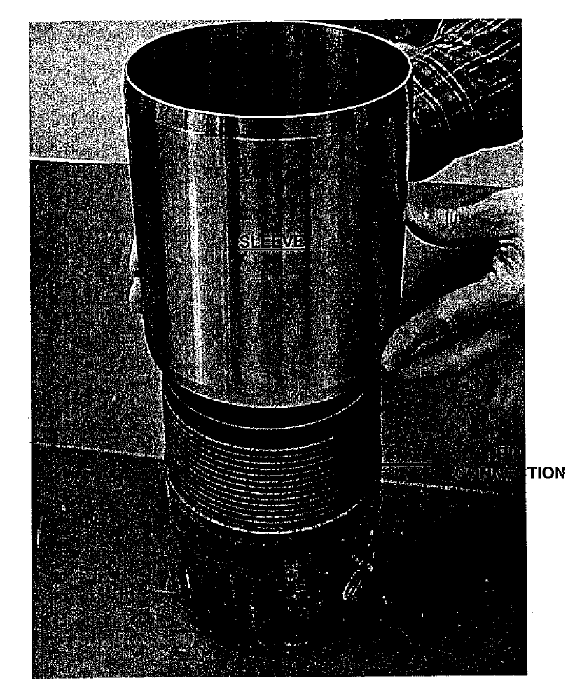

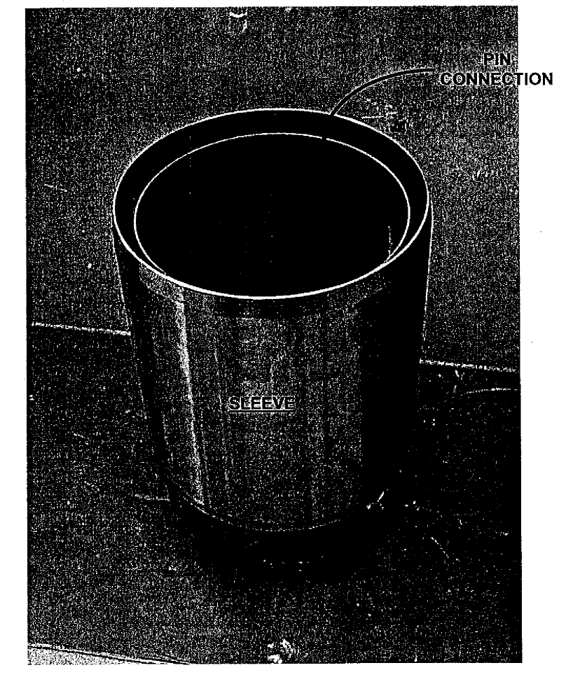

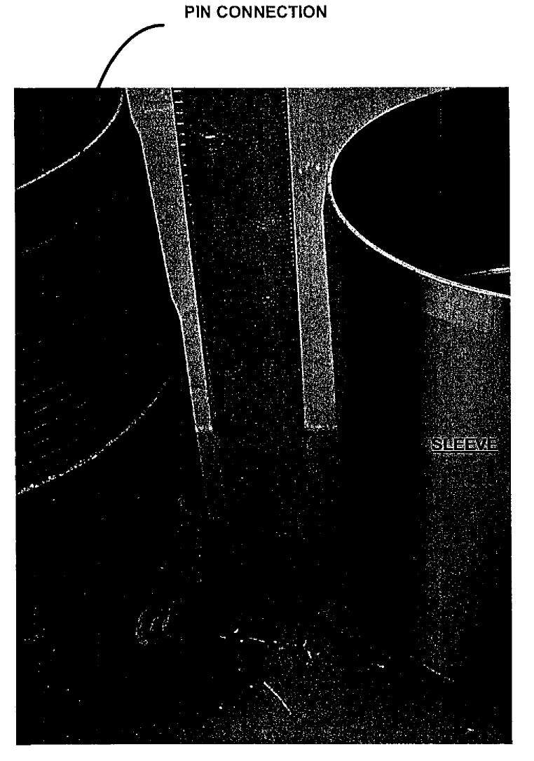

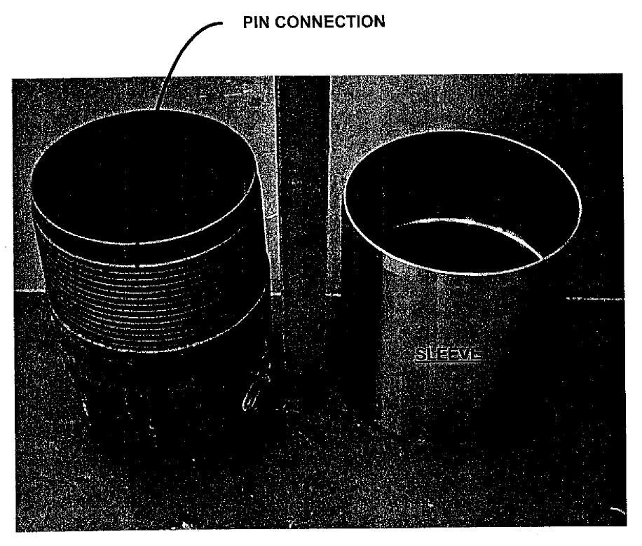

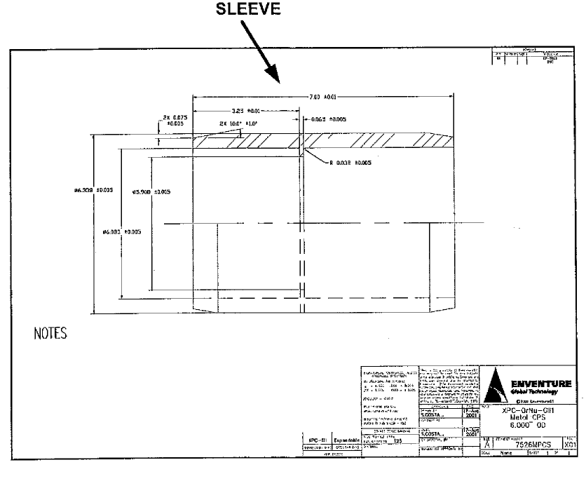

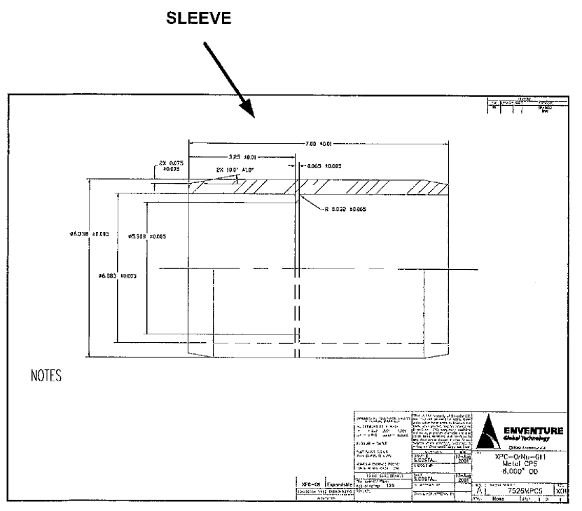

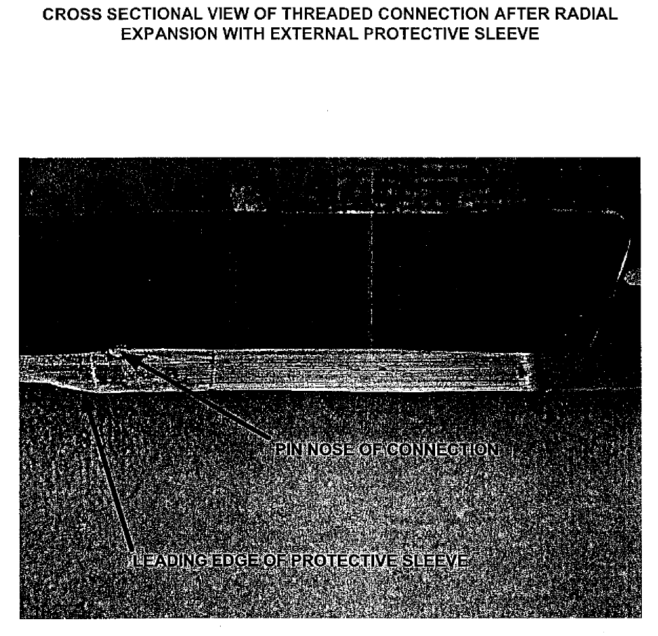

More generally still, as illustrated in FIG. 19, the teachings of the present exemplary embodiments provide a method 2100 of providing a fluid tight seal between a pair of adjacent tubular members in which the location of a fluid leak may be detected in the junction between a pair of adjacent tubular members in step 2102. In an exemplary embodiment, in step 2102, a pressurized fluid may be injected through the adjacent coupled tubular members and the amount, if any, of any fluid leakage through the junctions between the adjacent tubular members monitored.

If the amount of fluid leakage through the junctions of the adjacent tubular members exceeds a predetermined amount, then a tubular sleeve may then be coupled to and overlapping the junction between the adjacent tubular members in step 2104. And, finally, in step 2106, the portions of the tubular members proximate the tubular sleeve may then be radially expanded. In this manner, a cost efficient and reliable method for repairing leaks in the junctions between adjacent tubular members may be provided.

A method of radially expanding and plastically deforming a first tubular member and a second tubular member has been described that includes inserting an end of the first tubular member into an end of a tubular sleeve having an internal flange into abutment with the internal flange, inserting an end of the second tubular member into another end of the tubular sleeve, threadably coupling the ends of the first and second tubular member within the tubular sleeve until both ends of the first and second tubular members abut the internal flange of the tubular sleeve, and displacing an expansion cone through the interiors of the first and second tubular members. In an exemplary embodiment, the internal flange of the tubular sleeve is positioned between the ends of the tubular sleeve. In an exemplary embodiment, the internal flange of the tubular sleeve is positioned at one end of the tubular sleeve. In an exemplary embodiment, the tubular sleeve further includes one or more sealing members for sealing the interface between the tubular sleeve and at least one of the tubular members. In an exemplary embodiment, the method further includes placing the tubular members in another structure, and displacing the expansion cone through the interiors of the first and second tubular members. In an exemplary embodiment, the method further includes radially expanding the tubular sleeve into engagement with the structure. In an exemplary embodiment, the method further includes sealing an annulus between the tubular sleeve and the other structure. In an exemplary embodiment, the other structure comprises a wellbore. In an exemplary embodiment, the other structure comprises a wellbore casing. In an exemplary embodiment, the tubular sleeve further comprises a sealing element coupled to the exterior of the tubular sleeve. In an exemplary embodiment, the tubular sleeve is metallic. In an exemplary embodiment, the tubular sleeve is non metallic. In an exemplary embodiment, the tubular sleeve is plastic. In an exemplary embodiment, the tubular sleeve is ceramic. In an exemplary embodiment, the method further includes breaking the tubular sleeve. In an exemplary embodiment, the tubular sleeve includes one or more longitudinal slots. In an exemplary embodiment, the tubular sleeve includes one or more radial passages.

A method of radially expanding and plastically deforming a first tubular member and a second tubular member has also been described that includes inserting an end of the first tubular member into an end of a tubular sleeve, coupling the end of the tubular sleeve to the end of the first tubular member, inserting an end of the second tubular member into another end of the tubular sleeve, threadably coupling the ends of the first and second tubular member within the tubular sleeve, coupling the other end of the tubular sleeve to the end of the second tubular member, and displacing an expansion cone through the interiors of the first and second tubular members. In an exemplary embodiment, coupling the ends of the tubular sleeve to the ends of the first and second tubular members includes coupling the ends of the tubular sleeve to the ends of the first and second tubular members using locking rings. In an exemplary embodiment, coupling the ends of the tubular sleeve to the ends of the first and second tubular members using locking rings includes wedging the locking rings between the ends of the tubular sleeve and the ends of the first and second tubular members. In an exemplary embodiment, coupling the ends of the tubular sleeve to the ends of the first and second tubular members using locking rings includes affixing the locking rings to the ends of the first and second tubular members. In an exemplary embodiment, the locking rings are resilient. In an exemplary embodiment, the locking rings are elastomeric. In an exemplary embodiment, coupling the ends of the tubular sleeve to the ends of the first and second tubular members includes crimping the ends of the tubular sleeve onto the ends of the first and second tubular members. In an exemplary embodiment, the tubular sleeve further includes one or more sealing members for sealing the interface between the tubular sleeve and at least one of the tubular members. In an exemplary embodiment, the method further includes placing the tubular members in another structure, and displacing the expansion cone through the interiors of the first and second tubular members. In an exemplary embodiment, the method further includes radially expanding the tubular sleeve into engagement with the structure. In an exemplary embodiment, the method further includes sealing an annulus between the tubular sleeve and the other structure. In an exemplary embodiment, the other structure is a wellbore. In an exemplary embodiment, the other structure is a wellbore casing. In an exemplary embodiment, the tubular sleeve further includes a sealing element coupled to the exterior of the tubular sleeve. In an exemplary embodiment, the tubular sleeve is metallic. In an exemplary embodiment, the tubular sleeve is non-metallic. In an exemplary embodiment, the tubular sleeve is plastic. In an exemplary embodiment, the tubular sleeve is ceramic. In an exemplary embodiment, the method further includes breaking the tubular sleeve. In an exemplary embodiment, the tubular sleeve includes one or more longitudinal slots. In an exemplary embodiment, the tubular sleeve includes one or more radial passages.

A method of radially expanding and plastically deforming a first tubular member and a second tubular member has also been described that includes inserting an end of a tubular sleeve having an external flange into an end of the first tubular member until the external flange abuts the end of the first tubular member, inserting the other end of the tubular sleeve into an end of a second tubular member, threadably coupling the ends of the first and second tubular member within the tubular sleeve until both ends of the first and second tubular members abut the external flange of the tubular sleeve, and displacing an expansion cone through the interiors of the first and second tubular members. In an exemplary embodiment, the external flange of the tubular sleeve is positioned between the ends of the tubular sleeve. In an exemplary embodiment, the external flange of the tubular sleeve is positioned at one end of the tubular sleeve. In an exemplary embodiment, the tubular sleeve further includes one or more sealing members for sealing the interface between the tubular sleeve and at least one of the tubular members. In an exemplary embodiment, the method further includes placing the tubular members in another structure, and displacing the expansion cone through the interiors of the first and second tubular members. In an exemplary embodiment, the other structure comprises a wellbore. in an exemplary embodiment, the other structure comprises a wellbore casing. In an exemplary embodiment, the tubular sleeve is metallic. In an exemplary embodiment, the tubular sleeve is non-metallic. In an exemplary embodiment, the tubular sleeve is plastic. In an exemplary embodiment, the tubular sleeve is ceramic. In an exemplary embodiment, the method further includes breaking the tubular sleeve. In an exemplary embodiment, the tubular sleeve includes one or more longitudinal slots. In an exemplary embodiment, the tubular sleeve includes one or more radial passages.

A method of radially expanding and plastically deforming a first tubular member and a second tubular member has also been described that includes inserting an end of the first tubular member into an end of a tubular sleeve having an internal flange into abutment with the internal flange, inserting an end of the second tubular member into another end of the tubular sleeve into abutment with the internal flange, coupling the ends of the first and second tubular member to the tubular sleeve, and displacing an expansion cone through the interiors of the first and second tubular members. in an exemplary embodiment, the internal flange of the tubular sleeve is positioned between the ends of the tubular sleeve. In an exemplary embodiment, the internal flange of the tubular sleeve is positioned at one end of the tubular sleeve. In an exemplary embodiment, the tubular sleeve further comprises one or more sealing members for sealing the interface between the tubular sleeve and at least one of the tubular members. In an exemplary embodiment, the method further includes placing the tubular members in another structure, and displacing the expansion cone through the interiors of the first and second tubular members. In an exemplary embodiment, the method further includes radially expanding the tubular sleeve into engagement with the structure. In an exemplary embodiment, the method further includes sealing an annulus between the tubular sleeve and the other structure. In an exemplary embodiment, the other structure is a wellbore. In an exemplary embodiment, the other structure is a wellbore casing. In an exemplary embodiment, the tubular sleeve further includes a sealing element coupled to the exterior of the tubular sleeve. In an exemplary embodiment, the tubular sleeve is metallic. In an exemplary embodiment, the tubular sleeve is non-metallic. In an exemplary embodiment, the tubular sleeve is plastic. In an exemplary embodiment, the tubular sleeve is ceramic. In an exemplary embodiment, the method further includes breaking the tubular sleeve. In an exemplary embodiment, the tubular sleeve includes one or more longitudinal slots. In an exemplary embodiment, the tubular sleeve includes one or more radial passages. In an exemplary embodiment, coupling the ends of the first and second tubular member to the tubular sleeve includes heating the tubular sleeve and inserting the ends of the first and second tubular members into the tubular sleeve. In an exemplary embodiment, coupling the ends of the first and second tubular member to the tubular sleeve includes coupling the tubular sleeve to the ends of the first and second tubular members using a locking ring.

A method has been described that includes coupling an end of a first tubular member to an end of a tubular sleeve, coupling an end of a second tubular member to another end of the tubular sleeve, coupling the ends of the first and second tubular members, and radially expanding and plastically deforming the first tubular member and the second tubular member. In an exemplary embodiment, the tubular sleeve includes an internal flange. In an exemplary embodiment, coupling the end of the first tubular member to the end of the tubular sleeve includes inserting the end of the first tubular member into the end of the tubular sleeve into abutment with the internal flange. In an exemplary embodiment, coupling the end of the second tubular member to the other end of the tubular sleeve includes inserting the end of the second tubular member into the other end of the tubular sleeve into abutment with the internal flange. In an exemplary embodiment, coupling the end of the second tubular member to the other end of the tubular sleeve includes inserting the end of the second tubular member into the other end of the tubular sleeve into abutment with the internal flange. In an exemplary embodiment, the tubular sleeve includes an external flange. In an exemplary embodiment, coupling the end of the first tubular member to the end of the tubular sleeve includes inserting the end of the tubular sleeve into the end of the first tubular member until the end of the first tubular member abuts the external flange. In an exemplary embodiment, coupling the end of the second tubular member to the other end of the tubular sleeve includes inserting the other end of the tubular sleeve into the end of the second tubular member until the end of the second tubular member abuts the external flange. In an exemplary embodiment, coupling the end of the second tubular member to the other end of the tubular sleeve includes inserting the other end of the tubular sleeve into the end of the second tubular member until the end of the second tubular member abuts the external flange. In an exemplary embodiment, coupling the end of the first tubular member to the end of the tubular sleeve includes inserting a retaining ring between the end of the first tubular member and the end of the tubular sleeve. In an exemplary embodiment, coupling the end of the second tubular member to the other end of the tubular sleeve includes inserting another retaining ring between the end of the second tubular member and the other end of the tubular sleeve. In an exemplary embodiment, coupling the end of the second tubular member to the other end of the tubular sleeve includes inserting a retaining ring between the end of the first tubular member and the other end of the tubular sleeve. In an exemplary embodiment, the retaining ring is resilient. In an exemplary embodiment, the retaining ring and the other retaining ring are resilient. In an exemplary embodiment, the retaining ring is resilient. In an exemplary embodiment, coupling the end of the first tubular member to the end of the tubular sleeve includes deforming the end of the tubular sleeve. In an exemplary embodiment, coupling the end of the second tubular member to the other end of the tubular sleeve includes deforming the other end of the tubular sleeve. In an exemplary embodiment, coupling the end of the second tubular member to the other end of the tubular sleeve includes deforming the other end of the tubular sleeve. In an exemplary embodiment, coupling the end of the first tubular member to the end of the tubular sleeve includes coupling a retaining ring to the end of the first tubular member. In an exemplary embodiment, coupling the end of the second tubular member to the other end of the tubular sleeve includes coupling another retaining ring to the end of the second tubular member. In an exemplary embodiment, coupling the end of the second tubular member to the other end of the tubular sleeve includes coupling a retaining ring to the end of the second tubular member. In an exemplary embodiment, the retaining ring is resilient. In an exemplary embodiment, the retaining ring and the other retaining ring are resilient. In an exemplary embodiment, the retaining ring is resilient. In an exemplary embodiment, coupling the end of the first tubular member to the end of the tubular sleeve includes heating the end of the tubular sleeve, and inserting the end of the first tubular member into the end of the tubular sleeve. In an exemplary embodiment, coupling the end of the second tubular member to the other end of the tubular sleeve includes heating the other end of the tubular sleeve, and inserting the end of the second tubular member into the other end of the tubular sleeve. In an exemplary embodiment, coupling the end of the second tubular member to the other end of the tubular sleeve includes heating the other end of the tubular sleeve, and inserting the end of the second tubular member into the other end of the tubular sleeve. In an exemplary embodiment, coupling the end of the first tubular member to the end of the tubular sleeve includes inserting the end of the first tubular member into the end of the tubular sleeve, and latching the end of the first tubular member to the end of the tubular sleeve. In an exemplary embodiment, coupling the end of the second tubular member to the other end of the tubular sleeve includes inserting the end of the second tubular member into the end of the tubular sleeve, and latching the end of the second tubular member to the other end of the tubular sleeve. In an exemplary embodiment, coupling the end of the second tubular member to the other end of the tubular sleeve includes inserting the end of the second tubular member into the end of the tubular sleeve, and latching the end of the second tubular member to the other end of the tubular sleeve. In an exemplary embodiment, the tubular sleeve further comprises one or more sealing members for sealing the interface between the tubular sleeve and at least one of the tubular members. In an exemplary embodiment, the method further includes placing the tubular members in another structure, and then radially expanding and plastically deforming the first tubular member and the second tubular member. In an exemplary embodiment, the method further includes radially expanding the tubular sleeve into engagement with the structure. In an exemplary embodiment, the method further includes sealing an annulus between the tubular sleeve and the other structure. In an exemplary embodiment, the other structure is a wellbore. In an exemplary embodiment, the other structure is a wellbore casing. In an exemplary embodiment, the tubular sleeve further includes a sealing element coupled to the exterior of the tubular sleeve. In an exemplary embodiment, the tubular sleeve is metallic. In an exemplary embodiment, the tubular sleeve is non-metallic. In an exemplary embodiment, the tubular sleeve is plastic. In an exemplary embodiment, the tubular sleeve is ceramic. In an exemplary embodiment, the method further includes breaking the tubular sleeve. in an exemplary embodiment, the tubular sleeve includes one or more longitudinal slots. In an exemplary embodiment, the tubular sleeve includes one or more radial passages. In an exemplary embodiment, radially expanding and plastically deforming the first tubular member, the second tubular member, and the tubular sleeve includes displacing an expansion cone within and relative to the first and second tubular members. In an exemplary embodiment, radially expanding and plastically deforming the first tubular member, the second tubular member, and the tubular sleeve includes applying radial pressure to the interior surfaces of the first and second tubular member using a rotating member. In an exemplary embodiment, the method further includes amorphously bonding the first and second tubular members during the radial expansion and plastic deformation of the first and second tubular members. In an exemplary embodiment, the method further includes welding the first and second tubular members during the radial expansion and plastic deformation of the first and second tubular members. In an exemplary embodiment, the method further includes providing a fluid tight seal within the threaded coupling between the first and second tubular members during the radial expansion and plastic deformation of the first and second tubular members. In an exemplary embodiment, the method further includes placing the tubular sleeve in circumferential tension, placing the end of the first tubular member in circumferential compression, and placing the end of the second tubular member in circumferential compression. In an exemplary embodiment, the method further includes placing the tubular sleeve in circumferential compression, placing the end of the first tubular member in circumferential tension, and placing the end of the second tubular member in circumferential tension. In an exemplary embodiment, radially expanding and plastically deforming the first tubular member and the second tubular member includes radially expanding and plastically deforming only the portions of the first and second members proximate the tubular sleeve. In an exemplary embodiment, the method further includes providing a fluid tight seal between the tubular sleeve and at least one of the first and second tubular members. In an exemplary embodiment, the first tubular member includes internal threads, and the second tubular member includes external threads that engage the internal threads of the first tubular member. In an exemplary embodiment, radially expanding and plastically deforming the first tubular member and the second tubular member includes radially expanding and plastically deforming only the portions of the first and second members proximate the threads of the first and second tubular members. In an exemplary embodiment, the method further includes providing a fluid tight seal between the threads of the first and second tubular members. In an exemplary embodiment, the method further includes providing a fluid tight seal between the tubular sleeve and at least one of the first and second tubular members. In an exemplary embodiment, the first and second tubular members are wellbore casings. In an exemplary embodiment, the first and second tubular members are pipes.

A method has been described that includes providing a tubular sleeve including an internal flange positioned between the ends of the tubular sleeve, inserting an end of a first tubular member into an end of the tubular sleeve into abutment with the internal flange, inserting an end of a second tubular member into another end of the tubular sleeve into abutment the internal flange, threadably coupling the ends of the first and second tubular members, radially expanding and plastically deforming the first tubular member and the second tubular member, placing the tubular sleeve in circumferential tension, placing the end of the first tubular member in circumferential compression, and placing the end of the second tubular member in circumferential compression.

A method has been described that includes providing a tubular sleeve including an external flange positioned between the ends of the tubular sleeve, inserting an end of the tubular sleeve into an end of a first tubular member until the end of the first tubular member abuts with the external flange, inserting another end of the tubular sleeve into an end of the second tubular member until the end of the second tubular member abuts the external flange, threadably coupling the ends of the first and second tubular members, radially expanding and plastically deforming the first tubular member and the second tubular member, placing the tubular sleeve in circumferential compression, placing the end of the first tubular member In circumferential tension, and placing the end of the second tubular member in circumferential tension.

A method has been described that includes providing a tubular sleeve including an internal flange positioned between the ends of the tubular sleeve, inserting an end of a first tubular member into an end of the tubular sleeve into abutment with the internal flange, inserting an end of a second tubular member into another end of the tubular sleeve into abutment the internal flange, threadably coupling the ends of the first and second tubular members, radially expanding and plastically deforming only the portions of the first tubular member and the second tubular member proximate the threads of the first and second tubular members, placing the tubular sleeve in circumferential tension, placing the end of the first tubular member in circumferential compression, and placing the end of the second tubular member in circumferential compression.

A method has been described that includes providing a tubular sleeve including an external flange positioned between the ends of the tubular sleeve, inserting an end of the tubular sleeve into an end of a first tubular member until the end of the first tubular member abuts with the external flange, inserting another end of the tubular sleeve into an end of the second tubular member until the end of the second tubular member abuts the external flange, threadably coupling the ends of the first and second tubular members, radially expanding and plastically deforming only the portions of the first tubular member and the second tubular member proximate the threads of the first and second tubular members, placing the tubular sleeve in circumferential compression, placing the end of the first tubular member in circumferential tension, and placing the end of the second tubular member in circumferential tension.

An apparatus has been described that includes a tubular sleeve, a first tubular member coupled to an end of the tubular sleeve, and a second tubular member coupled to another end of the tubular sleeve. In an exemplary embodiment, the tubular sleeve is in circumferential tension, the end portion of the first tubular member is in circumferential compression, and the end portion of the second tubular member is in circumferential compression. In an exemplary embodiment, the tubular sleeve is in circumferential compression, the end portion of the first tubular member is in circumferential tension, and the end portion of the second tubular member is in circumferential tension. In an exemplary embodiment, the tubular sleeve includes an internal flange. In an exemplary embodiment, the end portion of the first tubular member is received within an end of the tubular sleeve, and the end portion of the second tubular member is received within another end of the tubular sleeve. In an exemplary embodiment, the end portions of the first and second tubular members abut the internal flange of the tubular sleeve. In an exemplary embodiment, the end portion of the first tubular member is received within an end of the tubular sleeve. In an exemplary embodiment, the end portions of the first and second tubular members abut the internal flange of the tubular sleeve. In an exemplary embodiment, the end portion of the second tubular member is received within an end of the tubular sleeve. In an exemplary embodiment, the end portions of the first and second tubular members abut the internal flange of the tubular sleeve. In an exemplary embodiment, the internal flange of the tubular sleeve is positioned between the ends of the tubular sleeve. In an exemplary embodiment, the internal flange of the tubular sleeve is positioned at an end of the tubular sleeve. In an exemplary embodiment, the tubular sleeve includes an external flange. In an exemplary embodiment, an end portion of the tubular sleeve is received within the first tubular member; and another end portion of the tubular sleeve is received within the end portion of the second tubular member. In an exemplary embodiment, the end portions of the first and second tubular members abut the external flange of the tubular sleeve. In an exemplary embodiment, an end portion of the tubular sleeve is received within the end portion of the first tubular member. In an exemplary embodiment, the end portions of the first and second tubular members abut the external flange of the tubular sleeve. In an exemplary embodiment, an end portion of the tubular sleeve is received within the end portion of the second tubular member. In an exemplary embodiment, the end portions of the first and second tubular members abut the external flange of the tubular sleeve. In an exemplary embodiment, the external flange of the tubular sleeve is positioned between the ends of the tubular sleeve. In an exemplary embodiment, the external flange of the tubular sleeve is positioned at an end of the tubular sleeve. In an exemplary embodiment, the tubular sleeve further comprises one or more sealing members for sealing the interface between the tubular sleeve and at least one of the tubular members. In an exemplary embodiment, the apparatus further includes a retaining ring positioned between the end of the first tubular member and the end of the tubular sleeve. In an exemplary embodiment, the apparatus further includes another retaining ring positioned between the end of the second tubular member and the other end of the tubular sleeve. In an exemplary embodiment, the apparatus further includes a retaining ring positioned between the end of the first tubular member and the other end of the tubular sleeve. In an exemplary embodiment, the retaining ring is resilient. In an exemplary embodiment, the retaining ring and the other retaining ring are resilient. In an exemplary embodiment, the retaining ring is resilient. In an exemplary embodiment, the end of the tubular sleeve is deformed onto the end of the first tubular member. In an exemplary embodiment, the other end of the tubular sleeve is deformed onto the end of the second tubular member. In an exemplary embodiment, the other end of the tubular sleeve is deformed onto the end of the second tubular member. In an exemplary embodiment, the apparatus further includes a retaining ring coupled to the end of the first tubular member for retaining the tubular sleeve onto the end of the first tubular member. In an exemplary embodiment, the apparatus further includes another retaining ring coupled to the end of the second tubular member for retaining the other end of the tubular sleeve onto the end of the second tubular member. In an exemplary embodiment, the apparatus further includes a retaining ring coupled to the end of the second tubular member for retaining the other end of the tubular sleeve onto the end of the second tubular member. In an exemplary embodiment, the retaining ring is resilient. In an exemplary embodiment, the retaining ring and the other retaining ring are resilient. In an exemplary embodiment, the retaining ring is resilient. In an exemplary embodiment, the apparatus further includes a locking ring for coupling the end of the first tubular member to the end of the tubular sleeve. In an exemplary embodiment, the apparatus further includes another locking ring for coupling the end of the second tubular member to the other end of the tubular sleeve. In an exemplary embodiment, the apparatus further includes a locking ring for coupling the end of the second tubular member to the other end of the tubular sleeve. In an exemplary embodiment, the apparatus further includes a structure for receiving the first and second tubular members and the tubular sleeve, and the tubular sleeve contacts the interior surface of the structure. In an exemplary embodiment, the tubular sleeve further includes a sealing member for fluidicly sealing the interface between the tubular sleeve and the structure. in an exemplary embodiment, the other structure is a wellbore. In an exemplary embodiment, the other structure is a wellbore casing. In an exemplary embodiment, the tubular sleeve further includes a sealing element coupled to the exterior surface of the tubular sleeve. In an exemplary embodiment, the tubular sleeve is metallic. In an exemplary embodiment, the tubular sleeve is non-metallic. In an exemplary embodiment, the tubular sleeve is plastic. In an exemplary embodiment, the tubular sleeve is ceramic. In an exemplary embodiment, the tubular sleeve is frangible. In an exemplary embodiment, the tubular sleeve includes one or more longitudinal slots. In an exemplary embodiment, the tubular sleeve includes one or more radial passages. In an exemplary embodiment, the first and second tubular members are amorphously bonded. In an exemplary embodiment, the first and second tubular members are welded. In an exemplary embodiment, the internal threads of the first tubular member and the internal threads of the second tubular member together provide a fluid tight seal. In an exemplary embodiment, only the portions of the first and second tubular members proximate the tubular sleeve are plastically deformed. In an exemplary embodiment, a fluid tight seal is provided between the tubular sleeve and at least one of the first and second tubular members. In an exemplary embodiment, the first tubular member includes internal threads; and wherein the second tubular member includes external threads that engage the internal threads of the first tubular member. In an exemplary embodiment, only the portions of the first and second members proximate the threads of the first and second tubular members are plastically deformed. In an exemplary embodiment, a fluid tight seal is provided between the threads of the first and second tubular members. In an exemplary embodiment, a fluid tight seal is provided between the tubular sleeve and at least one of the first and second tubular members.

An apparatus has been described that includes a tubular sleeve including an internal flange positioned between the ends of the tubular sleeve, a first tubular member received within an end of the tubular sleeve in abutment with the internal flange that comprises internal threads, and a second tubular member received within another end of the tubular sleeve in abutment with the internal flange that comprises external threads that engage the internal threads of the first tubular member. The tubular sleeve is in circumferential tension, the end of first tubular member is in circumferential compression, and the end of the second tubular member is in circumferential compression.

An apparatus has been described that includes a tubular sleeve comprising an external flange positioned between the ends of the tubular sleeve, a first tubular member that receives an end of the tubular sleeve and abuts the external flange that comprises internal threads, and a second tubular member that receives another end of the tubular sleeve that abuts the external flange that comprises external threads that engage the internal threads of the first tubular member. The tubular sleeve is in circumferential compression, the first tubular member is in circumferential tension, and the second tubular member is in circumferential tension.

An apparatus has been described that includes a tubular sleeve comprising an internal flange positioned between the ends of the tubular sleeve, a first tubular member received within an end of the tubular sleeve in abutment with the internal flange that comprises internal threads, and a second tubular member received within another end of the tubular sleeve in abutment with the internal flange that comprises external threads that engage the internal threads of the first tubular member. The tubular sleeve is in circumferential tension, the end of first tubular member is in circumferential compression, the end of the second tubular member is in circumferential compression, a fluid tight seal is provided between the tubular sleeve and at least one of the first and second tubular members, and a fluid tight seal is provided between the threads of the first and second tubular members.

An apparatus has been described that includes a tubular sleeve comprising an external flange positioned between the ends of the tubular sleeve, a first tubular member that receives an end of the tubular sleeve and abuts the external flange that comprises internal threads, and a second tubular member that receives another end of the tubular sleeve that abuts the external flange that comprises external threads that engage the internal threads of the first tubular member. The tubular sleeve is in circumferential compression, the first tubular member is in circumferential tension, the second tubular member is in circumferential tension, a fluid tight seal is provided between the tubular sleeve and at least one of the first and second tubular members, and a fluid tight seal is provided between the threads of the first and second tubular members.

A method of extracting geothermal energy from a subterranean source of geothermal energy has been described that includes drilling a borehole that traverses the subterranean source of geothermal energy, positioning a first casing string within the borehole, radially expanding and plastically deforming the first casing string within the borehole, positioning a second casing string within the borehole that traverses the subterranean source of geothermal energy, overlapping a portion of the second casing string with a portion of the first casing string, radially expanding and plastically deforming the second casing string within the borehole, and extracting geothermal energy from the subterranean source of geothermal energy using the first and second casing strings. In an exemplary embodiment, the interior diameter of a passage defined by the first and second casing strings is constant. In an exemplary embodiment, at least one of the first and second casing strings includes a tubular sleeve, a first tubular member coupled to an end of the tubular sleeve comprising internal threads at an end portion, and a second tubular member coupled to another end of the tubular sleeve comprising external threads at an end portion that engage the internal threads of the end portion of the first tubular member.

A method of extracting geothermal energy from a subterranean source of geothermal energy has been described that includes drilling a borehole that traverses the subterranean source of geothermal energy, positioning a first casing string within the borehole, radially expanding and plastically deforming the first casing string within the borehole, positioning a second casing string within the borehole that traverses the subterranean source of geothermal energy, overlapping a portion of the second casing string with a portion of the first casing string, radially expanding and plastically deforming the second casing string within the borehole, and extracting geothermal energy from the subterranean source of geothermal energy using the first and second casing strings. the interior diameter of a passage defined by the first and second casing strings is constant, and at least one of the first and second casing strings includes a tubular sleeve comprising an internal flange positioned between the ends of the tubular sleeve, a first tubular member received within an end of the tubular sleeve in abutment with the internal flange that comprises internal threads, and a second tubular member received within another end of the tubular sleeve in abutment with the internal flange that comprises external threads that engage the internal threads of the first tubular member.

A method of extracting geothermal energy from a subterranean source of geothermal energy has been described that includes drilling a borehole that traverses the subterranean source of geothermal energy, positioning a first casing string within the borehole, radially expanding and plastically deforming the first casing string within the borehole, positioning a second casing string within the borehole that traverses the subterranean source of geothermal energy, overlapping a portion of the second casing string with a portion of the first casing string, radially expanding and plastically deforming the second casing string within the borehole, and extracting geothermal energy from the subterranean source of geothermal energy using the first and second casing strings. The interior diameter of a passage defined by the first and second casing strings is constant, and at least one of the first and second casing strings include: a tubular sleeve comprising an external flange positioned between the ends of the tubular sleeve, a first tubular member that receives an end of the tubular sleeve that abuts external flange that comprises internal threads, and a second tubular member that receives another end of the tubular sleeve that abuts the external flange that comprises external threads that engage the internal threads of the first tubular member.

A method of extracting geothermal energy from a subterranean source of geothermal energy has been described that includes drilling a borehole that traverses the subterranean source of geothermal energy, positioning a first casing string within the borehole, radially expanding and plastically deforming the first casing string within the borehole, positioning a second casing string within the borehole that traverses the subterranean source of geothermal energy, overlapping a portion of the second casing string with a portion of the first casing string, radially expanding and plastically deforming the second casing string within the borehole, and extracting geothermal energy from the subterranean source of geothermal energy using the first and second casing strings. The interior diameter of a passage defined by the first and second casing strings is constant, and at least one of the first and second casing strings include a tubular sleeve comprising an internal flange positioned between the ends of the tubular sleeve, a first tubular member received within an end of the tubular sleeve in abutment with the internal flange that comprises internal threads, and a second tubular member received within another end of the tubular sleeve in abutment with the internal flange that comprises external threads that engage the internal threads of the first tubular member. The tubular sleeve is in circumferential tension, the first tubular member is in circumferential compression, the second tubular member is in circumferential compression, a fluid tight seal is provided between the tubular sleeve and at least one of the first and second tubular members, and a fluid tight seal is provided between the threads of the first and second tubular members.

A method of extracting geothermal energy from a subterranean source of geothermal energy has been described that includes drilling a borehole that traverses the subterranean source of geothermal energy, positioning a first casing string within the borehole, radially expanding and plastically deforming the first casing string within the borehole, positioning a second casing string within the borehole that traverses the subterranean source of geothermal energy, overlapping a portion of the second casing string with a portion of the first casing string, radially expanding and plastically deforming the second casing string within the borehole, and extracting geothermal energy from the subterranean source of geothermal energy using the first and second casing strings. The interior diameter of a passage defined by the first and second casing strings is constant, and wherein at least one of the first and second casing strings include a tubular sleeve comprising an external flange positioned between the ends of the tubular sleeve, a first tubular member that receives an end of the tubular sleeve that abuts external flange that comprises internal threads, and a second tubular member that receives another end of the tubular sleeve that abuts the external flange that comprises external threads that engage the internal threads of the first tubular member. The tubular sleeve is in circumferential compression, the first tubular member is in circumferential tension, the second tubular member is in circumferential tension, a fluid tight seal is provided between the tubular sleeve and at least one of the first and second tubular members, and a fluid tight seal is provided between the threads of the first and second tubular members.

An apparatus for extracting geothermal energy from a subterranean source of geothermal energy has been described that includes a borehole that traverses the subterranean source of geothermal energy, a first casing string positioned within the borehole, and a second casing positioned within the borehole that overlaps with the first casing string that traverses the subterranean source of geothermal energy. The first casing string and the second casing sting are radially expanded and plastically deformed within the borehole. In an exemplary embodiment, the interior diameter of a passage defined by the first and second casing strings is constant. In an exemplary embodiment, at least one of the first and second casing strings include a tubular sleeve, a first tubular member coupled to an end of the tubular sleeve comprising internal threads at an end portion, and a second tubular member coupled to another end of the tubular sleeve comprising external threads at an end portion that engage the internal threads of the end portion of the first tubular member.

An apparatus for extracting geothermal energy from a subterranean source of geothermal energy has been described that includes a borehole that traverses the subterranean source of geothermal energy, a first casing string positioned within the borehole, a second casing string within the borehole that traverses the subterranean source of geothermal energy that overlaps with the first casing string. The first and second casing strings are radially expanded and plastically deformed within the borehole, the inside diameter of a passage defined by the first and second casing strings is constant, and at least one of the first and second casing strings includes a tubular sleeve comprising an internal flange positioned between the ends of the tubular sleeve, a first tubular member received within an end of the tubular sleeve in abutment with the internal flange that comprises internal threads, and a second tubular member received within another end of the tubular sleeve in abutment with the internal flange that comprises external threads that engage the internal threads of the first tubular member.

An apparatus for extracting geothermal energy from a subterranean source of geothermal energy has been described a borehole that traverses the subterranean source of geothermal energy, a first casing string positioned within the borehole, and a second casing string positioned within the borehole that traverses the subterranean source of geothermal energy that overlaps with the first casing string. The interior diameter of a passage defined by the first and second casing strings is constant, and wherein at least one of the first and second casing strings include: a tubular sleeve comprising an external flange positioned between the ends of the tubular sleeve, a first tubular member that receives an end of the tubular sleeve that abuts external flange that comprises internal threads, and a second tubular member that receives another end of the tubular sleeve that abuts the external flange that comprises external threads that engage the internal threads of the first tubular member.

An apparatus for extracting geothermal energy from a subterranean source of geothermal energy has been described that includes a borehole that traverses the subterranean source of geothermal energy, a first casing string positioned within the borehole, and a second casing string within the borehole that traverses the subterranean source of geothermal energy that overlaps with the first casing string. The first and second casing strings are radially expanded and plastically deformed within the borehole. The inside diameter of a passage defined by the first and second casing strings is constant, and at least one of the first and second casing strings include: a tubular sleeve comprising an internal flange positioned between the ends of the tubular sleeve, a first tubular member received within an end of the tubular sleeve in abutment with the internal flange that comprises internal threads, a second tubular member received within another end of the tubular sleeve in abutment with the internal flange that comprises external threads that engage the internal threads of the first tubular member, the tubular sleeve is in circumferential tension, the first tubular member is in circumferential compression, the second tubular member is in circumferential compression, a fluid tight seal is provided between the tubular sleeve and at least one of the first and second tubular members, and a fluid tight seal is provided between the threads of the first and second tubular members.

An apparatus for extracting geothermal energy from a subterranean source of geothermal energy has been described that includes a borehole that traverses the subterranean source of geothermal energy, a first casing string positioned within the borehole, and a second casing string positioned within the borehole that traverses the subterranean source of geothermal energy that overlaps with the first casing string. The interior diameter of a passage defined by the first and second casing strings is constant, and at least one of the first and second casing strings include: a tubular sleeve comprising an external flange positioned between the ends of the tubular sleeve, a first tubular member that receives an end of the tubular sleeve that abuts external flange that comprises internal threads, and a second tubular member that receives another end of the tubular sleeve that abuts the external flange that comprises external threads that engage the internal threads of the first tubular member. The tubular sleeve is in circumferential compression, the first tubular member is in circumferential tension, the second tubular member is in circumferential tension, a fluid tight seal is provided between the tubular sleeve and at least one of the first and second tubular members, and a fluid tight seal is provided between the threads of the first and second tubular members.

A method has been described that includes coupling an end of a first tubular member to an end of a tubular sleeve, coupling an end of a second tubular member to another end of the tubular sleeve, coupling the ends of the first and second tubular members, injecting a pressurized fluid through the first and second tubular members, determining if any of the pressurized fluid leaks through the coupled ends of the first and second tubular members, and if a predetermined amount of the pressurized fluid leaks through the coupled ends of the first and second tubular members, then coupling a tubular sleeve to the ends of the first and second tubular members and radially expanding and plastically deforming only the portions of the first and second tubular members proximate the tubular sleeve. In an exemplary embodiment, radially expanding and plastically deforming only the portions of the first and second tubular members proximate the tubular sleeve includes displacing an expansion cone within and relative to the first and second tubular members. In an exemplary embodiment, radially expanding and plastically deforming only the portions of the first and second tubular members proximate the tubular sleeve includes applying radial pressure to the interior surfaces of the first and second tubular member proximate the tubular sleeve using a rotating member.

It is understood that variations may be made in the foregoing without departing from the scope of the invention. For example, the teachings of the present illustrative embodiments may be used to provide a wellbore casing, a pipeline, or a structural support. Furthermore, the elements and teachings of the various illustrative embodiments may be combined in whole or in part in some or all of the illustrative embodiments.

Although illustrative embodiments of the invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope of the invention.

What is claimed:

1. An apparatus, including:
a tubular sleeve including an internal flange;
a first tubular member coupled to and received within an end of the tubular sleeve; and
a second tubular member coupled to and received within another end of the tubular sleeve and the first tubular member; and
wherein the flange is positioned between and abutted by the end portions of the first and second tubular members.

2. The apparatus of claim 1, wherein the tubular sleeve further includes a sealing element coupled to the exterior surface of the tubular sleeve.

3. The apparatus of claim 1, wherein the tubular sleeve includes one or more longitudinal slots.

4. The apparatus of claim 1, wherein the tubular sleeve comprises one or more radial passages.

5. The apparatus of claim 1, further including:
the first tubular member including internal threads;
the second tubular member including external threads that engage the internal threads of the first tubular member;
wherein the tubular sleeve is in circumferential tension;
wherein the end of first tubular member is in circumferential compression;
wherein the end of the second tubular member is in circumferential compression;
wherein a fluid tight seal is provided between the tubular sleeve and at least one of the first and second tubular members; and
wherein a fluid tight seal is provided between the threads of the first and second tubular members.

6. The apparatus of claim 1, wherein only the portions of the first and second tubular members proximate the tubular sleeve are plastically deformed.

7. An apparatus, including:
a tubular sleeve including an external flange;
a first tubular member coupled to an end of the tubular sleeve; and
a second tubular member coupled to another end of the tubular sleeve and the first tubular member;
wherein an end portion of the tubular sleeve is received within the first tubular member and another end portion of the tubular sleeve is received within the end portion of the second tubular member; and
wherein the flange is positioned between and abutted by the end portions of the first and second tubular members.

8. The apparatus of claim 7, further including:
the first tubular member including internal threads;
the second tubular member including external threads that engage the internal threads of the first tubular member;
wherein the tubular sleeve is in circumferential tension;
wherein the end of first tubular member is in circumferential compression;
wherein the end of the second tubular member is in circumferential compression;
wherein a fluid tight seal is provided between the tubular sleeve and at least one of the first and second tubular members; and
wherein a fluid tight seal is provided between the threads of the first and second tubular members.

9. The apparatus of claim 7, wherein only the portions of the first and second tubular members proximate the tubular sleeve are plastically deformed.

10. An apparatus, including:
a tubular sleeve;
a first tubular member coupled to an end of the tubular sleeve; and
a second tubular member coupled to another end of the tubular sleeve and the first tubular member;
wherein an end of the tubular sleeve is deformed onto the end of the first tubular member; and
wherein another end of the tubular sleeve is deformed onto the end of the second tubular member.

11. An apparatus, including:
a tubular sleeve;
a first tubular member coupled to an end of the tubular sleeve; and
a second tubular member coupled to another end of the tubular sleeve and the first tubular member;
a retaining ring coupled to the end of the first tubular member for retaining the tubular sleeve onto the end of the first tubular member; and
another retaining ring coupled to the end of the second tubular member for retaining the other end of the tubular sleeve onto the end of the second tubular member.

12. An apparatus, including:
a tubular sleeve;
a first tubular member coupled to an end of the tubular sleeve;
a second tubular member coupled to another end of the tubular sleeve and the first tubular member; and
a structure for receiving the first and second tubular members and the tubular sleeve;
wherein the tubular sleeve contacts the interior surface of the structure.

13. The apparatus of claim 12, wherein the other structure comprises a wellbore.

14. The apparatus of claim 12, wherein the other structure comprises a wellbore casing.
